(19) United States
(12) Patent Application Publication
(10) Pub. No.: US 2023/0114058 A1
(43) Pub. Date: Apr. 13, 2023

(54) RELIABILITY AND COVERAGE ENHANCEMENTS FOR COMMUNICATION NETWORKS

(71) Applicant: QUALCOMM Incorporated, San Diego, CA (US)

(72) Inventors: Liangping MA, San Diego, CA (US); Xiao Feng WANG, San Diego, CA (US); Alberto RICO ALVARINO, San Diego, CA (US); Huilin XU, Temecula, CA (US); Ayan SENGUPTA, San Diego, CA (US); Jun MA, San Diego, CA (US); Yiqing CAO, Beijing (CN); Peter GAAL, San Diego, CA (US); Umesh PHUYAL, San Diego, CA (US); Bharat SHRESTHA, San Diego, CA (US); Dan ZHANG, San Diego, CA (US)

(21) Appl. No.: 17/905,270

(22) PCT Filed: Apr. 2, 2021
(86) PCT No.: PCT/CN2021/085246

§ 371 Date: Aug. 30, 2022

(30) Foreign Application Priority Data
Apr. 7, 2020 (CN) PCT/CN2020/083455

(51) Int. Cl. H04L 1/08; H04W 72/0446; H04W 72/0453; H04W 72/23

(52) U.S. Cl. CPC H04L 1/08; H04W 72/0446; H04W 72/0453; H04W 72/23; H04W 84/06

(57) ABSTRACT

Methods, systems, and devices for wireless communications are described in which a block error rate (BLER) in non-terrestrial network (NTN) communications may be reduced through coverage enhancement techniques. Coverage enhancement techniques may include slot bundling for physical downlink control channel (PDCCH) communications, in which repetitions of a PDCCH may occupy multiple time-frequency locations spanning multiple slots. Such slots can be consecutive or non-consecutive, and in some cases multiple repetitions of the PDCCH may be provided within the same slot. The pattern of the time-frequency locations of repetitions may be periodic or non-periodic. Further, the repetitions can be exact copies, or different redundancy versions of the same encoded DCI. Additionally, repetitions of uplink or downlink shared channel communications, uplink or downlink control channel communication, broadcast channel communications, or any combinations thereof, may be provided.

### CROSS REFERENCE

The present Application is a 371 national stage filing of International PCT Application No. PCT/CN2021/085246 by MA et al. entitled “RELIABILITY AND COVERAGE ENHANCEMENTS FOR COMMUNICATION NETWORKS,” filed Apr. 2, 2021; and claims priority to International Patent Application No. PCT/CN2020/083455 by MA et al., entitled “RELIABILITY AND COVERAGE ENHANCEMENTS FOR COMMUNICATION NETWORKS,” filed Apr. 7, 2020, each of which is assigned to the assignee hereof, and each of which is expressly incorporated by reference in its entirety herein.

### INTRODUCTION

The following relates generally to wireless communications and more specifically to reliability enhancements for networks.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some cases, there may be a large distance between a UE and a serving node of the UE, such as when one or more of a gateway, base station, or the UE are at a high altitude relative to one another (e.g., in a non-terrestrial network (NTN) or system with high altitude platform stations (HAPSs)). Because of the distance between wireless nodes in such cases, signal strength for communications may be relatively low, and there may be a relatively long round-trip delay or propagation delay in message transmissions (e.g., relative to terrestrial networks).

### SUMMARY

A method for wireless communications at a user equipment (UE) is described. The method may include receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication, receiving signals from two or more of the set of multiple shared channel resources based on the control channel communication, and decoding the shared channel communication based on the received signals from the two or more of the set of multiple shared channel resources.

An apparatus for wireless communications at a UE is described. The apparatus may include a processor, memory coupled with the processor, the processor and memory configured to receive a control channel communication that indicates a set of multiple shared channel resources associated with a shared channel communication, the control channel communication indicating a first repetition resource set for an initial shared channel communication and one or more repetition resource sets for one or more repetitions of the shared channel communication, receive signals from two or more of the set of multiple shared channel resources based on the control channel communication, and decode the shared channel communication based on the received signals from the two or more of the set of multiple shared channel resources.

Another apparatus for wireless communications at a UE is described. The apparatus may include means for receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication, means for receiving signals from two or more of the set of multiple shared channel resources based on the control channel communication, and means for decoding the shared channel communication based on the received signals from the two or more of the set of multiple shared channel resources.

A non-transitory computer-readable medium storing code for wireless communications at a UE is described. The code may include instructions executable by a processor to receive a control channel communication that indicates a set of multiple shared channel resources associated with a shared channel communication, the control channel communication indicating a first repetition resource set for an initial shared channel communication and one or more repetition resource sets for one or more repetitions of the shared channel communication, receive signals from two or more of the set of multiple shared channel resources based on the control channel communication, and decode the shared channel communication based on the received signals from the two or more of the set of multiple shared channel resources.

In some examples of the method, apparatuses, and non-transitory computer-readable medium described herein, the shared channel communication is a downlink shared channel communication. In some examples of the method, apparatuses, and non-transitory computer-readable medium described herein, the shared channel resources further include resources for uplink shared channel communications, and uplink shared channel communications are transmitted on two or more of the plurality of shared channel resources.

In some examples of the method, apparatuses, and non-transitory computer-readable medium described herein, the repetition resource sets include resources having a periodic or non-periodic pattern across multiple consecutive or non-consecutive slots. In some examples of the method, apparatuses, and non-transitory computer-readable medium described herein, one or more of the repetition resource sets include multiple time resources, frequency resources, or combinations thereof, within a same slot. In some examples of the method, apparatuses, and non-transitory computer-readable medium described herein, the one or more repetitions of the shared channel transmission include repetitions of an exact copy of the shared channel transmission or include different redundancy versions of the shared channel transmission. In some examples of the method, apparatuses, and non-transitory computer-readable medium described herein, the repetitions of the shared channel transmission may be configured for aggregation levels above a configured threshold value.

In some examples of the method, apparatuses, and non-transitory computer-readable medium described herein, the control channel communication further indicates a repetition pattern for the one or more repetitions of the shared channel communication. In some examples of the method, apparatuses, and non-transitory computer-readable medium described herein, the shared channel communication has multiple repetitions in a same slot.

In some examples of the method, apparatuses, and non-transitory computer-readable medium described herein, the repetition pattern provided is provided in downlink control information (DCI) in the control channel communication, and where the DCI further indicates a duration that repetitions according to the repetition pattern are to be transmitted, a number of slots between consecutive repetitions, or any combinations thereof.

In some examples of the method, apparatuses, and non-transitory computer-readable medium described herein, control channel communication further indicates whether different redundancy versions (RVs) are used for consecutive repetitions of the shared channel communication, and where the decoding is further based on whether the different RVs are used for the consecutive repetitions.

In some examples of the method, apparatuses, and non-transitory computer-readable medium described herein, UE and the base station may be nodes in a non-terrestrial network (NTN).

A method for wireless communications at a base station is described. The method may include configuring a set of multiple shared channel resources associated with a shared channel communication to a UE, where the set of multiple shared channel resources include a first repetition resource set for an initial shared channel communication and one or more repetition resource sets for one or more repetitions of the shared channel communication, transmitting, to the UE, a control channel communication that indicates the set of multiple shared channel resources, and transmitting a set of multiple repetitions of the shared channel transmission using the set of multiple shared channel resources.

An apparatus for wireless communications at a base station is described. The apparatus may include a processor, memory coupled with the processor, the processor and memory configured to configure a set of multiple shared channel resources associated with a shared channel communication to a UE, where the set of multiple shared channel resources include a first repetition resource set for an initial shared channel communication and one or more repetition resource sets for one or more repetitions of the shared channel communication, transmit, to the UE, a control channel communication that indicates the set of multiple shared channel resources, and transmit a set of multiple repetitions of the shared channel transmission using the set of multiple shared channel resources.

Another apparatus for wireless communications at a base station is described. The apparatus may include means for configuring a set of multiple shared channel resources associated with a shared channel communication to a UE, where the set of multiple shared channel resources include a first repetition resource set for an initial shared channel communication and one or more repetition resource sets for one or more repetitions of the shared channel communication, means for transmitting, to the UE, a control channel communication that indicates the set of multiple shared channel resources, and means for transmitting a set of multiple repetitions of the shared channel transmission using the set of multiple shared channel resources.

A non-transitory computer-readable medium storing code for wireless communications at a base station is described. The code may include instructions executable by a processor to configure a set of multiple shared channel resources associated with a shared channel communication to a UE, where the set of multiple shared channel resources include a first repetition resource set for an initial shared channel communication and one or more repetition resource sets for one or more repetitions of the shared channel communication, transmit, to the UE, a control channel communication that indicates the set of multiple shared channel resources, and transmit a set of multiple repetitions of the shared channel transmission using the set of multiple shared channel resources.

In some examples of the method, apparatuses, and non-transitory computer-readable medium described herein, repetition resource sets include resources having a periodic or non-periodic pattern across multiple consecutive or non-consecutive slots. In some examples of the method, apparatuses, and non-transitory computer-readable medium described herein, one or more of the repetition resource sets include multiple time resources, frequency resources, or combinations thereof, within a same slot. In some examples of the method, apparatuses, and non-transitory computer-readable medium described herein, the repetitions of the shared channel transmission include repetitions of an exact copy of the shared channel transmission or include different redundancy versions of the shared channel transmission.

In some examples of the method, apparatuses, and non-transitory computer-readable medium described herein, control channel communication further indicates a repetition pattern for the one or more repetitions of the shared channel communication. In some examples of the method, apparatuses, and non-transitory computer-readable medium described herein, the UE and the base station may be nodes in a non-terrestrial network (NTN).

In some examples of the method, apparatuses, and non-transitory computer-readable medium described herein, the shared channel communication has multiple repetitions in a same slot. In some examples of the method, apparatuses, and non-transitory computer-readable medium described herein, a repetition pattern associated with the set of multiple repetitions of the shared channel transmission provides a duration that repetitions according to the repetition pattern are to be transmitted, a number of slots between consecutive repetitions, or any combinations thereof. In some examples of the method, apparatuses, and non-transitory computer-readable medium described herein, the control channel communication further indicates whether different redundancy versions (RVs) are used for consecutive repetitions of the shared channel communication.

A method of wireless communications at a UE is described. The method may include identifying, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffering received signals from two or more of the set of resources based on the identifying, and decoding the downlink control channel transmission based on the buffered received signals.

An apparatus for wireless communications at a UE is described. The apparatus may include a processor, memory coupled with the processor, the memory and processor configured to identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffer received signals from two or more of the set of resources based on the identifying, and decode the downlink control channel transmission based on the buffered received signals.

Another apparatus for wireless communications at a UE is described. The apparatus may include means for identifying, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffering received signals from two or more of the set of resources based on the identifying, and decoding the downlink control channel transmission based on the buffered received signals.

A non-transitory computer-readable medium storing code for wireless communications at a UE is described. The code may include instructions executable by a processor to identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffer received signals from two or more of the set of resources based on the identifying, and decode the downlink control channel transmission based on the buffered received signals.

In some examples of the method, apparatuses, and non-transitory computer-readable medium described herein, the repetition resource sets include resources having a periodic or non-periodic pattern across multiple consecutive or non-consecutive slots. In some examples of the method, apparatuses, and non-transitory computer-readable medium described herein, one or more of the repetition resource sets include multiple time resources, frequency resources, or combinations thereof, within a same slot. In some examples of the method, apparatuses, and non-transitory computer-readable medium described herein, the one or more repetitions of the downlink control channel transmission include repetitions of an exact copy of the downlink control channel transmission or include different redundancy versions of the downlink control channel transmission. In some examples of the method, apparatuses, and non-transitory computer-readable medium described herein, the repetitions of the downlink control channel transmission may be configured for aggregation levels above a configured threshold value. In some examples of the method, apparatuses, and non-transitory computer-readable medium described herein, a first part of a repetition of the downlink control channel transmission at an aggregation level is associated with a first control resource set transmitted by the base station, and a second part of the repetition of the downlink control channel transmission is associated with a second control resource set transmitted by the base station.

In some examples of the method, apparatuses, and non-transitory computer-readable medium described herein, the repetition resource sets include one or more configured search spaces of a set of available search spaces. In some examples of the method, apparatuses, and non-transitory computer-readable medium described herein, the one or more configured search spaces include all search space candidates for an indicated number of slots, search space candidates up to an indicated repetition level, or search space candidates that are determined based on a gap that indicates how many search space candidates are skipped between two repetitions. Some examples of the method, apparatuses, and non-transitory computer-readable medium described herein may further include operations, features, means, or instructions for determining one or more of a scrambling identification, a radio network temporary identifier (RNTI), or a DCI size, associated with the downlink control channel transmission, and determining a repetition level of the downlink control channel transmission based on mapping between the scrambling identification, RNTI, or DCI size and the repetition level. In some examples of the method, apparatuses, and non-transitory computer-readable medium described herein, the control resource set configuration may have a set of search spaces that may be candidates for downlink control channel communications, and where one or more search space candidates is dropped based on the determined repetition level.

Some examples of the method, apparatuses, and non-transitory computer-readable medium described herein may further include operations, features, means, or instructions for determining the first repetition resource set for the downlink control channel transmission based on a configured search space of a set of search spaces that has candidates for downlink control channel communications, and deriving the one or more additional repetition resource sets based on the first repetition resource set. In some examples of the method, apparatuses, and non-transitory computer-readable medium described herein, the repetition resource sets include two or more different time resources, two or more different frequency resources, two or more resources associated with different control resource sets, or any combinations thereof. In some examples of the method, apparatuses, and non-transitory computer-readable medium described herein, the one or more additional repetition resource sets may be derived based on one or more of a time shift and repetition level associated with the first repetition resource set, and where the time shift is a fixed time shift, a deterministic time shift, or a pseudo-random time shift relative to the first repetition resource set. In some examples of the method, apparatuses, and non-transitory computer-readable medium described herein, the time shift may be configured as a number of orthogonal frequency division multiplexing (OFDM) symbols.

In some examples of the method, apparatuses, and non-transitory computer-readable medium described herein, the one or more additional repetition resource sets may be derived based on one or more of a frequency shift and repetition level associated with the first repetition resource set, and where the frequency shift is a fixed frequency shift, a deterministic frequency shift, or a pseudo-random frequency shift relative to the first transmission resource. In some examples of the method, apparatuses, and non-transitory computer-readable medium described herein, the frequency shift may be cyclic frequency shift that is applied to the first repetition resource set or a prior repetition resource set, or that is applied to one or more search spaces associated with two or more different control resource sets.

In some examples of the method, apparatuses, and non-transitory computer-readable medium described herein, the one or more additional repetition resource sets may be derived based on a control resource set shift associated with the first repetition resource set and the control resource set configuration, and where the control resource set shift indicates one or more control resource sets that carry one or more repetitions of the downlink control channel transmission. In some examples of the method, apparatuses, and non-transitory computer-readable medium described herein, the one or more additional repetition resource sets are derived based on one or more of a time shift, a frequency shift, a control resource set shift, or any combinations thereof, relative to the first repetition resource set. In some examples of the method, apparatuses, and non-transitory computer-readable medium described herein, one or more repetition resource sets may be located in UE-specific search spaces that are at a same frequency within a same slot and are shifted in frequency across slots. In some examples of the method, apparatuses, and non-transitory computer-readable medium described herein, one or more repetition resource sets are located in common search spaces that are at a same frequency within a same slot, and that are at the same frequency across slots.

Some examples of the method, apparatuses, and non-transitory computer-readable medium described herein may further include operations, features, means, or instructions for receiving information from the base station that indicates that repetitions of the downlink control channel transmission are enabled and that indicates whether the repetitions are slot-based repetitions or control resource set based repetitions. In some examples of the method, apparatuses, and non-transitory computer-readable medium described herein, the information from the base station may be received in a master information block (MIB) that indicates whether repetitions are used, a repetition level, shift information, or any combinations thereof. In some examples of the method, apparatuses, and non-transitory computer-readable medium described herein, one or more slots may be determined to be downlink control channel transmission candidates, and a repetition level and a starting slot number may be indicated in the MIB. In some examples of the method, apparatuses, and non-transitory computer-readable medium described herein, the downlink control channel transmission includes a grant of downlink shared channel resources, and where the downlink shared channel resources start before or after a final repetition resource set.

A method of wireless communications at a UE is described. The method may include identifying, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffering received signals from two or more of the set of shared channel resources based on the identifying, and decoding the downlink shared channel communication based on the buffered received signals.

An apparatus for wireless communications at a UE is described. The apparatus may include a processor, and memory coupled with the processor, the memory and processor configured to identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffer received signals from two or more of the set of shared channel resources based on the identifying, and decode the downlink shared channel communication based on the buffered received signals.

Another apparatus for wireless communications at a UE is described. The apparatus may include means for identifying, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffering received signals from two or more of the set of shared channel resources based on the identifying, and decoding the downlink shared channel communication based on the buffered received signals.

A non-transitory computer-readable medium storing code for wireless communications at a UE is described. The code may include instructions executable by a processor to identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffer received signals from two or more of the set of shared channel resources based on the identifying, and decode the downlink shared channel communication based on the buffered received signals.

In some examples of the method, apparatuses, and non-transitory computer-readable medium described herein, the downlink shared channel communication has multiple repetitions in a same slot. In some examples of the method, apparatuses, and non-transitory computer-readable medium described herein, the repetition pattern may be provided in DCI in the control channel communication, and where the DCI further indicates a duration that repetitions according to the repetition pattern are to be transmitted, a number of slots between consecutive repetitions, or any combinations thereof. In some examples of the method, apparatuses, and non-transitory computer-readable medium described herein, the control channel communication further indicates whether different redundancy versions (RVs) are used for consecutive repetitions of the downlink shared channel communication, and where the buffering is further based on whether the different RVs are used for the consecutive repetitions.

A method of wireless communications at a UE is described. The method may include identifying a set of physical broadcast channel resources associated with a base station, the set of physical broadcast channel resources including two or more repetition resources for two or more repetitions of a physical broadcast channel communication, buffering received signals from the two or more repetitions of the physical broadcast channel communication based on the identifying, and decoding the physical broadcast channel communication based on the buffered received signals.

An apparatus for wireless communications at a UE is described. The apparatus may include a processor, and a memory coupled with the processor, the memory and processor configured to identify a set of physical broadcast channel resources associated with a base station, the set of physical broadcast channel resources including two or more repetition resources for two or more repetitions of a physical broadcast channel communication, buffer received signals from the two or more repetitions of the physical broadcast channel communication based on the identifying, and decode the physical broadcast channel communication based on the buffered received signals.

Another apparatus for wireless communications at a UE is described. The apparatus may include means for identifying a set of physical broadcast channel resources associated with a base station, the set of physical broadcast channel resources including two or more repetition resources for two or more repetitions of a physical broadcast channel communication, buffering received signals from the two or more repetitions of the physical broadcast channel communication based on the identifying, and decoding the physical broadcast channel communication based on the buffered received signals.

A non-transitory computer-readable medium storing code for wireless communications at a UE is described. The code may include instructions executable by a processor to identify a set of physical broadcast channel resources associated with a base station, the set of physical broadcast channel resources including two or more repetition resources for two or more repetitions of a physical broadcast channel communication, buffer received signals from the two or more repetitions of the physical broadcast channel communication based on the identifying, and decode the physical broadcast channel communication based on the buffered received signals.

In some examples of the method, apparatuses, and non-transitory computer-readable medium described herein, each repetition of the physical broadcast channel communications use a same set of beamforming parameters. In some examples of the method, apparatuses, and non-transitory computer-readable medium described herein, adjacent sets of physical broadcast channel resources for two or more repetitions of the physical broadcast channel communication are determined based on a defined time gap between adjacent repetitions. In some examples of the method, apparatuses, and non-transitory computer-readable medium described herein two or more sets of physical broadcast channel frequency resources are defined within a slot, and where two or more repetitions of the physical broadcast channel communication use different sets of physical broadcast channel frequency resources within the slot. In some examples of the method, apparatuses, and non-transitory computer-readable medium described herein, the two or more repetitions of the physical broadcast channel communication use a same system frame number (SFN) as an initial transmission of the physical broadcast channel communication. In some examples of the method, apparatuses, and non-transitory computer-readable medium described herein, the two or more repetitions of the physical broadcast channel communication use a same half-frame bit associated with a system frame number as an initial transmission of the physical broadcast channel communication. In some examples of the method, apparatuses, and non-transitory computer-readable medium described herein, the two or more repetitions of the physical broadcast channel communication use a same synchronization signal (SS)/physical broadcast channel (PBCH) index as an initial transmission of the physical broadcast channel communication.

A method of wireless communications at a UE is described. The method may include receiving, from a base station, an uplink grant for an uplink communication from the UE, the uplink grant indicating a set of uplink resources that include one or more repetition resources for one or more repetitions of the uplink communication, determining a transmission frequency bandwidth for the uplink communication as a subset of a channel frequency bandwidth used for receiving downlink communications at the UE, and transmitting the uplink communication via the set of uplink resources using the transmission frequency bandwidth.

An apparatus for wireless communications at a UE is described. The apparatus may include a processor, and a memory coupled with the processor, the memory and processor configured to receive, from a base station, an uplink grant for an uplink communication from the UE, the uplink grant indicating a set of uplink resources that include one or more repetition resources for one or more repetitions of the uplink communication, determine a transmission frequency bandwidth for the uplink communication as a subset of a channel frequency bandwidth used for receiving downlink communications at the UE, and transmit the uplink communication via the set of uplink resources using the transmission frequency bandwidth.

Another apparatus for wireless communications at a UE is described. The apparatus may include means for receiving, from a base station, an uplink grant for an uplink communication from the UE, the uplink grant indicating a set of uplink resources that include one or more repetition resources for one or more repetitions of the uplink communication, determining a transmission frequency bandwidth for the uplink communication as a subset of a channel frequency bandwidth used for receiving downlink communications at the UE, and transmitting the uplink communication via the set of uplink resources using the transmission frequency bandwidth.

A non-transitory computer-readable medium storing code for wireless communications at a UE is described. The code may include instructions executable by a processor to receive, from a base station, an uplink grant for an uplink communication from the UE, the uplink grant indicating a set of uplink resources that include one or more repetition resources for one or more repetitions of the uplink communication, determine a transmission frequency bandwidth for the uplink communication as a subset of a channel frequency bandwidth used for receiving downlink communications at the UE, and transmit the uplink communication via the set of uplink resources using the transmission frequency bandwidth.

In some examples of the method, apparatuses, and non-transitory computer-readable medium described herein, the uplink communication may be an uplink control channel communication and the uplink grant indicates a repetition level and resource allocation for the uplink control channel communication over multiple slots. In some examples of the method, apparatuses, and non-transitory computer-readable medium described herein, the one or more repetitions of the uplink communication include retransmissions of a same communication or different redundancy versions (RVs) of the uplink communication. In some examples of the method, apparatuses, and non-transitory computer-readable medium described herein, the uplink communication may be an uplink shared channel communication and the uplink grant indicates a repetition level and resource allocation for the uplink shared channel communication over multiple slots. In some examples of the method, apparatuses, and non-transitory computer-readable medium described herein, a timing between the uplink grant and the uplink shared channel communication corresponds to a predetermined repetition of the one or more repetitions of the uplink shared channel communication.

A method of wireless communications at a base station is described. The method may include determining that coverage enhancement is to be used for communications with a UE, identifying, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmitting a set of repetitions of the downlink control channel transmission using the set of resources.

An apparatus for wireless communications at a base station is described. The apparatus may include a processor, and a memory coupled with the processor, the memory and processor configured to determine that coverage enhancement is to be used for communications with a UE, identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmit a set of repetitions of the downlink control channel transmission using the set of resources.

Another apparatus for wireless communications at a base station is described. The apparatus may include means for determining that coverage enhancement is to be used for communications with a UE, identifying, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmitting a set of repetitions of the downlink control channel transmission using the set of resources.

A non-transitory computer-readable medium storing code for wireless communications at a base station is described. The code may include instructions executable by a processor to determine that coverage enhancement is to be used for communications with a UE, identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmit a set of repetitions of the downlink control channel transmission using the set of resources.

In some examples of the method, apparatuses, and non-transitory computer-readable medium described herein, the repetition resource sets include resources having a periodic or non-periodic pattern across multiple consecutive or non-consecutive slots. In some examples of the method, apparatuses, and non-transitory computer-readable medium described herein, one or more of the repetition resource sets include multiple time resources, frequency resources, or combinations thereof, within a same slot. In some examples of the method, apparatuses, and non-transitory computer-readable medium described herein, the repetitions of the downlink control channel transmission include repetitions of an exact copy of the downlink control channel transmission or include different redundancy versions of the downlink control channel transmission. In some examples of the method, apparatuses, and non-transitory computer-readable medium described herein, a first part of a repetition of the downlink control channel transmission at an aggregation level is associated with a first control resource set transmitted by the base station, and a second part of the repetition of the downlink control channel transmission is associated with a second control resource set transmitted by the base station. In some examples of the method, apparatuses, and non-transitory computer-readable medium described herein, the repetition resources include one or more configured search spaces of a set of available search spaces.

In some examples of the method, apparatuses, and non-transitory computer-readable medium described herein, the one or more configured search spaces include all search space candidates for an indicated number of slots, search space candidates up to an indicated repetition level, or search space candidates that are determined based on a gap that indicates how many search space candidates are skipped between two repetitions. In some examples of the method, apparatuses, and non-transitory computer-readable medium described herein, a repetition level of the one or more repetitions of the downlink control channel transmission is determined based on mapping between the repetition level and a scrambling identification, a radio network temporary identifier (RNTI), or a DCI size.

Some examples of the method, apparatuses, and non-transitory computer-readable medium described herein may further include operations, features, means, or instructions for determining the first repetition resource set for the downlink control channel transmission based on a configured search space of a set of search spaces that has candidates for downlink control channel communications, and deriving one or more repetition resource sets based on the first repetition resource set. In some examples of the method, apparatuses, and non-transitory computer-readable medium described herein, the repetition resource sets include two or more different time resources, two or more different frequency resources, two or more resources associated with different control resource sets, or any combinations thereof. In some examples of the method, apparatuses, and non-transitory computer-readable medium described herein, the repetition resource sets may be derived based on one or more of a time shift and repetition level associated with the first repetition resource set, and where the time shift may be a fixed time shift, a deterministic time shift, or a pseudo-random time shift relative to the first repetition resource set. In some examples of the method, apparatuses, and non-transitory computer-readable medium described herein, the repetition resource sets may be derived based on one or more of a frequency shift and repetition level associated with the first repetition resource set, and where the frequency shift may be a fixed frequency shift, a deterministic frequency shift, or a pseudo-random frequency shift relative to the first repetition resource set. In some examples of the method, apparatuses, and non-transitory computer-readable medium described herein, the repetition resource sets may be derived based on a control resource set shift associated with the first repetition resource set and the control resource set configuration, and where the control resource set shift indicates one or more control resource sets that carry one or more repetitions of the downlink control channel transmission.

Some examples of the method, apparatuses, and non-transitory computer-readable medium described herein may further include operations, features, means, or instructions for transmitting an indication to the UE that repetitions of the downlink control channel transmission are enabled and that indicates whether the repetitions are slot-based repetitions or control resource set based repetitions. In some examples of the method, apparatuses, and non-transitory computer-readable medium described herein, the indication may be transmitted in a MIB that indicates whether repetitions are used, a repetition level, shift information, or any combinations thereof. In some examples of the method, apparatuses, and non-transitory computer-readable medium described herein, the repetition resource sets may be determined based on a mapping between the MIB information and one or more time locations, frequency locations, a repetition level, or any combinations thereof. In some examples of the method, apparatuses, and non-transitory computer-readable medium described herein, the downlink control channel transmission includes a grant of downlink shared channel resources, and where the downlink shared channel resources start before or after a final repetition resource.

A method of wireless communications at a base station is described. The method may include identifying a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmitting, to the UE, a control channel communication that indicates the set of shared channel resources, and transmitting a set of repetitions of the downlink shared channel transmission according to the repetition pattern, using the set of shared channel resources.

An apparatus for wireless communications at a base station is described. The apparatus may include a processor, and a memory coupled with the processor, the memory and processor configured to identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmit, to the UE, a control channel communication that indicates the set of shared channel resources, and transmit a set of repetitions of the downlink shared channel transmission according to the repetition pattern, using the set of shared channel resources.

Another apparatus for wireless communications at a base station is described. The apparatus may include means for identifying a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmitting, to the UE, a control channel communication that indicates the set of shared channel resources, and transmitting a set of repetitions of the downlink shared channel transmission according to the repetition pattern, using the set of shared channel resources.

A non-transitory computer-readable medium storing code for wireless communications at a base station is described. The code may include instructions executable by a processor to identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmit, to the UE, a control channel communication that indicates the set of shared channel resources, and transmit a set of repetitions of the downlink shared channel transmission according to the repetition pattern, using the set of shared channel resources.

In some examples of the method, apparatuses, and non-transitory computer-readable medium described herein, the downlink shared channel communication may have multiple repetitions in a same slot. In some examples of the method, apparatuses, and non-transitory computer-readable medium described herein, the repetition pattern provided may be provided in DCI in the control channel communication, and where the DCI further indicates a duration that repetitions according to the repetition pattern are to be transmitted, a number of slots between consecutive repetitions, or any combinations thereof. In some examples of the method, apparatuses, and non-transitory computer-readable medium described herein, the control channel communication further indicates whether different redundancy versions (RVs) are used for consecutive repetitions of the downlink shared channel communication, and where the buffering is further based on whether the different RVs are used for the consecutive repetitions.

A method of wireless communications at a base station is described. The method may include determining that coverage enhancement is to be used for physical broadcast channel communications with at least one UE, allocating a set of physical broadcast channel resources based on the determining, the set of physical broadcast channel resources including two or more repetition resources for two or more repetitions of the physical broadcast channel communications, and transmitting a set of instances of the physical broadcast channel communications using the set of physical broadcast channel resources.

An apparatus for wireless communications at a base station is described. The apparatus may include a processor, and a memory coupled with the processor, the memory and processor configured to determine that coverage enhancement is to be used for physical broadcast channel communications with at least one UE, allocate a set of physical broadcast channel resources based on the determining, the set of physical broadcast channel resources including two or more repetition resources for two or more repetitions of the physical broadcast channel communications, and transmit a set of instances of the physical broadcast channel communications using the set of physical broadcast channel resources.

Another apparatus for wireless communications at a base station is described. The apparatus may include means for determining that coverage enhancement is to be used for physical broadcast channel communications with at least one UE, allocating a set of physical broadcast channel resources based on the determining, the set of physical broadcast channel resources including two or more repetition resources for two or more repetitions of the physical broadcast channel communications, and transmitting a set of instances of the physical broadcast channel communications using the set of physical broadcast channel resources.

A non-transitory computer-readable medium storing code for wireless communications at a base station is described. The code may include instructions executable by a processor to determine that coverage enhancement is to be used for physical broadcast channel communications with at least one UE, allocate a set of physical broadcast channel resources based on the determining, the set of physical broadcast channel resources including two or more repetition resources for two or more repetitions of the physical broadcast channel communications, and transmit a set of instances of the physical broadcast channel communications using the set of physical broadcast channel resources.

In some examples of the method, apparatuses, and non-transitory computer-readable medium described herein, each repetition of the physical broadcast channel communications use a same set of beamforming parameters. In some examples of the method, apparatuses, and non-transitory computer-readable medium described herein adjacent sets of physical broadcast channel resources for two or more repetitions of the physical broadcast channel communication are determined based on a defined time gap between adjacent repetitions. In some examples of the method, apparatuses, and non-transitory computer-readable medium described herein, two or more sets of physical broadcast channel frequency resources may be defined within a slot, and where two or more repetitions of the physical broadcast channel communication use different sets of physical broadcast channel frequency resources within the slot. In some examples of the method, apparatuses, and non-transitory computer-readable medium described herein, the two or more repetitions of the physical broadcast channel communication use a same system frame number (SFN) as an initial transmission of the physical broadcast channel communication. In some examples of the method, apparatuses, and non-transitory computer-readable medium described herein, the two or more repetitions of the physical broadcast channel communication use a same half-frame bit associated with a system frame number as an initial transmission of the physical broadcast channel communication.

A method of wireless communications at a base station is described. The method may include determining that coverage enhancement is to be used for communications with a UE, allocating a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmitting an uplink grant for the uplink communication to the UE, buffering received signals from two or more of the set of uplink resources based on the uplink grant, and decoding the uplink communication based on the buffered received signals.

An apparatus for wireless communications at a base station is described. The apparatus may include a processor, and a memory coupled with the processor, the memory and processor configured to determine that coverage enhancement is to be used for communications with a UE, allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmit an uplink grant for the uplink communication to the UE, buffer received signals from two or more of the set of uplink resources based on the uplink grant, and decode the uplink communication based on the buffered received signals.

Another apparatus for wireless communications at a base station is described. The apparatus may include means for determining that coverage enhancement is to be used for communications with a UE, allocating a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmitting an uplink grant for the uplink communication to the UE, buffering received signals from two or more of the set of uplink resources based on the uplink grant, and decoding the uplink communication based on the buffered received signals.

A non-transitory computer-readable medium storing code for wireless communications at a base station is described. The code may include instructions executable by a processor to determine that coverage enhancement is to be used for communications with a UE, allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmit an uplink grant for the uplink communication to the UE, buffer received signals from two or more of the set of uplink resources based on the uplink grant, and decode the uplink communication based on the buffered received signals.

In some examples of the method, apparatuses, and non-transitory computer-readable medium described herein, the uplink communication may be an uplink control channel communication and the uplink grant indicates a repetition level and resource allocation for the uplink control channel communication over multiple slots. In some examples of the method, apparatuses, and non-transitory computer-readable medium described herein, the one or more repetitions of the uplink communication include retransmissions of a same communication or different redundancy versions (RVs) of the uplink communication. In some examples of the method, apparatuses, and non-transitory computer-readable medium described herein, the uplink communication may be an uplink shared channel communication and the uplink grant indicates a repetition level and resource allocation for the uplink shared channel communication over multiple slots. In some examples of the method, apparatuses, and non-transitory computer-readable medium described herein, a timing between the uplink grant and the uplink shared channel communication corresponds to a predetermined repetition of the one or more repetitions of the uplink shared channel communication.

### BRIEF DESCRIPTION OF THE DRAWINGS

FIG. 1 illustrates an example of a system for wireless communications that supports reliability and coverage enhancement for non-terrestrial networks (NTNs) in accordance with aspects of the present disclosure.

FIG. 2 illustrates an example of a portion of a wireless communications system that supports reliability and coverage enhancement for NTNs in accordance with aspects of the present disclosure.

FIG. 3 illustrates an example of a repetition pattern that supports reliability and coverage enhancement for NTNs in accordance with aspects of the present disclosure.

FIG. 4 illustrates an example of a cross-CORESET aggregation that supports reliability and coverage enhancement for NTNs in accordance with aspects of the present disclosure.

FIGS. 5 through 7 illustrate examples of search space sets that support reliability and coverage enhancement for NTNs in accordance with aspects of the present disclosure.

FIGS. 8 through 11 illustrate examples of slot bundling patterns that support reliability and coverage enhancement for NTNs in accordance with aspects of the present disclosure.

FIG. 12 illustrates an example of a control channel and shared channel slot pattern that supports reliability and coverage enhancement for NTNs in accordance with aspects of the present disclosure.

FIG. 13 through 14 illustrate examples of SIB repetition patterns that support reliability and coverage enhancement for NTNs in accordance with aspects of the present disclosure.

FIG. 15 illustrates an example of scheduling patterns that support reliability and coverage enhancement for NTNs in accordance with aspects of the present disclosure.

FIG. 16 illustrates an example of control channel slot bundling patterns that support reliability and coverage enhancement for NTNs in accordance with aspects of the present disclosure.

FIG. 17 illustrates an example of broadcast channel slot bundling patterns that support reliability and coverage enhancement for NTNs in accordance with aspects of the present disclosure.

FIG. 18 illustrates an example of a uplink control channel resources and bundling pattern that supports reliability and coverage enhancement for NTNs in accordance with aspects of the present disclosure.

FIGS. 19 and 20 show block diagrams of devices that support reliability and coverage enhancement for NTNs in accordance with aspects of the present disclosure.

FIG. 21 shows a block diagram of a communications manager that supports reliability and coverage enhancement for NTNs in accordance with aspects of the present disclosure.

FIG. 22 shows a diagram of a system including a device that supports reliability and coverage enhancement for NTNs in accordance with aspects of the present disclosure.

FIGS. 23 and 24 show block diagrams of devices that support reliability and coverage enhancement for NTNs in accordance with aspects of the present disclosure.

FIG. 25 shows a block diagram of a communications manager that supports reliability and coverage enhancement for NTNs in accordance with aspects of the present disclosure.

FIG. 26 shows a diagram of a system including a device that supports reliability and coverage enhancement for NTNs in accordance with aspects of the present disclosure.

FIGS. 27 through 36 show flowcharts illustrating methods that support reliability and coverage enhancement for NTNs in accordance with aspects of the present disclosure.

### DETAILED DESCRIPTION

Various aspects of the present disclosure relate to providing enhanced communications reliability in wireless communications systems in which relatively large distances may be present between different wireless nodes. Such systems may include, for example, non-terrestrial networks (NTNs) that may provide coverage by using high-altitude vehicles between user terminals and gateways or base stations (e.g., next-generation NodeBs or giga-NodeBs (which may be referred to as a gNB, and also referred to as access stations or access gateways)). While various examples discussed herein refer to NTNs, techniques discussed herein may be used in any networks in which signals between two devices may be affected from coverage enhancement techniques (e.g., due to large distances between nodes, large amounts of signal attenuation between devices, lower limitations of one or more devices, etc.). A base station or gateway may, for example, transmit data to a satellite which may then be relayed to a user terminal or vice-versa. A high-altitude vehicle itself may be a base station, in some examples. A user terminal may be any device having capability to transmit signals to a satellite or high altitude node. Examples of a user terminal may include a UE, a relay equipment configured to relay a signal between a satellite and a user terminal, or a combination thereof. In some cases, NTNs may involve the use of high altitude platform stations (HAPSs) and/or satellites to provide coverage for terrestrial base stations and UEs. The terms HAPS and satellite may be used interchangeably herein to refer to a remote NTN device that may provide coverage to one or more other high altitude or terrestrial devices. Likewise, the terms gateway and base station may be used interchangeably herein to refer to a network node that serves a UE and provides network access to the UE. In some cases, the base station (e.g. gNB) may be itself on the satellite, or the functionality of the base station may be split between the satellite and the gateway (e.g. the satellite may be a DU and the gateway a CU, or other architectures).

The gateway and the satellite may be thousands of kilometers apart which may result in signal degradation as electromagnetic waves to propagate over the distance between the gateway and the satellite and between the satellite and the user terminal. Further, in some cases, acknowledgment feedback (e.g., hybrid automatic repeat request (HARM) feedback) may be disabled in NTN systems due to relatively long round trip delays that may exceed feedback timelines. In cases where acknowledgment feedback is disabled, a lower block error rate (BLER) may be used in order to provide communications with relatively fewer higher layer retransmissions required. For example, the operating SNR for 1200 km orbit and 0.4 MHz channel bandwidth could be as low as −8.6 dB. In accordance with various aspects of the disclosure, in order to provide a lower BLER in such situations, coverage enhancement techniques may be provided, which may support communications with handheld devices such as handheld UEs. Coverage enhancement technique may include, for example, slot bundling for physical downlink control channel (PDCCH) communications, in which repetitions of a PDCCH may occupy multiple time-frequency locations spanning multiple slots. Such slots may be consecutive or non-consecutive, and in some cases multiple repetitions of the PDCCH may be provided within the same slot. The pattern of the time-frequency locations of repetitions may be periodic or non-periodic. Further, the repetitions may be copies, or different redundancy versions of the same encoded DCI. Additionally, repetitions of uplink or downlink shared channel communications, uplink or downlink control channel communication, broadcast channel communications, or any combinations thereof, may be provided.

Particular aspects of the subject matter described herein may be implemented to realize one or more potential aspects. The described techniques may support NTN through reduced BLER between a base station or satellite and one or more UEs served by the base station or satellite. For instance, the described techniques may provide for reliability and network efficiency, etc., in communications between high-altitude vehicles (e.g., satellites or other high altitude or non-terrestrial-based equipment), user terminals, and gateways, in NTNs, among other aspects. As such, supported techniques may include features for efficient NTNs and efficient non-terrestrial communications. The described techniques may also support increased spectral efficiency, among other aspects.

Aspects of the disclosure are initially described in the context of wireless communications systems. Various examples of repetition patterns and signaling for repetitions are then discussed. Aspects of the disclosure are further illustrated by and described with reference to apparatus diagrams, system diagrams, and flowcharts that relate to reliability and coverage enhancement for NTNs.

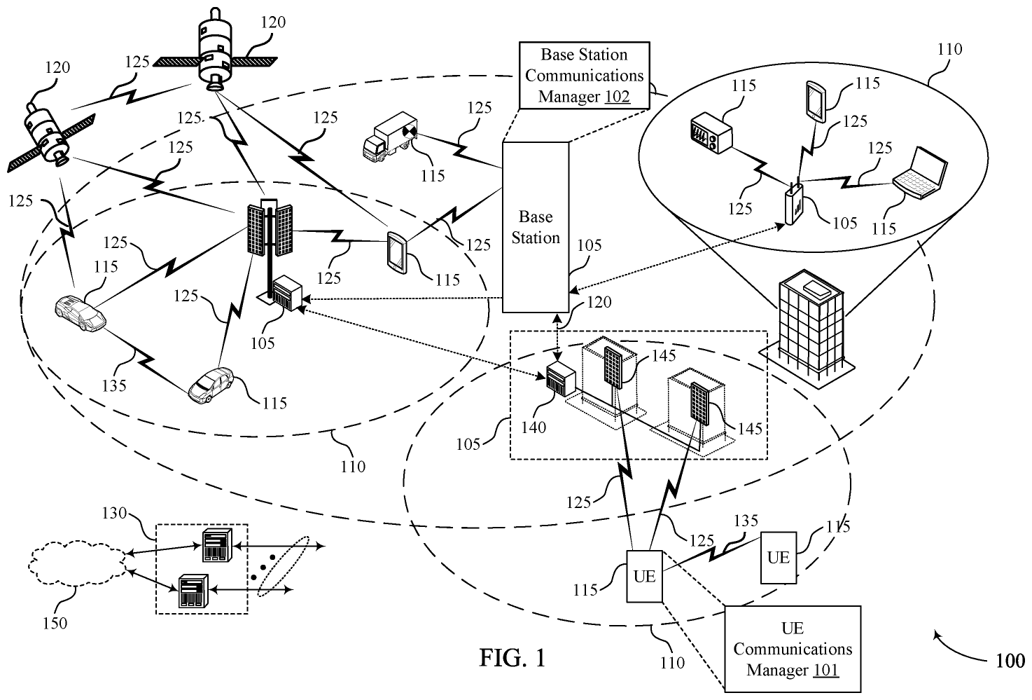

FIG. 1 illustrates an example of a wireless communications system 100 that supports reliability and coverage enhancement for NTNs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links (e.g., via an S1, N2, N3, or other interface). The base stations 105 may communicate with one another over the backhaul links (e.g., via an X2, Xn, or other interface) either directly (e.g., directly between base stations 105), or indirectly (e.g., via core network 130), or both. In some examples, the backhaul links may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 includes base stations 105, UEs 115, satellites 120, and a core network 130. In some examples, the wireless communications system 100 may be an LTE network, an LTE-A network, an LTE-A Pro network, or a NR network. In some cases, wireless communications system 100 may support enhanced broadband communications, ultra-reliable (e.g., mission critical) communications, low latency communications, or communications with low-cost and low-complexity devices.

Wireless communications system 100 may also include one or more satellites 120. Satellite 120 may communicate with base stations 105 (also referred to as gateways in NTNs) and UEs 115 (or other high altitude or terrestrial communications devices). Satellite 120 may be any suitable type of communication satellite configured to relay communications between different end nodes in a wireless communication system. Satellite 120 may be an example of a space satellite, a balloon, a dirigible, an airplane, a drone, an unmanned aerial vehicle, and/or the like. In some examples, the satellite 120 may be in a geosynchronous or geostationary earth orbit, a low earth orbit or a medium earth orbit. A satellite 120 may be a multi-beam satellite configured to provide service for multiple service beam coverage areas in a predefined geographical service area. The satellite 120 may be any distance away from the surface of the earth.

In some cases, a cell may be provided or established by a satellite 120 as part of a non-terrestrial network. A satellite 120 may, in some cases, perform the functions of a base station 105, act as a bent-pipe satellite, or may act as a regenerative satellite, or a combination thereof. In other cases, satellite 120 may be an example of a smart satellite, or a satellite with intelligence. For example, a smart satellite may be configured to perform more functions than a regenerative satellite (e.g., may be configured to perform particular algorithms beyond those used in regenerative satellites, to be reprogrammed, etc.). A bent-pipe transponder or satellite may be configured to receive signals from ground stations and transmit those signals to different ground stations. In some cases, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, or a combination thereof. For example, a bent-pipe satellite (e.g., satellite 120) may receive a signal from a base station 105 and may relay the signal to a UE 115 or base station 105, or vice-versa. In accordance with various aspects of the present disclosure, coverage enhancement for communications with satellites 120 may be provided through repetitions of communications, which may reduce BLER and enhance communications reliability.

A UE 115 may include a UE communications manager 101 (e.g., which may be examples of a communications manager 2210 described herein). The UE communications manager 101 may receive, from a base station 105 or a satellite 120, an indication of a repetition activation for communications. The UE communications manager 101 may determine, responsive to the repetition indication, resources for communications that contain repetitions. When receiving communications, the UE communications manager 101 may buffer signals from resources containing multiple transmissions, and attempt to decode the associated communication. In some cases, when transmitting an uplink message to the base station 105 or the satellite 120, the UE communications manager 101 may prepare multiple repetitions of the communication based on the configured repetitions. Further, in some cases, uplink messages may be transmitted using a smaller frequency bandwidth than a full channel bandwidth, in order to provide a higher power density and enhance the likelihood of reception of the uplink message.

A base station 105 may include a base station communications manager 102 (e.g., which may be examples of a communications manager 2610 described herein). The base station communications manager 102 may configure a coverage enhancement scheme at one or more UEs 115 in which a number of repetitions of communications are provided to help reduce BLER. Repetitions may be provided through slot bundling for PDCCH in consecutive or non-consecutive slots, or through multiple repetitions within the same slot.

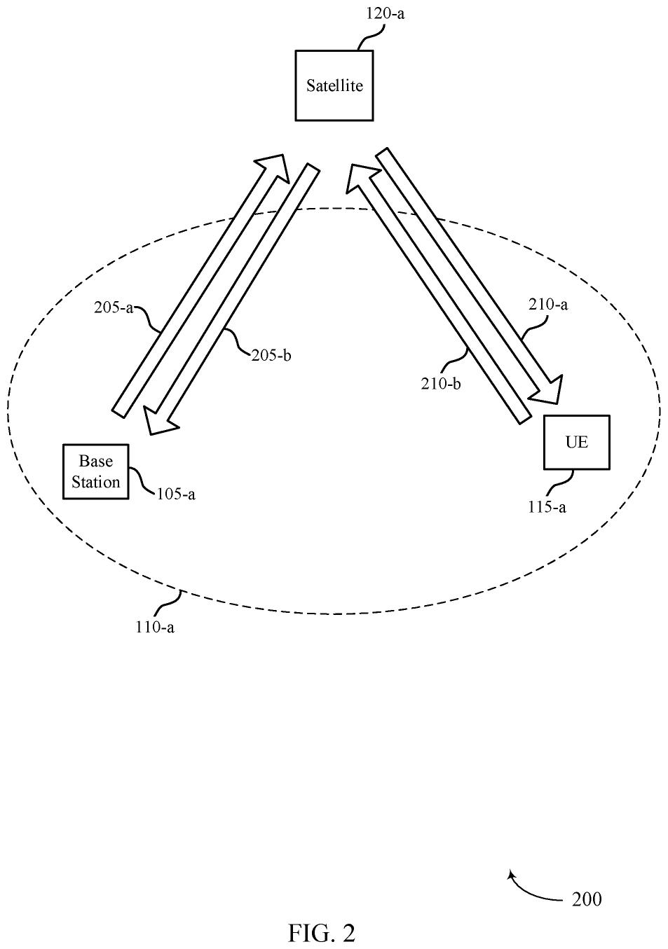

FIG. 2 illustrates an example of a wireless communications system 200 that supports reliability and coverage enhancement for NTNs in accordance with aspects of the present disclosure. In some examples, wireless communications system 200 may implement aspects of wireless communications system 100. Wireless communications system 200 may include a gateway such as base station 105-a, a UE 115-a, and a satellite 120-a (e.g., which in some cases may also be referred to as a base station), which may be examples of a base station 105, UEs 115, and satellites 120 as described with reference to FIG. 1. The base station 105-a may serve a coverage area 110-a in cases of a terrestrial network, and the satellite 120-a may serve coverage area 110-a in cases where the satellite 120-a acts as a base station of an NTN.

In some examples, the satellite 120-a may relay communications between the base station 105-a and the UE 115-a. For example, the base station 105-a may communicate with the UE 115-a via the satellite 120-a or vice-versa. In some examples, for communications originating at the base station 105-a and going to the UE 115-a (i.e., downlink communications), the base station 105-a may transmit via first link 205-a to the satellite 120-a. In some cases, the link 205 between the base station 105-a and the satellite 120-a may be referred to as a feeder link. The satellite 120-a may relay the transmission via second link 210-a as a downlink transmission to the UE 115-a. In some cases, the link 210 between the satellite 120 and the UE 115-a may be referred to as a service link. In other examples, for communications originating at the UE 115-a and going to the base station 105-a, the UE 115-a may transmit an uplink transmission to the satellite 120-a via third link 210-b. The satellite 120-a may relay the uplink transmission to base station 105-b via fourth link 205-b.

The base station 105-a and the satellite 120-a may be thousands of kilometers apart and it may take some time for electromagnetic waves to propagate over the distance between the base station 105-a and the satellite 120-a and between the satellite 120-a and the UE 115-a. The propagation delay for NTNs may be many orders of magnitude larger than the propagation delay for terrestrial networks. By way of example, the satellite 120-a may be in an orbit, such as low earth orbit, medium earth orbit, other non-geostationary earth orbit, or geostationary earth orbit. In any of these examples, the satellite 120-a may be many thousands of kilometers from earth, and therefore may be thousands of kilometers from the base station 105-a and the UE 115-a. Each transmission via links 205 or 210 between the base station 105-a and the UE 115-a may therefore travel from earth the distance to the satellite 120-a and back to earth. The distance that a transmission travels may result in substantial signal degradation due to, for example, atmospheric effects, interference from other radio frequency sources, signal attenuation due to vegetation or structures, and the like.

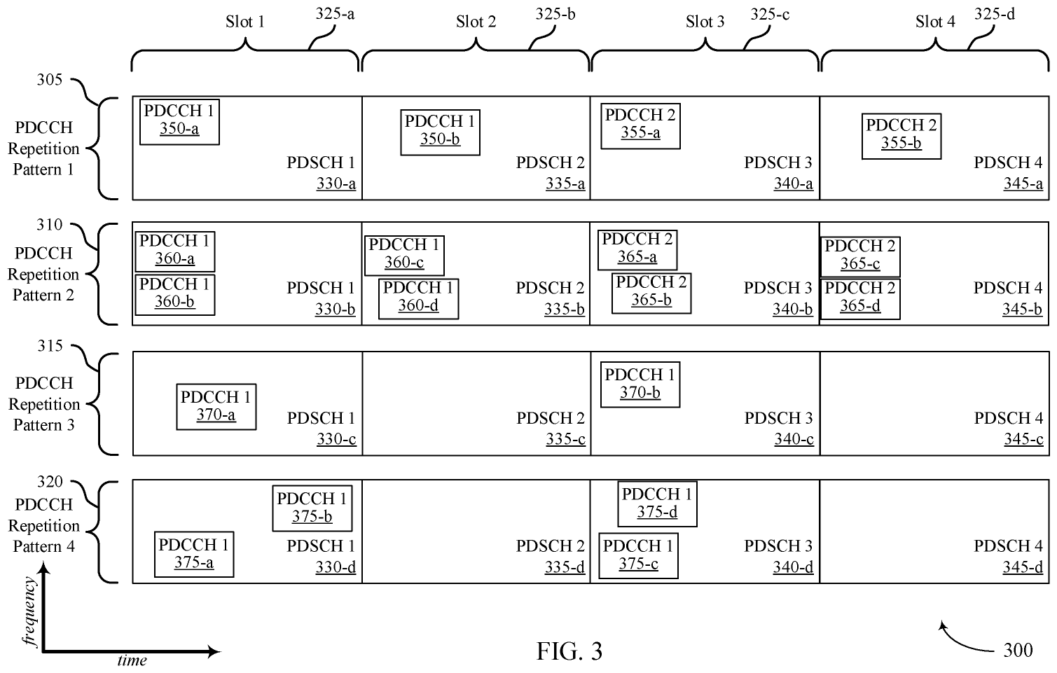

Further, due to the relatively large round trip delay (RTD) associated with propagation delays between the satellite 120-a and the UE 115-a and base station 105-a HARQ feedback may be disabled due to the RTD exceeding HARQ timelines. When HARQ feedback is disabled, it may be desirable to have a relatively low BLER, in order to provide efficient communications without a large number of higher layer retransmissions (e.g., based on RLC or PDCP feedback). In accordance with various aspects as discussed herein, one or more coverage enhancement techniques may be implemented in NTNs that provide for multiple repetitions of a communication, which may be used to enhance the likelihood of successful receipt of a communication and thereby provide BLERs that are within BLER targets for such communications. In some cases, coverage enhancement techniques may include providing repetitions of transmission of PDCCH, PDSCH, PBCH, PUCCH, PUSCH, or any combinations thereof. FIGS. 3 through 18 provide various examples of repetition techniques in accordance with techniques as discussed herein.

FIG. 3 illustrates an example of a repetition pattern 300 that supports reliability and coverage enhancement for NTNs in accordance with aspects of the present disclosure. In some examples, repetition pattern 300 may be implemented in aspects of wireless communications system 100. In this example, a number of repetition patterns are illustrated, including a first repetition pattern 305, a second repetition pattern 310, a third repetition pattern 315, and a fourth repetition pattern 320. Repetition patterns 305 through 320 are illustrated for a number of slots 325, including a first slot 325-a, a second slot 325-b, a third slot 325-c, and a fourth slot 325-d.

In the examples of FIG. 3, slot bundling may be used for transmitting multiple repetitions of PDCCH communications. Different repetitions of a PDCCH occupy multiple time-frequency locations spanning multiple slots 325, where the slots 325 can be either consecutive or non-consecutive. For example, slot bundling may have R repetitions over N slots. In one example, the first repetition pattern 305 may have R=2 repetitions and N=2 consecutive slots, providing a first repetition 350-a of a first PDCCH in first slot 325-a (e.g., multiplexed with a first PDSCH 330-a), and a second repetition 350-b of the first PDCCH in second slot 325-b that is consecutive to the first slot 325-a (e.g., multiplexed with a second PDSCH 335-a). In this example, a first repetition 355-a of a second PDCCH in third slot 325-c (e.g., multiplexed with a third PDSCH 340-a), and a second repetition 355-b of the second PDCCH in fourth slot 325-d that is consecutive to the third slot 325-c (e.g., multiplexed with a fourth PDSCH 345-a).

The second repetition pattern 310 may provide multiple repetitions of the PDCCH within the same slot. In this example, slot bundling may have R=4 repetitions over N=2 slots, providing a first repetition 360-a and a second repetition 360-b of the first PDCCH in the first slot 325-a (e.g., multiplexed with first PDSCH 330-b), and a third repetition 360-c and a fourth repetition 360-d of the first PDCCH in second slot 325-b that is consecutive to the first slot 325-a (e.g., multiplexed with second PDSCH 335-b). Likewise, in this example, a first repetition 365-a and a second repetition 365-b of second PDCCH are in third slot 325-c (e.g., multiplexed with a third PDSCH 340-a), and a third repetition 365-c and a fourth repetition 365-d of the second PDCCH is in fourth slot 325-d that is consecutive to the third slot 325-c (e.g., multiplexed with fourth PDSCH 345-b). The pattern of the time-frequency locations of repetitions can be periodic or non-periodic, and the repetitions can be exact copies or different redundancy versions (RVs) of the same encoded DCI.

In cases where slots 325 are non-consecutive, the third repetition pattern 315 may have R=2 repetitions and N=2 non-consecutive slots with a gap of one slot (e.g., G=1), providing a first repetition 370-a of first PDCCH in first slot 325-a (e.g., multiplexed with first PDSCH 330-c), and a second repetition 370-b of the first PDCCH in third slot 325-c (e.g., multiplexed with third PDSCH 340-c). The fourth repetition pattern 320 may have multiple repetitions within a slot and repetitions that are in non-consecutive slots (e.g., R=4, N=2, G=1), providing a first repetition 375-a and a second repetition 375-b of first PDCCH in first slot 325-a (e.g., multiplexed with first PDSCH 330-d), and a third repetition 375-c and a fourth repetition 375-d of the first PDCCH in third slot 325-c (e.g., multiplexed with third PDSCH 340-d).

While the examples of FIG. 3 show repetitions of PDCCH transmissions, similar techniques may be used for other channels, as discussed herein. For example, slot bundling may be used for PUSCH transmissions in a similar manner as for PDCCH as illustrated in FIG. 3. Additionally, in some cases, a timing parameter between downlink control information (DCI) that schedules a PUSCH and the PUSCH transmission (e.g., the K2 parameter) may refer to a fixed repetition among all repetitions of the PUSCH (e.g., the final repetition). Further, in some cases, UE may be in power limited regime, and PUSCH transmissions may be configured to span a narrower bandwidth than downlink communications with repetitions across multiple slots, which can boost the signal to noise ratio. A repetition level R may be defined and signaled to the UE, and the resource allocation for PUSCH over multiple slots may be configured for one slot with R. The repetitions may be identical or different redundancy versions of the same codeword.

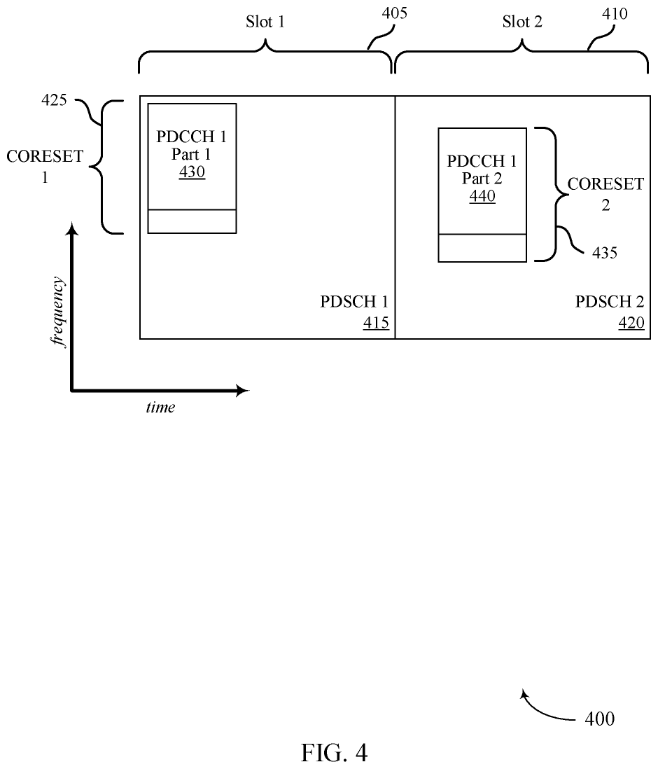

FIG. 4 illustrates an example of a cross-CORESET aggregation 400 that supports reliability and coverage enhancement for NTNs in accordance with aspects of the present disclosure. In some examples, cross-CORESET aggregation 400 may be implemented in aspects of wireless communications system 100 or 200. In some cases, signaling for slot bundling may be provided in one or more CORESETs.

In the example of FIG. 4, signaling is provided across CORESETs. In some cases, only aggregation levels above a threshold (e.g., aggregation level 8) are used for the repetitions of a transmission (e.g., PDCCH), and other aggregation levels, such as aggregation levels 32 and 64, may be adopted. In some cases, an aggregation level may be mapped to multiple CORESETs, which may or may not be in the same slot. In the example of FIG. 4, a first slot 405 and a second slot 410 may be used to transmit, respectively, a first PDSCH 415 and a second PDSCH 420. In this example, a first CORESET 425 may include a first part of a first PDCCH 430, in the first slot 405, and a second CORESET 435 may include a second part of the first PDCCH 440. Such mapping may be useful, in some cases, if a relatively large aggregation level is used to improve coverage.

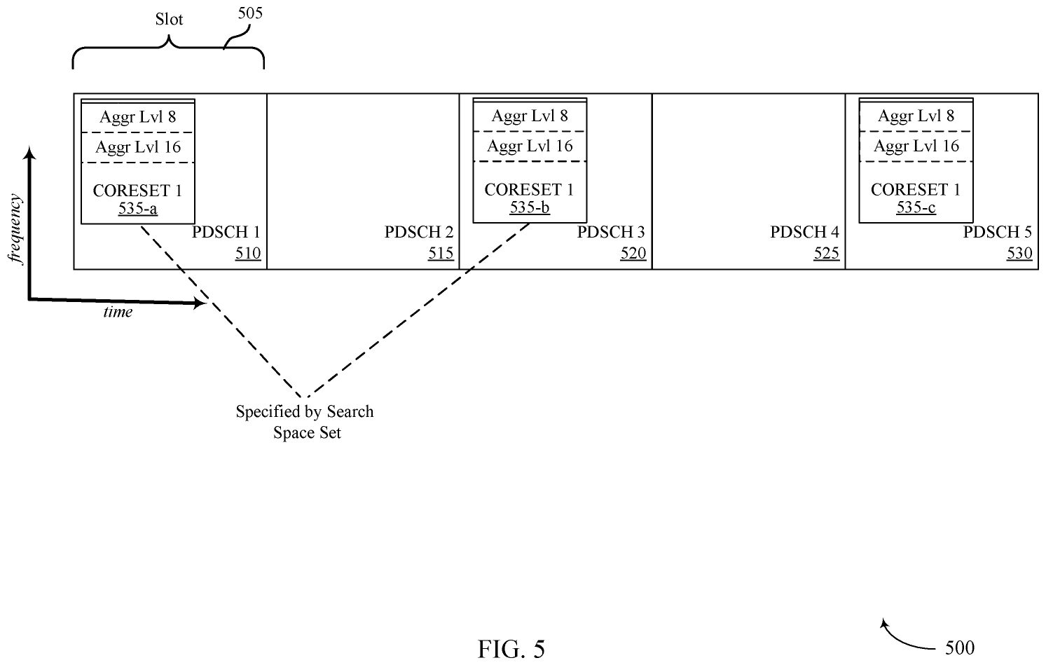

In some cases, repetitions of a PDCCH may be limited to configured search spaces. For example, a network node may specify that within a time interval the PDCCH candidates defined by a search space set correspond to repetitions of a same PDCCH (e.g., all PDCCH candidates carry the same DCI). Such a time interval may be identified, for example, by a starting slot (e.g., Nₛₜₐᵣₜ) and a duration (e.g., T slots). A UE may combine or buffer all possible PDCCH candidates at a certain aggregation level within the time interval, and attempt to decode the combined PDCCH. In some cases, a repetition level R may be configured (e.g., in a master information block (MIB), system information block (SIB), remaining minimum system information (RMSI), radio resource control (RRC) signaling, or any combinations thereof) that may indicate how many repetitions in total are present. A UE may then try to combine the first R PDCCH candidates and decode. In some cases, the signaling for slot bundling may also indicate a gap (e.g., G) that may be configured to indicate how many search space set occasions are skipped between two adjacent search space set occasions in blind decoding. In some instances, one aggregation level may completely overlap another aggregation level, and signaling for the slot bundling may further provide an indication to avoid ambiguity of which aggregation level is used. FIG. 5 provides an illustration of such a situation.

FIG. 5 illustrates an example of a search space set 500 that supports reliability and coverage enhancement for NTNs in accordance with aspects of the present disclosure. In some examples, search space set 500 may be implemented in aspects of wireless communications system 100 or 200. In this example, multiple instances of a CORESET 535 may be present in multiple slots 505. In this example, five slots 505 are illustrated for, respectively, a first PDSCH 510, a second PDSCH 515, a third PDSCH 520, a fourth PDSCH 525, and a fifth PDSCH 530.

In the example of FIG. 5, a first instance of the CORESET 535-a may be transmitted with the first PDSCH 510, and the first instance of the CORESET 535-a includes a PDCCH candidate at an aggregation level (e.g., aggregation level 8) that is fully included in a PDCCH candidate at aggregation level 16. Further, a second instance of the CORESET 535-b in third PDSCH 520 and a third instance of the CORESET 535-c in the fifth PDSCH 530 may each include overlapping PDCCH candidates of different aggregation levels. Further, the first instance of the CORESET 535-a and the second instance of the CORESET 535-b may be specified by a search space set. Further, it is possible that there may be multiple candidates at an aggregation level in a CORESET, and thus which PDSCH is to be decoded based on the different CORESET instances may be ambiguous. In some cases, an indication of the repetition level (e.g., R) may indicate which PDSCH are to be decoded. For example, if R=1, the first instance of the CORESET 535-a may configure PDSCH in the first slot, and if R=2, two PDCCH repetitions in the CORESETs 535-a and 535-b together may configure third slot. In cases where two PDCCH repetitions are transmitted but the SNR at the UE is good, the UE may be able to decode the PDCCH in the first instance of the CORESET 535-a and based on the decoding assume (in the absence of an indicated repetition level) that the PDCCH applies to the first PDSCH 510 when, in fact, the PDCCH is intended for the third PDSCH 520.

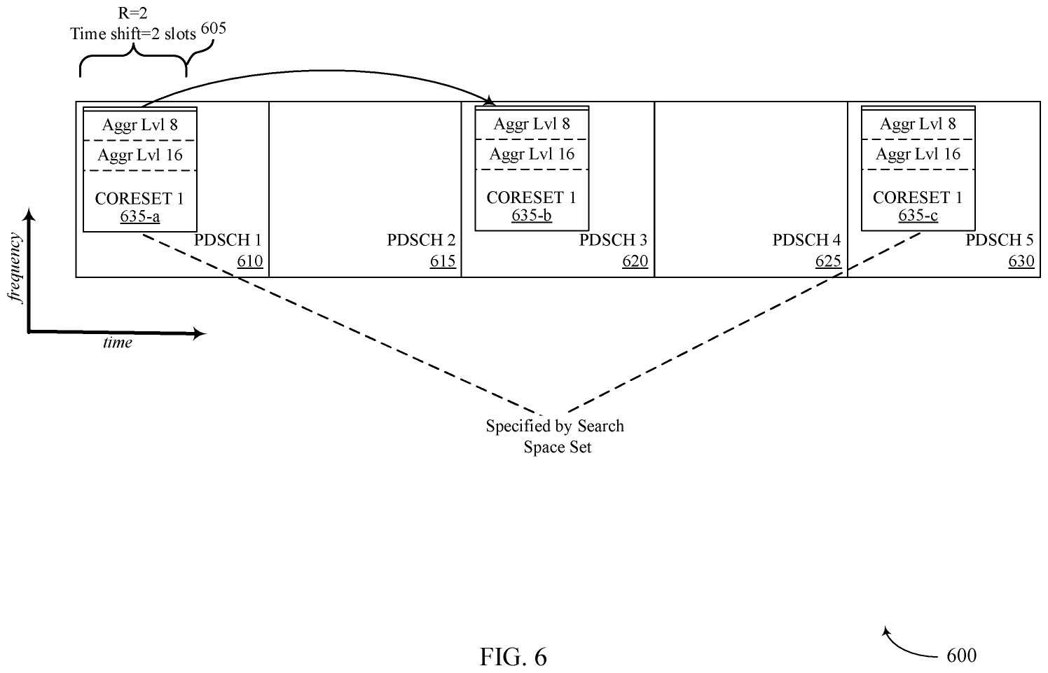

In some cases, as indicated, an indication of the repetition level associated with a PDCCH may help remove ambiguity in which shared channel communication a control channel communication configures. In other cases, additionally or alternatively, a unique PDCCH scrambling sequence (e.g., applied to the output of a rate matching block of the UE decoder) may be used for each of the repetition levels. Thus, the UE may determine the repetition level based on the scrambling sequence that successfully descrambles the PDCCH. In other cases, additionally or alternatively, a unique RNTI may be used to scramble the CRC of the DCI for each of the repetition levels, a unique DCI size may be used for the DCI (e.g., by padding zeros up to a target DCI size) at each of the repetition levels, or combinations thereof. Further, in some cases, a dropping rule may be configured for dropping one or more PDCCH candidates. Such dropping may help reduce the number of PDCCH candidates where uncertainty in repetition level may lead to an increase in the number of PDCCH candidates. In some cases, the dropping rule may be shared between the base station and the UE. For example, the UE and base station may each know to drop PDCCH candidates from the lowest repetition level first and, if needed, continue to drop PDCCH candidates at repetition levels at ascending order until a number of PDCCH candidates is less than a threshold number. In some cases, the dropping rule that is applied may be indicated in signaling from the base station to the UE (e.g., in RRC signaling, in a MAC-CE, and the like). In other cases, repetition patterns may be configured based on an initial instance of a communication and one or more rules, examples of which are discussed with reference to FIGS. 6 through 11.

FIG. 6 illustrates an example of a search space set 600 that supports reliability and coverage enhancement for NTNs in accordance with aspects of the present disclosure. In some examples, search space set 600 may be implemented in aspects of wireless communications system 100 or 200. In this example, multiple instances of a CORESET 635 may be present in multiple slots 605. In this example, five slots 605 are illustrated for, respectively, a first PDSCH 610, a second PDSCH 615, a third PDSCH 620, a fourth PDSCH 625, and a fifth PDSCH 630.

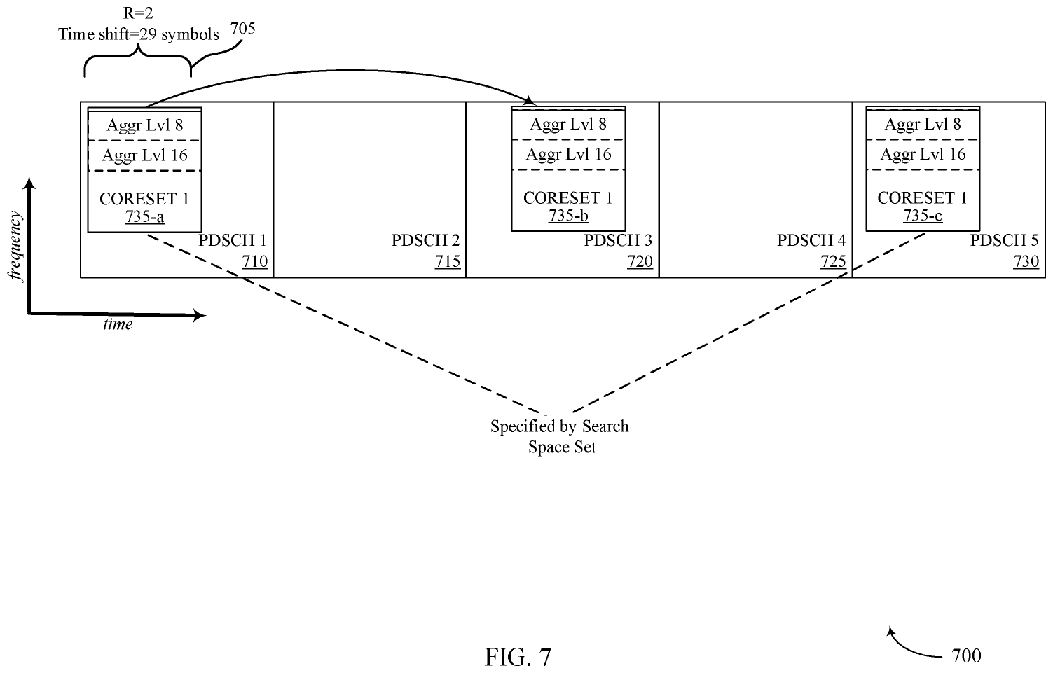

In the example of FIG. 6, a first instance of the CORESET 635-a may be transmitted with the first PDSCH 610, and the first instance of the CORESET 635-a includes a PDCCH candidate at an aggregation level (e.g., aggregation level 8). Further, a second instance of the CORESET 635-b is in third PDSCH 620 and a third instance of the CORESET 635-c is in the fifth PDSCH 630. Further, the first instance of the CORESET 635-a may be specified by a search space set. In this example, some repetitions of a PDCCH may be in configured search spaces and other repetitions are derived by the UE according to a rule. For example, only the first repetition provided in the first instance of the CORESET 635-a is in the search space configured by a search space set, and any of the other repetitions may be at a different time, frequency, or CORESETs as determined based on the rule. For example, the base station may configure a time shift in slots (e.g., as a value timeShiftInSlots), and a repetition number R (i.e., how many repetitions in total). The time shift may be fixed, deterministic, or pseudo-random (i.e., generated from a formula). In the example of FIG. 6, the first instance of the CORESET 635-a is in the search space and has a time shift of two slots and a repetition number of two, thus resulting in a second repetition of the PDCCH in the second instance of the CORESET 635-b. The search space set in such an example may include the first instance of the CORESET 635-a and the third instance of the CORESET 635-c. While the example of FIG. 6 shows the time shift as a number of slots, the time shift may be defined in other terms (e.g., an absolute time, number of symbols, etc.), such as illustrated in FIG. 7.

FIG. 7 illustrates an example of a search space set 700 that supports reliability and coverage enhancement for NTNs in accordance with aspects of the present disclosure. In some examples, search space set 700 may be implemented in aspects of wireless communications system 100 or 200. In this example, multiple instances of a CORESET 735 may be present in multiple slots 705. In this example, five slots 705 are illustrated for, respectively, a first PDSCH 710, a second PDSCH 715, a third PDSCH 720, a fourth PDSCH 725, and a fifth PDSCH 730.

In the example of FIG. 7, a first instance of the CORESET 735-a may be transmitted with the first PDSCH 710. Further, a second instance of the CORESET 735-b is in third PDSCH 720 and a third instance of the CORESET 735-c is in the fifth PDSCH 730. Further, the first instance of the CORESET 735-a may be specified by a search space set. Again in this example some repetitions of a PDCCH may be in configured search spaces and other repetitions are derived by the UE according to a rule. For example, only the first repetition provided in the first instance of the CORESET 735-a is in the search space configured by a search space set, and any of the other repetitions may be at a different time, frequency, or CORESETs as determined based on the rule. In the example of FIG. 7, the first instance of the CORESET 735-a is in the search space and has a time shift of 29 OFDM symbols (e.g., indicated as a value timeShiftInSymbols) and a repetition number of two, thus resulting in a second repetition of the PDCCH in the second instance of the CORESET 735-b. The search space set in such an example may include the first instance of the CORESET 735-a and the third instance of the CORESET 735-c. Such techniques may provide finer granularity for specifying repetitions of a PDCCH, which may provide additional flexibility to a base station scheduling repetitions.

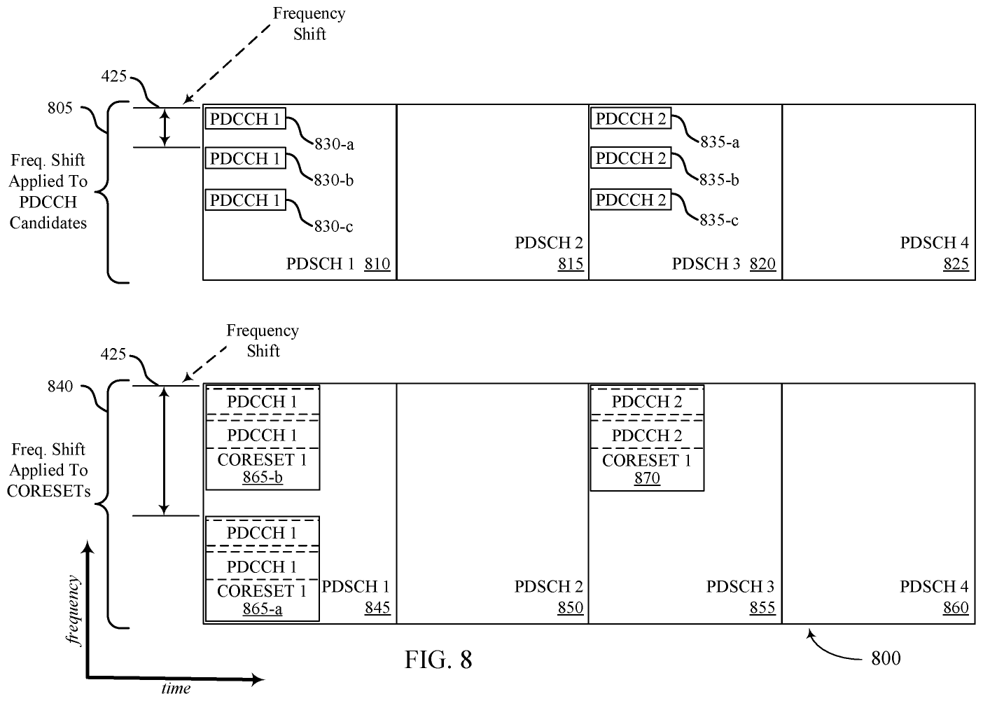

In further examples, a repetition pattern may include frequency shifts additionally or alternatively to time shifts. FIG. 8 illustrates an example of a slot bundling pattern 800 with frequency shifts that supports reliability and coverage enhancement for NTNs in accordance with aspects of the present disclosure. In some examples, slot bundling pattern 800 may be implemented in aspects of wireless communications system 100 or 200. In this example, a first repetition pattern 805 may apply a frequency shift to PDCCH candidates, and a second repetition pattern 840 may apply a frequency shift to CORESETs.

In the first repetition pattern 805, four slots are illustrated for, respectively, a first PDSCH 810, a second PDSCH 815, a third PDSCH 820, and a fourth PDSCH 825. In this example, a first instance of the PDCCH 830-a may be transmitted at a first frequency (e.g., in a first set of physical resource blocks (PRBs)) and multiplexed with the first PDSCH 810. Further, a second instance of the PDCCH 830-b may be located in the first slot at a frequency shift relative to the first instance of the PDCCH 830-a (e.g., based on a PRB shift). A third instance of the PDCCH 830-c may be located in the first slot at the frequency shift relative to the second instance of the PDCCH 830-b. Similarly, multiple instances of a second PDCCH 835 may be present in the third slot with third PDSCH 820. The frequency shift may be configured, for example, as a number of RBs (e.g., as a value freqShiftInRBs), and a repetition number R may identify how many repetitions are to be made in total (e.g., three repetitions as illustrated in FIG. 8). The frequency shift may be fixed, deterministic, or pseudo-random. Further, the frequency shift may be cyclic and provide that a repetition will wrap around if it reaches the minimum or maximum resource block ID within a bandwidth part.

As illustrated in the second repetition pattern 840, the frequency shift may be applied to CORESETs. In this pattern, four slots are illustrated for, respectively, a first PDSCH 845, a second PDSCH 850, a third PDSCH 855, and a fourth PDSCH 860. In this example, a first instance of a CORESET 865-a may carry a first PDCCH and may be transmitted at a first frequency (e.g., in a first set of physical resource blocks (PRBs) as configured in a search space set) that is multiplexed with the first PDSCH 845. Further, a second instance of the CORESET 865-b may be located in the first slot at a frequency shift relative to the first instance of the CORESET 865-a (e.g., based on a RB shift). In this example, the search space set may include CORESET 870 in the third slot that is multiplexed with third PDSCH 855. In this example, a single repetition of CORESET 870 may carry one or more repetitions of a second PDCCH. Similarly as the first repetition pattern 805, the frequency shift may be configured, for example, as a number of RBs (e.g., as a value freqShiftInRBs), and a repetition number R may identify how many repetitions are to be made in total (e.g., two CORESET repetitions as illustrated in FIG. 8). The frequency shift may be fixed, deterministic, or pseudo-random. Further, the frequency shift may be cyclic and provide that a repetition will wrap around if it reaches the minimum or maximum resource block ID within a bandwidth part.

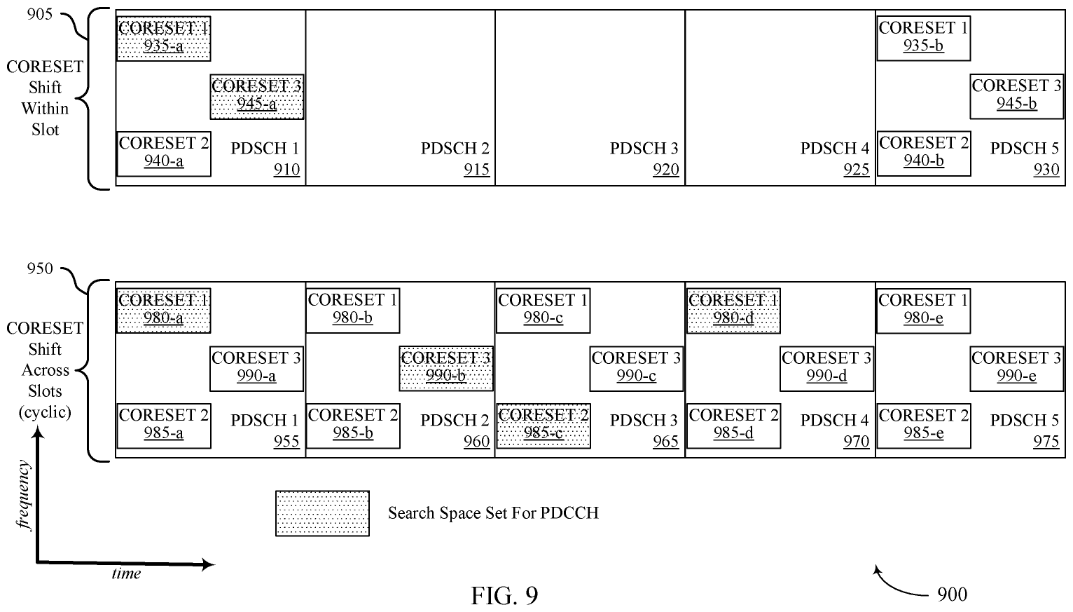

FIG. 9 illustrates an example of slot bundling patterns 900 that supports reliability and coverage enhancement for NTNs in accordance with aspects of the present disclosure. In some examples, slot bundling pattern 900 may be implemented in aspects of wireless communications system 100 or 200. In this example, a search space set may be configured to use multiple CORESETs, which may be configured with timing). In such cases, a CORESET shift (e.g., configured by a value of CORESETShift) may be configured to identify the CORESETs that carry the PDCCH repetitions.

In the example of FIG. 9, a first pattern 905 may provide for CORESET shifts within a same slot. In the first repetition pattern 905, five slots are illustrated for, respectively, a first PDSCH 910, a second PDSCH 915, a third PDSCH 920, a fourth PDSCH 925, and a fifth PDSCH 930. In this example, a first CORESET 935-a may carry a first PDCCH instance in a first set of resources (e.g., in a first set of physical resource blocks (PRBs)) and multiplexed with the first PDSCH 910. Further, a second CORESET 940-a may be located in the first slot, and a third CORESET 945-a may be located in the first slot. In this example, the fifth slot may also include the first CORESET 935-a, second CORESET 940-b, and third CORESET 945-b. In this example, the search space for PDCCH may be configured for the first slot and first CORESET 935-a, with a CORESET shift set to two, which indicates the third CORESET 945-a is also in the search space and may include a repetition of the PDCCH.

In the first pattern 905 the shift is in a same slot, although the shift can be for a following slot, such as in the example of the second pattern 950. In this example, five slots again are illustrated for, respectively, a first PDSCH 955, a second PDSCH 960, a third PDSCH 965, a fourth PDSCH 970, and a fifth PDSCH 975. In this example, a first CORESET 980, a second CORESET 985, and a third CORESET 990 be configured in each slot, and the CORESET shift for PDCCH repetition monitoring may be configured to provide a shift of two CORESETs for each successive slot with a repetition level of four, and the shift may be cyclic. Thus, in this example, the UE may monitor for PDCCH in the first CORESET 980-a in the first slot, the third CORESET 990-b in the second slot, the second CORESET 985-a in the third slot, the first CORESET 980-d in the fourth slot.

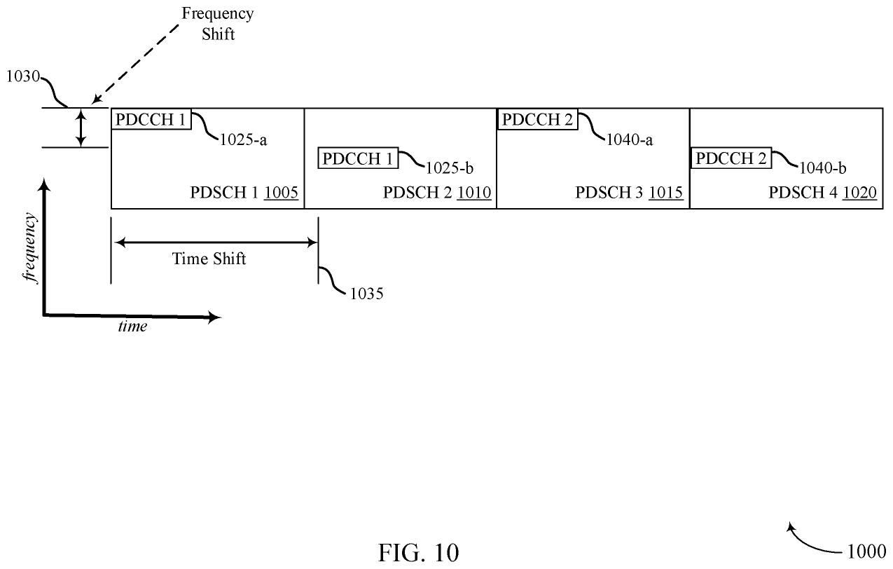

In further cases, both time and frequency shifts may be applied to repetitions of a PDCCH. FIG. 10 illustrates an example of a slot bundling pattern 1000 with time and frequency shifts that supports reliability and coverage enhancement for NTNs in accordance with aspects of the present disclosure. In some examples, slot bundling pattern 1000 may be implemented in aspects of wireless communications system 100 or 200. In this example, a number of slots are illustrated that include a first slot 1005, a second slot 1010, a third slot 1015, and a fourth slot 1020. The first slot 1005 may be configured with a first repetition of a first PDCCH 1025-a.

In this example, both a frequency shift 1030 and a time shift 1035 may be applied to the first instance of the first PDCCH 1025-a to identify resources for a second instance of the first PDCCH 1025-b. In this example, the time shift 1035 may be provided as a number of symbols such that the location of the second instance of the first PDCCH 1025-b is offset by one or more symbols relative to the location of the first instance of the first PDCCH 1025-a in the first slot 1005. In this case, the number of repetitions is two (i.e., R=2), and the third slot 1015 and the fourth slot 1020 may include instances of a second PDCCH 1040. While this example provides a combination of time shift and frequency shift, such shifts may include time shifts, frequency shifts, CORESET shifts, or any combinations thereof.

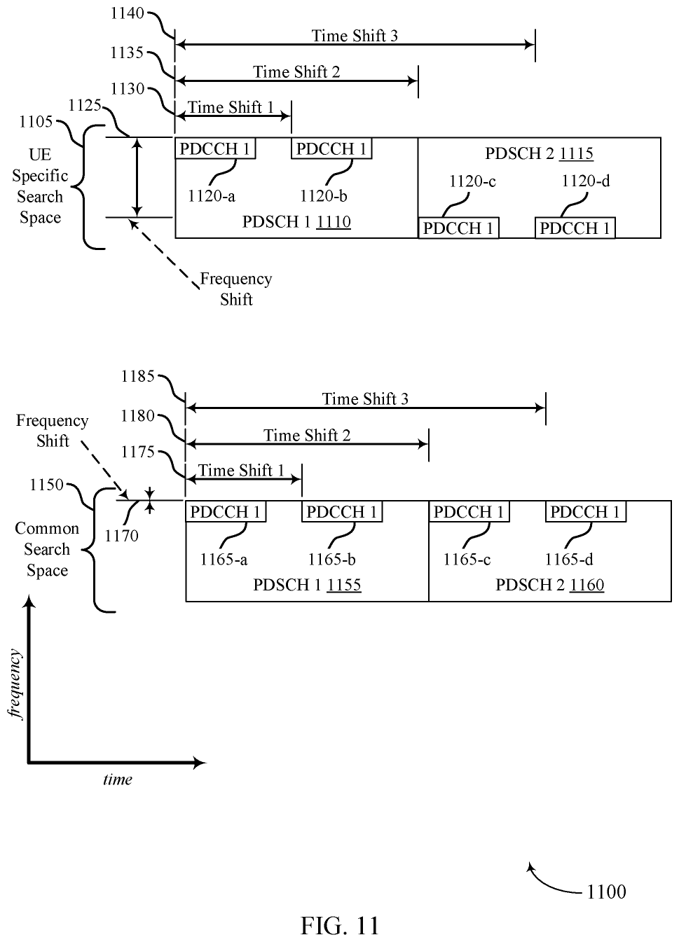

In some cases, bundling patterns may use multiple PDCCH candidates for the same DCI across search space occasions. FIG. 11 illustrates examples of slot bundling patterns 1100 across search space occasions that support reliability and coverage enhancement for NTNs in accordance with aspects of the present disclosure. In some examples, slot bundling pattern 1100 may be implemented in aspects of wireless communications system 100 or 200. In this example, a first pattern 1105 may provide UE-specific search spaces, and a second pattern 1150 may provide common search spaces.

In the first pattern, a first slot 1110 and a second slot 1115 may contain repetitions of a first PDCCH 1120. In this example, a frequency shift 1125 may be configured to shift frequencies across slots, and multiple time shifts may be configured that include a first time shift 1130, second time shift 1135, and a third time shift 1140, such that four repetitions of the first PDCCH 1120 are provided. In this example, the second time shift 1135 and the third time shift 1140 provide that the third instance of the first PDCCH 1120-c and the fourth instance of the first PDCCH 1120-d are in the second slot 1115, and have the frequency shift 1125 applied. Thus, in this example, PDCCH candidates with the same candidate index (i.e., carrying the same DCI) in UE specific search spaces are shifted in frequency across slots, but have the same control channel element (CCE) allocation within in the same slot.

In the second pattern 1150, a first slot 1155 and a second slot 1160 may contain common search spaces that include repetitions of a first PDCCH 1165. In this example, a frequency shift 1170 may be configured to shift frequencies across slots, which is set to zero in this example to provide that each instance of PDCCH 1165 is at a same frequency. In this example, multiple time shifts may be configured that include a first time shift 1175, second time shift 1180, and a third time shift 1185, such that four repetitions of the first PDCCH 1165 are provided. Thus, in this example, PDCCH candidates in common search spaces with the same candidate index (i.e., carrying the same DCI) always have the same CCE allocation across and within slot(s).

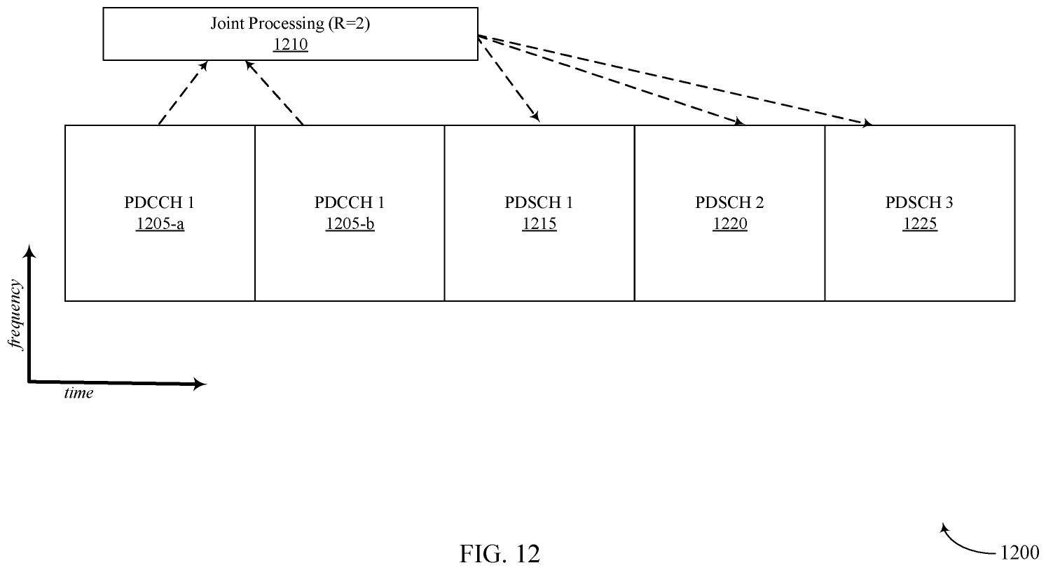

FIG. 12 illustrates an example of a control channel and shared channel slot pattern 1200 that supports reliability and coverage enhancement for NTNs in accordance with aspects of the present disclosure. In some examples, control channel and shared channel slot pattern 1200 may be implemented in aspects of wireless communications system 100 or 200. In this example, a first slot 1205-a and a second slot 1205-b may contain repetitions of a PDCCH, and a third slot 1215, a fourth slot 1220, and a fifth slot 1225 may each contain PDSCH communications.

In some cases, as discussed herein, one or more whole slots may be used for a PDCCH. In such cases, the network may indicate whether the PDCCH repetition is slot based or CORESET based (e.g., as discussed with reference to FIGS. 4 through 11). For slot-based repetitions, a repetition level (R) may be defined to specify how many repetitions for a PDCCH are configured. A starting point of the repetitions (Nₛₜₐᵣₜ) may be defined, and a gap (G) may be defined to indicate number of slots skipped between adjacent repetitions of a PDCCH. In the example of FIG. 12, R may be set to two (R=2), the starting point (Nₛₜₐᵣₜ) may be the first slot 1205-a, and the gap may be zero (G=0). Based on the repetition configuration, the UE may perform joint processing 1210 on the repetitions of PDCCH provided in first slot 1205-a and second slot 1205-b. to determine the PDSCH configuration for the third slot 1215, fourth slot 1220, and fifth slot 1225.

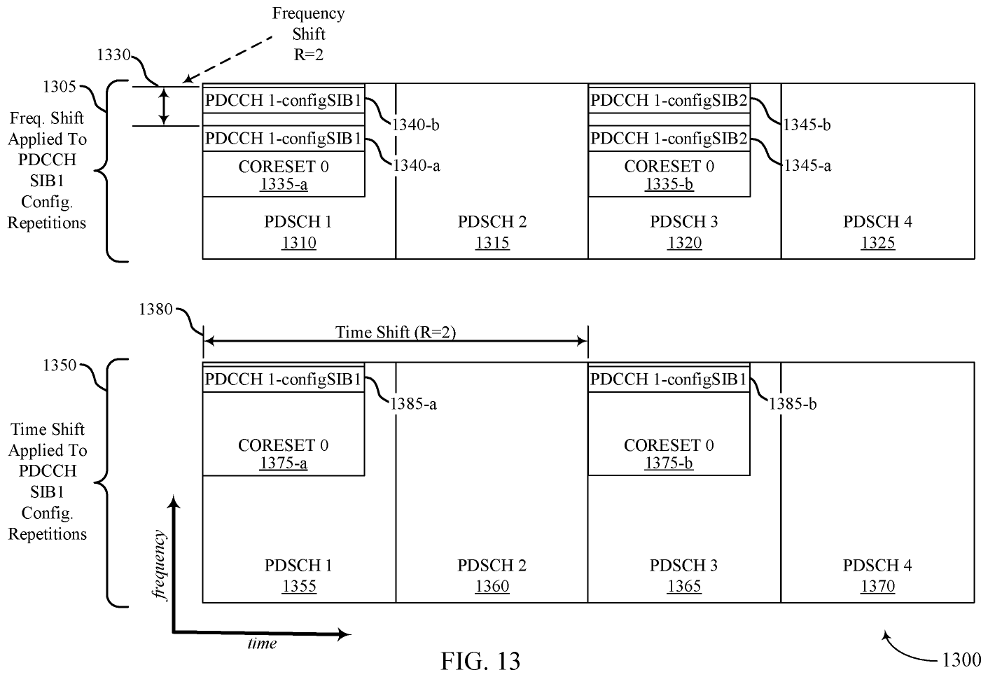

FIG. 13 illustrates an example of a SIB-configuring PDCCH repetition pattern 1300 that supports reliability and coverage enhancement for NTNs in accordance with aspects of the present disclosure. In some examples, SIB-configuring PDCCH repetition pattern 1300 may be implemented in aspects of wireless communications system 100 or 200. In this example, repetitions of PDCCH communications that configure a system information block (SIB), such as SIB1, may be provided.

In this example, time or frequency shifts (or both) may be configured to provide repetitions in one or more CORESETs of PDCCHs that configure SIB1. A first pattern 1305 illustrates a frequency shift that may be used, and a second pattern 1350 illustrates a time shift that may be used. In the first pattern 1305, a first slot 1310, a second slot 1315, a third slot 1320, and a fourth slot 1325 may include resources for one or more CORESETs including CORESET 0 1335. In this example, a frequency shift 1330 and a number of repetitions (e.g., R=2 in this example) may be configured, and multiple instances of a PDCCH 1340 that configures SIB1 may be monitored. In the first pattern 1305, the frequency shift 1330 may be applied to a first instance of the first PDCCH 1340-a to determine a location of a second instance of the first PDCCH 1340-b, which may be combined to decode the SIB1. In this example, multiple repetitions of a second PDCCH 1345 to decode a SIB2 may be provided in the third slot 1320, in accordance with the repetition pattern.

In some cases, the CORESET 1335 (called CORESET 0) and the search space sets for the PDCCH candidates configuring SIB1 are specified in Master Information Block (MIB) using an 8-bit code. In some cases, the repetitions of the PDCCH that configures SIB1 (called PDCCH-configSIB1) may be indicated in the MIB, for example, by extending the 8-bit code. The indication may determine whether PDCCH-configSIB1 repetition is used or not, may determine a repetition number (R), may determine a shift among the repetitions in time (in slots or symbols) or frequency, or any combinations thereof. The second pattern 1350 illustrates a time shift 1380 that may be applied to a first instance of PDCCH1-configSIB1 1385-a that is provided in CORESET 0 1375-a in first slot 1355. The time shift 1380 may indicate that a second instance of PDCCH1-configSIB1 1385-b is present in CORESET 0 1375-b in third slot 1365. In this pattern, a second slot 1360 and fourth slot 1370 may not include a CORESET that is monitored for the PDCCH1-configSIB1 1385. In some cases, the indication in the MIB may be used to determine repetitions of the CORESET 0 (shifted in time and/or frequency) to be used for mapping the PDCCH.

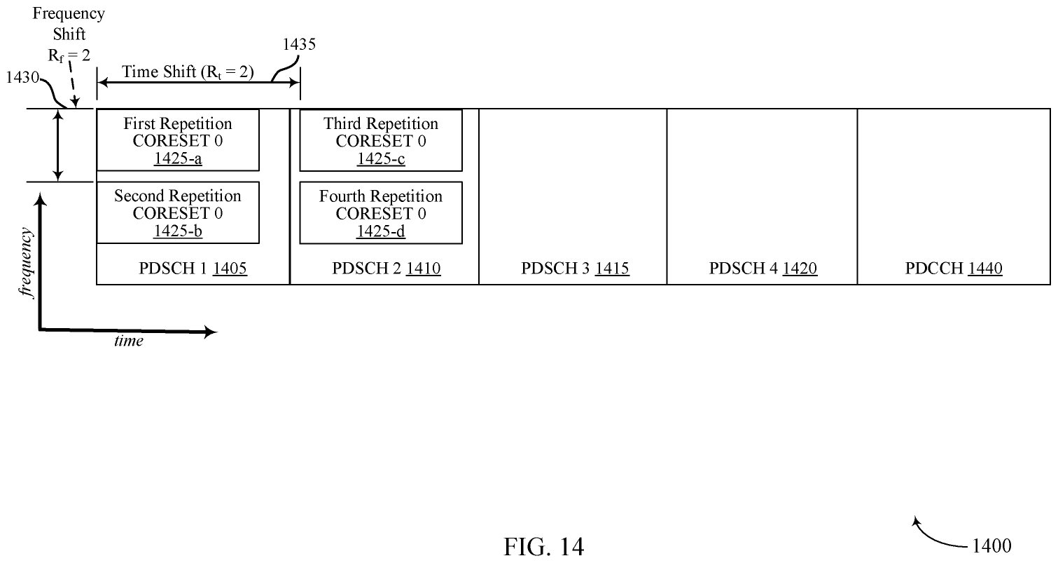

FIG. 14 illustrates another example of a SIB-configuring PDCCH repetition pattern 1400 that supports reliability and coverage enhancement for NTNs in accordance with aspects of the present disclosure. In some examples, SIB-configuring PDCCH repetition pattern 1400 may be implemented in aspects of wireless communications system 100 or 200. In this example, a first slot 1405, a second slot 1410, a third slot 1415, and a fourth slot 1420 are illustrated.

As discussed herein, in some cases a MIB may provide an indication that may be used to determine repetitions of the CORESET 0 (shifted in time and/or frequency) to be used for mapping the PDCCH. The indication may include the time and frequency locations of the repetitions, which may include a number of repetitions in time (Rₜ) and associated time shift 1435, a number of repetitions in frequency (R_{f}) and associated frequency shift 1430, or combinations thereof. In the example of FIG. 14, a first repetition of CORESET 0 1425-a and a second repetition of CORESET 0 1425-b may be configured based on frequency shift 1430 within the first slot 1405, and a third repetition of CORESET 0 1425-c and a fourth repetition of CORESET 0 1425-d may be configured based on time shift 1435 and frequency shift 1430 within second slot 1410. The UE may then combine identical PDCCH candidates across CORESET 0 repetitions, and decode. In some cases, the configuration for determining repetitions of CORESET 0 may be specific to a particular frequency range, and a separate table may be used for each frequency range.

In some cases, additionally or alternatively, one or more whole slots may be used for PDCCH, such as slot 1440. In such cases, one or more repetitions (e.g., repetition level R) may be defined to specify how many repetitions for a PDCCH are present in the PDCCH slot 1440, in one or more other PDCCH slots, in one or more CORESETs provided in a PDSCH slot, or any combinations thereof. In some cases, a starting point of the repetitions (e.g., Nₛₜₐᵣₜ) may be defined and provided to the UE, along with the number of repetitions, and associated information for a repetition pattern. The PDCCH candidates may be jointly decoded at the UE and configure one or more PDSCHs.

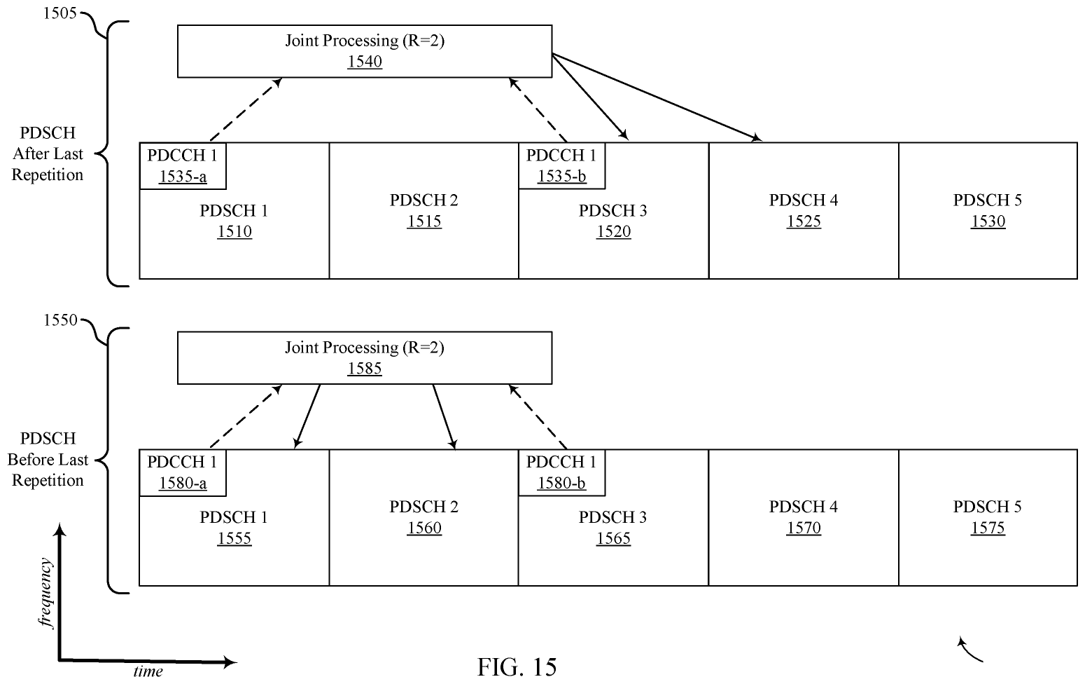

FIG. 15 illustrates examples of scheduling patterns 1500 of PDCCH/PDSCH communications that supports reliability and coverage enhancement for NTNs in accordance with aspects of the present disclosure. In some examples, scheduling patterns 1500 may be implemented in aspects of wireless communications system 100 or 200. In some cases, PDCCH communications may provide DCI for one or more PDSCH communications that start at or after a slot of the last repetition of the PDCCH, such as illustrated in first pattern 1505. In other cases, PDCCH communications may provide DCI for one or more PDSCH communications that start before a last repetition of the PDCCH, such as illustrated in second pattern 1550.

In the example of the first pattern 1505, a first slot 1510, a second slot 1515, a third slot 1520, a fourth slot 1525, and a fifth slot 1530 are illustrated, in which the first slot 1510 and the third slot 1520 each include a repetition of PDCCH 1535. In this example, PDSCH communications start at or after a last slot with a PDCCH 1535 repetition, and UE may perform joint processing 1540 of the repetitions to determine DCI for PDSCH communications in the third slot 1520 and the fourth slot 1525. Such a configuration may require less memory at the UE for buffering any PDSCH data signals that may be received in a slot prior to the last slot that includes a repetition of the PDCCH 1535.

In cases of the second pattern 1550, a first slot 1555, a second slot 1560, a third slot 1565, a fourth slot 1570, and a fifth slot 1575 are illustrated, in which the first slot 1555 and the third slot 1565 each include a repetition of PDCCH 1580. In this example, PDSCH communications before a last slot with a PDCCH 1535 repetition, namely in the first slot 1555 and the second slot 1560, may be transmitted and UE may perform joint processing 1585 of the repetitions to determine DCI for PDSCH communications in the first slot 1555 and the second slot 1560. In such cases, the UE may use additional memory to buffer signals from the first slot 1555 and the second slot 1560, but there may be less delay in decoding PDSCH.

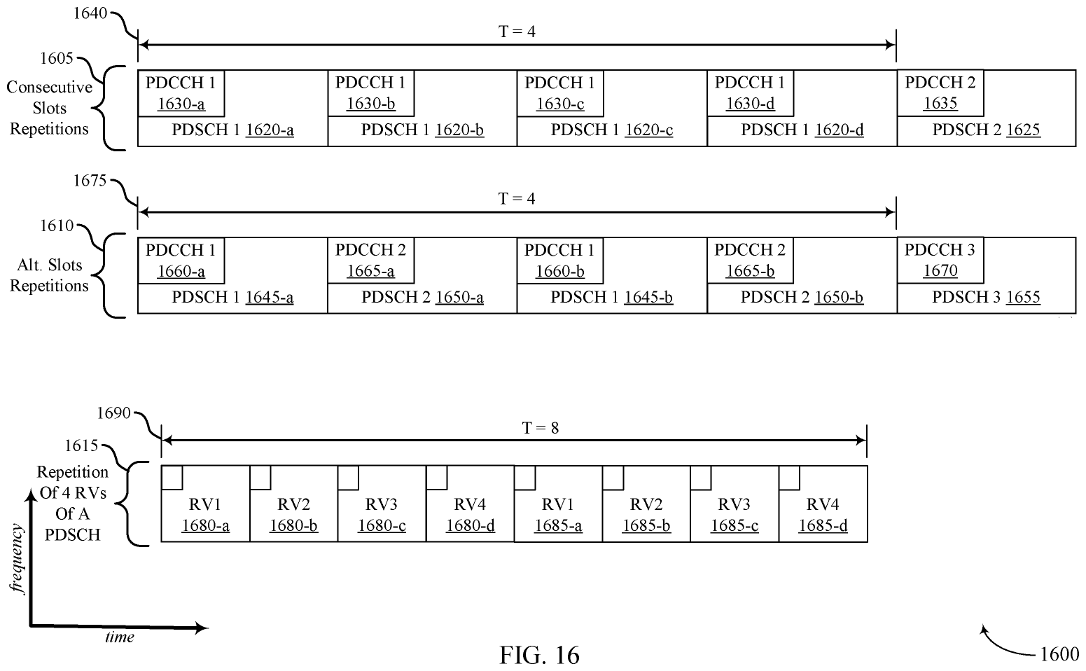

FIG. 16 illustrates an example of PDSCH slot bundling patterns 1600 that support reliability and coverage enhancement for NTNs in accordance with aspects of the present disclosure. In some examples, slot bundling patterns 1600 may be implemented in aspects of wireless communications system 100 or 200. Slot bundling of repetitions of PDSCH may be configured in some cases, in addition or alternatively to repetitions of other channels (e.g., PDCCH, PBCH, PUSCH, PUCCH, etc.).

In a first pattern 1605, a first PDSCH 1620 is repeated in T slots 1640, where T is four, thus providing a first PDSCH repetition1620-a in a first slot, a second PDSCH repetition 1620-b in a second slot, a third PDSCH repetition 1620-c in a third slot, and a fourth PDSCH repetition 1620-d in a fourth slot. The T slots may be understood as T downlink slots. In this example a second PDSCH 1625 may be present in a fifth slot. In this example, multiple repetitions of a first PDCCH 1630 may be provided in each of the first through fourth slots, and a second PDCCH 1635 may be present in the fifth slot. In this example, repetitions may be included in consecutive slots, although in other cases the slots may be non-consecutive (e.g., with gaps of one or more slots). Further, in some cases, multiple repetitions within a same slot may be configured.

In a second pattern 1610, PDSCH repetitions may be present in alternating slots. In this pattern, a first PDSCH 1645 and a second PDSCH 1650 may have repetitions in alternate slots. In this example, repetitions of the first PDSCH 1645 and the second PDSCH 1650 are provided for T slots 1675, where T is four, thus providing a repetition of first PDSCH 1645-a in a first slot, and a first repetition of a second PDSCH 1650-a in a second slot, a second repetition of the first PDSCH 1645-b in a third slot, and a second repetition of the second PDSCH 1650-b in a fourth slot. In this example a third PDSCH 1655 may be present in a fifth slot. In this example, multiple repetitions of a first PDCCH 1660 and a second PDCCH 1665 may be provided slots corresponding to the first PDSCH 1645 and the second PDSCH 1650. A third PDCCH 1670 may be present in the fifth slot. Further, in some cases, multiple repetitions within a same slot may be configured.

In some cases, the network may configure (e.g., via DCI, RRC, MAC-CE, etc.) the PDSCH repetition pattern. For example, configuration may include the duration for repetition, such as T (in time slots), and a gap G (in time slots) that indicates a number of slots between two nearest repetitions. Thus, the slots carrying the repetitions of a PDSCH are slots N, N+(G+1), . . . , N+m*(G+1), where m is the largest value such that m*(G+1)−1<T.

Further, in some cases a different redundancy version (RV) or a same RV may be used for repetitions of PDSCH. Pattern 1615 shows an exemplary repetition of four RVs of a PDSCH. In this example, repetitions are provided for T slots 1690, where T is eight. Thus, in this example a first repetition and a second repetition of a PDSCH may be provided, in which a first RV 1680-a, a second RV 1680-b, a third RV 1680-c, and a fourth RV 1680-d are provided for the first repetition, and the second repetition also includes a first RV 1685-a, a second RV 1685-b, a third RV 1685-c, and a fourth RV 1685-d. In some cases, the network may use an indicator, such as diffRV, to indicate whether different redundancy versions are used among repetitions. In such cases, diffRV=1 may indicate that different redundancy versions are used. Use of different RVs may provide a coding gain. Further, diffRV=0 may indicate the same redundancy version is used for repetitions (e.g., UE does Chase combining). Use of the same RV may require less memory at the UE. For example, in Chase combining which computes a weighted sum of the received copies of a signal, a UE can start with zero and add a term when a copy is received and then discard the copy, thus consuming less memory when buffering repetitions.

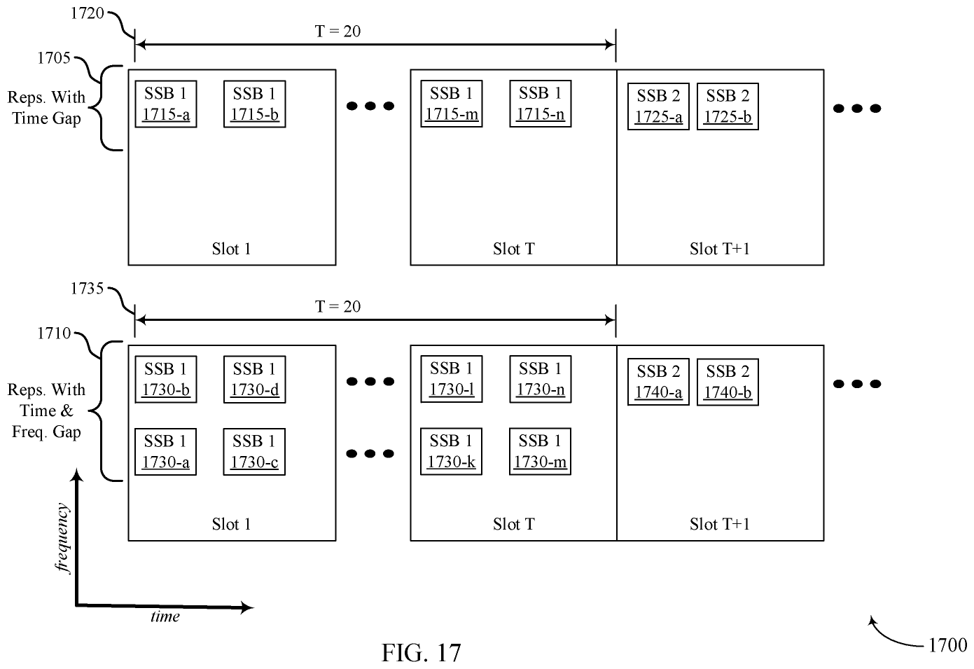

FIG. 17 illustrates an example of a broadcast channel (e.g., PBCH) slot bundling patterns 1700 that supports reliability and coverage enhancement for NTNs in accordance with aspects of the present disclosure. In some examples, broadcast channel slot bundling patterns 1700 may be implemented in aspects of wireless communications system 100 or 200. In some cases, PBCH bundling may be configured, in which PBCH transmissions (e.g., in a synchronization signal block (SSB)) may have repetitions with a time gap, with a frequency gap, or combinations thereof. In FIG. 17, a first pattern 1705 illustrates PBCH repetitions with a time gap, and a second pattern 1710 PBCH repetitions with a time gap and a frequency gap.

In the first pattern 1705, multiple repetitions of a first SSB 1715 based on a time gap may be configured for a repetition duration T 1720, which corresponds to 20 slots in this example. Following the first SSB 1715, a second SSB 1725 may be transmitted starting at slot T+1. In the second pattern 1710, multiple repetitions of first SSB 1730 based on both a time gap and frequency gap may be configured for a repetition duration T 1720, which corresponds to 20 slots in this example. Following the first SSB 1730, a second SSB 1740 may be transmitted starting at slot T+1.

In such cases, PBCH as part of SSB is repeated across multiple slots (e.g., T slots) possibly with repetitions in the frequency domain within slots. The repetitions of a same PBCH may be transmitted using the same beam. In some cases, a time gap (e.g., timeGap) may be defined to indicate the number of OFDM symbols between adjacent repetitions in the time domain, which may be different for different repetitions, deterministic, or pseudo-random. Similarly, a frequency gap (e.g., freqGap) may be defined to indicate the number of PRBs between adjacent repetitions in the frequency domain, which may be different for different repetitions, deterministic, or pseudo-random. The information carried in the PBCH may be made identical. In some cases, a system frame number (SFN) of each repetition of PBCH may refer to the SFN of a fixed repetition (e.g., the first repetition) of the PBCH. In some cases, a half-frame bit associated with a SFN may refer to the half frame bit of a fixed repetition (e.g., the first repetition) of the PBCH. In some cases, a SS/PBCH (i.e., SSB) index of each repetition of PBCH may refer to the SS/PBCH (SSB) index of fixed repetition (e.g., the first repetition) of the PBCH.

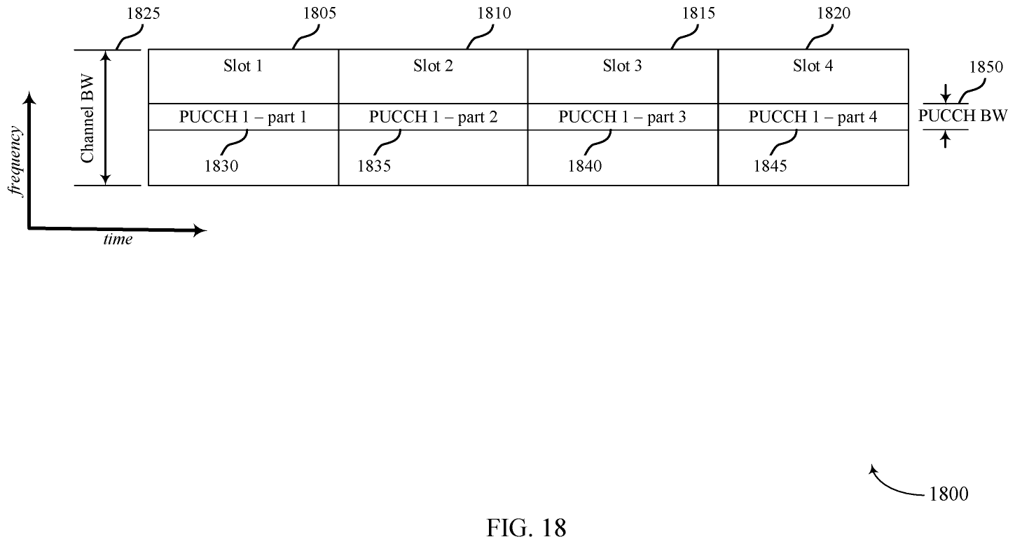

FIG. 18 illustrates an example of a uplink control channel resources and bundling pattern 1800 that supports reliability and coverage enhancement for NTNs in accordance with aspects of the present disclosure. In some examples, uplink control channel resources and bundling pattern 1800 may be implemented in aspects of wireless communications system 100 or 200. While downlink communications are discussed in the various examples of FIGS. 3 through 17, such techniques may also be applied to repetitions of uplink communications from a UE to a base station (e.g., to a high-altitude base station or via a high altitude relay or satellite).

Additionally, considering that the UE may have limited transmit power (e.g., based on UE operation in a power limited regime or otherwise having a relatively low available transmit power), uplink communications may be configured to be transmitted using a relatively narrow bandwidth, to allow a higher power density (e.g., based on energy per resource element (EPRE)), and higher likelihood of receipt at a satellite or other node. In the example of FIG. 18, a first slot 1805, a second slot 1810, a third slot 1815, and a fourth slot 1820 may have an associated channel bandwidth 1825 (e.g., 80 MHz). In this example, multiple repetitions of a PUCCH may use a PUCCH bandwidth 1850 that is a subset of the channel bandwidth 1825. In this example, a first part of a PUCCH 1830 may be transmitted in the first slot 1805, a second part of the PUCCH 1835 may be transmitted in the second slot 1810, a third part of the PUCCH 1840 may be transmitted in the third slot 1815, a fourth part of the PUCCH 1845 may be transmitted in the fourth slot 1820. By providing PUCCH in the PUCCH bandwidth 1850 and multiple slots the signal to noise ratio may be boosted. In some cases, a repetition level R may be defined and signaled to the UE, and the resource allocation for PUCCH over multiple slots may be configured for one slot with R. The repetitions may be identical or different redundancy versions of the same codeword.

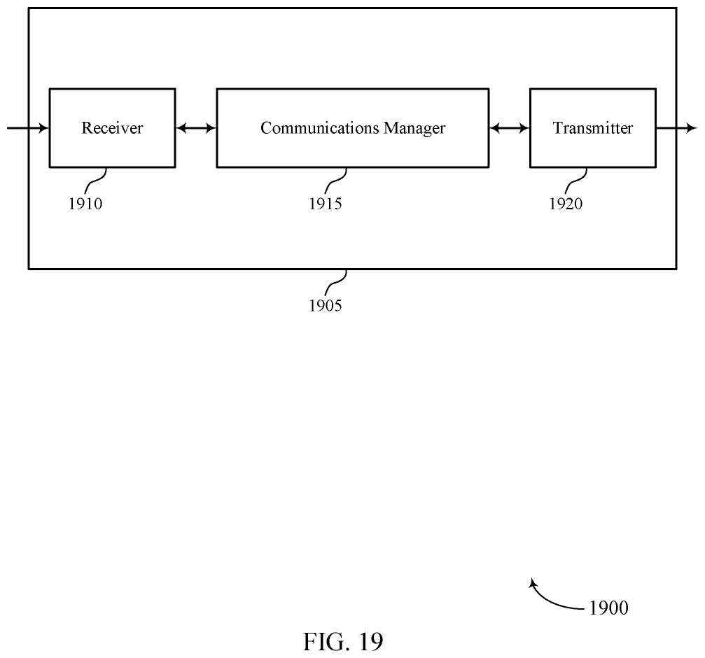

FIG. 19 shows a block diagram 1900 of a device 1905 that supports reliability and coverage enhancement for NTNs in accordance with aspects of the present disclosure. The device 1905 may be an example of aspects of a UE 115 as described herein. The device 1905 may include a receiver 1910, a communications manager 1915, and a transmitter 1920. The device 1905 may also include a processor. Each of these components may be in communication with one another (e.g., via one or more buses).

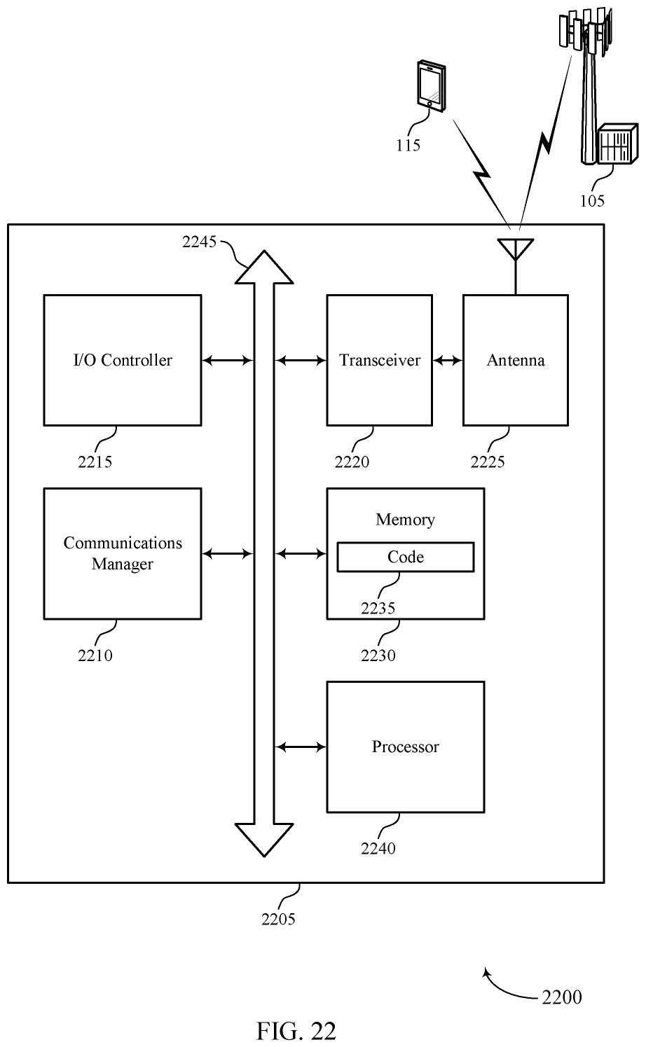

The receiver 1910 may receive information such as packets, user data, or control information associated with various information channels (e.g., control channels, data channels, and information related to reliability and coverage enhancement for NTNs, etc.). Information may be passed on to other components of the device 1905. The receiver 1910 may be an example of aspects of the transceiver 2220 described with reference to FIG. 22. The receiver 1910 may utilize a single antenna or a set of antennas.

In some cases, the communications manager 1915 may support wireless communications at a UE in accordance with examples as disclosed herein. For example, the communications manager 1915 may be configured as or otherwise support a means for receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication. The communications manager 1915 may be configured as or otherwise support a means for receiving signals from two or more of the set of multiple shared channel resources based on the control channel communication. The communications manager 1915 may be configured as or otherwise support a means for decoding the shared channel communication based on the received signals from the two or more of the set of multiple shared channel resources.

In some cases, the communications manager 1915 may identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffer received signals from two or more of the set of resources based on the identifying, and decode the downlink control channel transmission based on the buffered received signals.

In some cases, the communications manager 1915 may identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffer received signals from two or more of the set of shared channel resources based on the identifying, and decode the downlink shared channel communication based on the buffered received signals.

In some cases, the communications manager 1915 may identify a set of physical broadcast channel resources associated with a base station, the set of physical broadcast channel resources including two or more repetition resources for two or more repetitions of a physical broadcast channel communication, buffer received signals from the two or more repetitions of the physical broadcast channel communication based on the identifying, and decode the physical broadcast channel communication based on the buffered received signals.

In some cases, the communications manager 1915 may receive, from a base station, an uplink grant for an uplink communication from the UE, the uplink grant indicating a set of uplink resources that include one or more repetition resources for one or more repetitions of the uplink communication, determine a transmission frequency bandwidth for the uplink communication as a subset of a channel frequency bandwidth used for receiving downlink communications at the UE, and transmit the uplink communication via the set of uplink resources using the transmission frequency bandwidth. The communications manager 1915 may be an example of aspects of the communications manager 2210 described herein.

The communications manager 1915 may as described herein be implemented to realize one or more potential aspects. One implementation may allow the device 1905 to reduce BLER associated with communications with of via a high altitude node, such as a satellite in a NTN, which may allow for enhanced reliability and reduced retransmissions. Further, implementations may allow the device 1905 to reduce the latency of communications, and increase signaling reliability, throughput, and user experience, while reducing power consumption, among other aspects.

The communications manager 1915, or its sub-components, may be implemented in hardware, code (e.g., software or firmware) executed by a processor, or any combination thereof. If implemented in code executed by a processor, the functions of the communications manager 1915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1915, or its sub-components, may be physically located at various positions, including being distributed such that portions of functions are implemented at different physical locations by one or more physical components. In some examples, the communications manager 1915, or its sub-components, may be a separate and distinct component in accordance with various aspects of the present disclosure. In some examples, the communications manager 1915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1920 may transmit signals generated by other components of the device 1905. In some examples, the transmitter 1920 may be collocated with a receiver 1910 in a transceiver module. For example, the transmitter 1920 may be an example of aspects of the transceiver 2220 described with reference to FIG. 22. The transmitter 1920 may utilize a single antenna or a set of antennas.

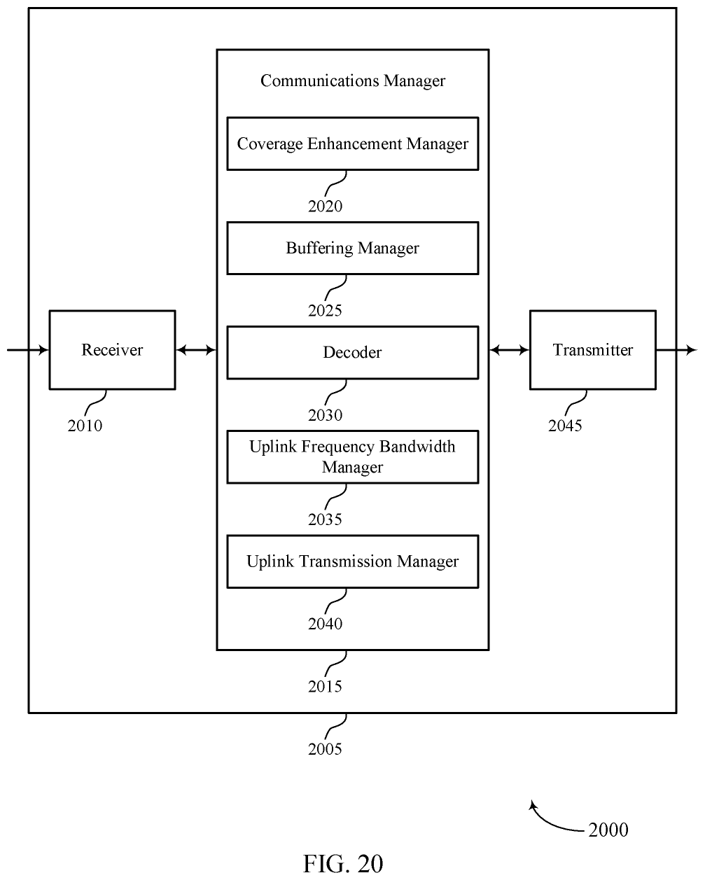

FIG. 20 shows a block diagram 2000 of a device 2005 that supports reliability and coverage enhancement for NTNs in accordance with aspects of the present disclosure. The device 2005 may be an example of aspects of a device 1905, or a UE 115 as described herein. The device 2005 may include a receiver 2010, a communications manager 2015, and a transmitter 2045. The device 2005 may also include a processor. Each of these components may be in communication with one another (e.g., via one or more buses).

The receiver 2010 may receive information such as packets, user data, or control information associated with various information channels (e.g., control channels, data channels, and information related to reliability and coverage enhancement for NTNs, etc.). Information may be passed on to other components of the device 2005. The receiver 2010 may be an example of aspects of the transceiver 2220 described with reference to FIG. 22. The receiver 2010 may utilize a single antenna or a set of antennas.

The communications manager 2015 may be an example of aspects of the communications manager 1915 as described herein. The communications manager 2015 may include a coverage enhancement manager 2020, a buffering manager 2025, a decoder 2030, an uplink frequency bandwidth manager 2035, and an uplink transmission manager 2040. The communications manager 2015 may be an example of aspects of the communications manager 2210 described herein.

In some cases, the communications manager 2015 may support wireless communications at a UE in accordance with examples as disclosed herein. The coverage enhancement manager 2020 may be configured as or otherwise support a means for receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication. The buffering manager 2025 may be configured as or otherwise support a means for receiving signals from two or more of the set of multiple shared channel resources based on the control channel communication. The decoder 2030 may be configured as or otherwise support a means for decoding the shared channel communication based on the received signals from the two or more of the set of multiple shared channel resources.

In some cases, the coverage enhancement manager 2020 may identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission. The buffering manager 2025 may buffer received signals from two or more of the set of resources based on the identifying. The decoder 2030 may decode the downlink control channel transmission based on the buffered received signals.

In some cases, the coverage enhancement manager 2020 may identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication. The buffering manager 2025 may buffer received signals from two or more of the set of shared channel resources based on the identifying. The decoder 2030 may decode the downlink shared channel communication based on the buffered received signals.

In some cases, the coverage enhancement manager 2020 may identify a set of physical broadcast channel resources associated with a base station, the set of physical broadcast channel resources including two or more repetition resources for two or more repetitions of a physical broadcast channel communication. The buffering manager 2025 may buffer received signals from the two or more repetitions of the physical broadcast channel communication based on the identifying. The decoder 2030 may decode the physical broadcast channel communication based on the buffered received signals.

In some cases, the coverage enhancement manager 2020 may receive, from a base station, an uplink grant for an uplink communication from the UE, the uplink grant indicating a set of uplink resources that include one or more repetition resources for one or more repetitions of the uplink communication. The uplink frequency bandwidth manager 2035 may determine a transmission frequency bandwidth for the uplink communication as a subset of a channel frequency bandwidth used for receiving downlink communications at the UE. The uplink transmission manager 2040 may transmit the uplink communication via the set of uplink resources using the transmission frequency bandwidth.

The transmitter 2045 may transmit signals generated by other components of the device 2005. In some examples, the transmitter 2045 may be collocated with a receiver 2010 in a transceiver module. For example, the transmitter 2045 may be an example of aspects of the transceiver 2220 described with reference to FIG. 22. The transmitter 2045 may utilize a single antenna or a set of antennas.

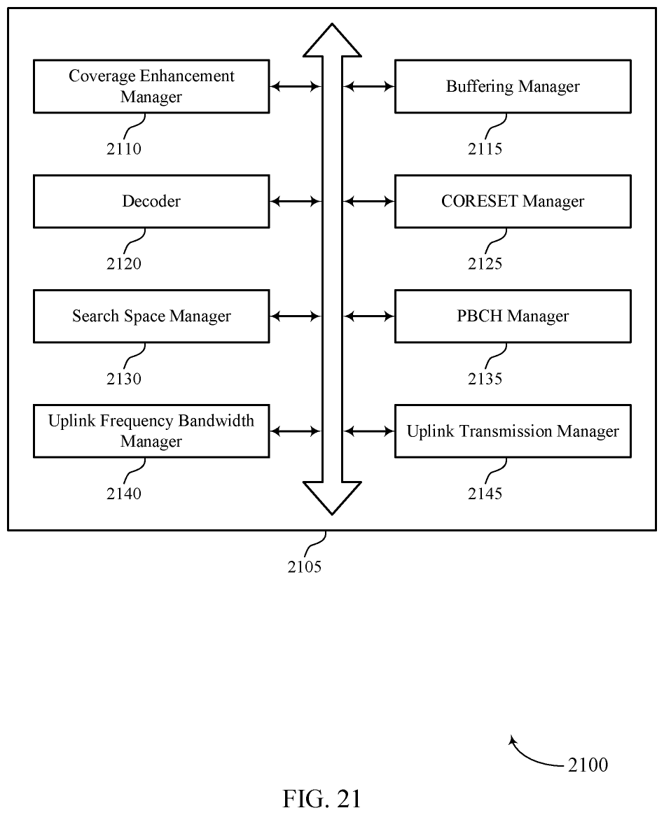

FIG. 21 shows a block diagram 2100 of a communications manager 2105 that supports reliability and coverage enhancement for NTNs in accordance with aspects of the present disclosure. The communications manager 2105 may be an example of aspects of a communications manager 1915, a communications manager 2015, or a communications manager 2210 described herein. The communications manager 2105 may include a coverage enhancement manager 2110, a buffering manager 2115, a decoder 2120, a CORESET manager 2125, a search space manager 2130, a PBCH manager 2135, an uplink frequency bandwidth manager 2140, and an uplink transmission manager 2145. Each of these modules may communicate, directly or indirectly, with one another (e.g., via one or more buses).

The communications manager 2105 may support wireless communications at a UE in accordance with examples as disclosed herein. The coverage enhancement manager 2110 may be configured as or otherwise support a means for receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication. The buffering manager 2115 may be configured as or otherwise support a means for receiving signals from two or more of the set of multiple shared channel resources based on the control channel communication. The decoder 2120 may be configured as or otherwise support a means for decoding the shared channel communication based on the received signals from the two or more of the set of multiple shared channel resources.

In some examples, the repetition resource sets include resources having a periodic or non-periodic pattern across multiple consecutive or non-consecutive slots. In some examples, one or more of the repetition resource sets include multiple time resources, frequency resources, or combinations thereof, within a same slot. In some examples, the one or more repetitions of the shared channel transmission include repetitions of an exact copy of the shared channel transmission or include different redundancy versions of the shared channel transmission. In some examples, the repetitions of the shared channel transmission are configured for aggregation levels above a configured threshold value.

In some examples, the control channel communication further indicates a repetition pattern for the one or more repetitions of a downlink shared channel communication. In some examples, the downlink shared channel communication has multiple repetitions in a same slot. In some examples, the repetition pattern provided is provided in DCI in the control channel communication, and where the DCI further indicates a duration that repetitions according to the repetition pattern are to be transmitted, a number of slots between consecutive repetitions, or any combinations thereof. In some examples, control channel communication further indicates whether different redundancy versions (RVs) are used for consecutive repetitions of the downlink shared channel communication, and where the decoding is further based on whether the different RVs are used for the consecutive repetitions. In some examples, UE and the base station are nodes in a non-terrestrial network (NTN).

In some examples, the coverage enhancement manager 2110 may identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission.

In some examples, the coverage enhancement manager 2110 may identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication.

In some examples, the coverage enhancement manager 2110 may identify a set of physical broadcast channel resources associated with a base station, the set of physical broadcast channel resources including two or more repetition resources for two or more repetitions of a physical broadcast channel communication.

In some examples, the coverage enhancement manager 2110 may receive, from a base station, an uplink grant for an uplink communication from the UE, the uplink grant indicating a set of uplink resources that include one or more repetition resources for one or more repetitions of the uplink communication.

In some examples, the coverage enhancement manager 2110 may determine one or more of a scrambling identification, a radio network temporary identifier (RNTI), or a DCI size, associated with the downlink control channel transmission. In some examples, the coverage enhancement manager 2110 may determine a repetition level of the downlink control channel transmission based on mapping between the scrambling identification, RNTI, or DCI size and the repetition level.

In some cases, the repetition resource sets include resources having a periodic or non-periodic pattern across multiple consecutive or non-consecutive slots. In some cases, one or more of the repetition resource sets include multiple time resources, frequency resources, or combinations thereof, within a same slot. In some cases, the one or more repetitions of the downlink control channel transmission include repetitions of an exact copy of the downlink control channel transmission or include different redundancy versions of the downlink control channel transmission. In some cases, the repetitions of the downlink control channel transmission are configured for aggregation levels above a configured threshold value.

In some cases, the repetition resource sets include two or more different time resources, two or more different frequency resources, two or more resources associated with different control resource sets, or any combinations thereof. In some cases, the one or more additional repetition resource sets are derived based on one or more of a time shift and repetition level associated with the first repetition resource set, and where the time shift is a fixed time shift, a deterministic time shift, or a pseudo-random time shift relative to the first repetition resource set. In some cases, the time shift is configured as a number of orthogonal frequency division multiplexing (OFDM) symbols.

In some cases, the one or more additional repetition resource sets are derived based on one or more of a frequency shift and repetition level associated with the first repetition resource set, and where the frequency shift is a fixed frequency shift, a deterministic frequency shift, or a pseudo-random frequency shift relative to the first transmission resource. In some cases, the frequency shift is cyclic frequency shift that is applied to the first repetition resource set or a prior repetition resource set, or that is applied to one or more search spaces associated with two or more different control resource sets. In some cases, the one or more additional repetition resource sets are derived based on a control resource set shift associated with the first repetition resource set and the control resource set configuration, and where the control resource set shift indicates one or more control resource sets that carry one or more repetitions of the downlink control channel transmission. In some cases, the one or more additional repetition resource sets are derived based on one or more of a time shift, a frequency shift, a control resource set shift, or any combinations thereof, relative to the first repetition resource set.

In some cases, the repetition pattern provided is provided in DCI in the control channel communication, and where the DCI further indicates a duration that repetitions according to the repetition pattern are to be transmitted, a number of slots between consecutive repetitions, or any combinations thereof. In some cases, the control channel communication further indicates whether different redundancy versions (RVs) are used for consecutive repetitions of the downlink shared channel communication, and where the buffering is further based on whether the different RVs are used for the consecutive repetitions.

The buffering manager 2115 may buffer received signals from two or more of the set of resources based on the identifying. In some examples, the buffering manager 2115 may receive information from the base station that indicates that repetitions of the downlink control channel transmission are enabled and that indicates whether the repetitions are slot-based repetitions or control resource set based repetitions. In some cases, the downlink control channel transmission includes a grant of downlink shared channel resources, and where the downlink shared channel resources start before or after a final repetition resource set. In some cases, the downlink shared channel communication has multiple repetitions in a same slot.

The decoder 2120 may decode the downlink control channel transmission based on the buffered received signals. The uplink frequency bandwidth manager 2140 may determine a transmission frequency bandwidth for the uplink communication as a subset of a channel frequency bandwidth used for receiving downlink communications at the UE.

The uplink transmission manager 2145 may transmit the uplink communication via the set of uplink resources using the transmission frequency bandwidth. In some cases, the uplink communication is an uplink control channel communication and the uplink grant indicates a repetition level and resource allocation for the uplink control channel communication over multiple slots. In some cases, the uplink communication is an uplink shared channel communication and the uplink grant indicates a repetition level and resource allocation for the uplink shared channel communication over multiple slots. In some cases, a timing between the uplink grant and the uplink shared channel communication corresponds to a predetermined repetition of the one or more repetitions of the uplink shared channel communication.

The CORESET manager 2125 may identify one or more CORESETs of a base station. In some cases, a first part of a repetition of the downlink control channel transmission at an aggregation level is associated with a first control resource set transmitted by the base station, and a second part of the repetition of the downlink control channel transmission is associated with a second control resource set transmitted by the base station. In some cases, the control resource set configuration has a set of search spaces that are candidates for downlink control channel communications, and where one or more search space candidates are dropped based on the determined repetition level. In some cases, the information from the base station is received in a master information block (MIB) that indicates whether repetitions are used, a repetition level, shift information, or any combinations thereof. In some cases, one or more slots are determined to be downlink control channel transmission candidates, and a repetition level and a starting slot number may be indicated in the MIB.

The search space manager 2130 may determine the first repetition resource set for the downlink control channel transmission based on a configured search space of a set of search spaces that are candidates for downlink control channel communications. In some examples, the search space manager 2130 may derive the one or more additional repetition resource sets based on the first repetition resource set. In some cases, the repetition resource sets include one or more configured search spaces of a set of available search spaces. In some cases, the one or more configured search spaces include all search space candidates for an indicated number of slots, search space candidates up to an indicated repetition level, or search space candidates that are determined based on a gap that indicates how many search space candidates are skipped between two repetitions. In some cases, one or more repetition resource sets are located in UE-specific search spaces that are at a same frequency within a same slot and are shifted in frequency across slots. In some cases, one or more repetition resource sets are located in common search spaces that are at a same frequency within a same slot, and that are at the same frequency across slots.

The PBCH manager 2135 may adjacent sets of physical broadcast channel resources for two or more repetitions of the physical broadcast channel communication are determined based on a defined time gap between adjacent repetitions. In some examples, the PBCH manager 2135 may two or more sets of physical broadcast channel frequency resources are defined within a slot, and where two or more repetitions of the physical broadcast channel communication use different sets of physical broadcast channel frequency resources within the slot. In some cases, each repetition of the physical broadcast channel communications use a same set of beamforming parameters. In some cases, the two or more repetitions of the physical broadcast channel communication use a same system frame number (SFN) as an initial transmission of the physical broadcast channel communication. In some cases, the two or more repetitions of the physical broadcast channel communication use a same half-frame bit associated with a system frame number as an initial transmission of the physical broadcast channel communication. In some cases, the two or more repetitions of the physical broadcast channel communication use a same synchronization signal (SS)/physical broadcast channel (PBCH) index as an initial transmission of the physical broadcast channel communication.

FIG. 22 shows a diagram of a system 2200 including a device 2205 that supports reliability and coverage enhancement for NTNs in accordance with aspects of the present disclosure. The device 2205 may be an example of or include the components of device 1905, device 2005, or a UE 115 as described herein. The device 2205 may include components for bi-directional voice and data communications including components for transmitting and receiving communications, including a communications manager 2210, an I/O controller 2215, a transceiver 2220, an antenna 2225, memory 2230, and a processor 2240. These components may be in electronic communication via one or more buses (e.g., bus 2245).

The communications manager 2210 may support wireless communications at a UE in accordance with examples as disclosed herein. For example, the communications manager 2210 may be configured as or otherwise support a means for receiving a control channel communication that indicates a set of multiple shared channel resources associated with a shared channel communication, the control channel communication indicating a first repetition resource set for an initial shared channel communication and one or more repetition resource sets for one or more repetitions of the shared channel communication. The communications manager 2210 may be configured as or otherwise support a means for receiving signals from two or more of the set of multiple shared channel resources based on the control channel communication. The communications manager 2210 may be configured as or otherwise support a means for decoding the shared channel communication based on the received signals from the two or more of the set of multiple shared channel resources.

The communications manager 2210 may identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission, buffer received signals from two or more of the set of resources based on the identifying, and decode the downlink control channel transmission based on the buffered received signals.

The communications manager 2210 may also identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication, buffer received signals from two or more of the set of shared channel resources based on the identifying, and decode the downlink shared channel communication based on the buffered received signals.

The communications manager 2210 may also identify a set of physical broadcast channel resources associated with a base station, the set of physical broadcast channel resources including two or more repetition resources for two or more repetitions of a physical broadcast channel communication, buffer received signals from the two or more repetitions of the physical broadcast channel communication based on the identifying, and decode the physical broadcast channel communication based on the buffered received signals.

The communications manager 2210 may also receive, from a base station, an uplink grant for an uplink communication from the UE, the uplink grant indicating a set of uplink resources that include one or more repetition resources for one or more repetitions of the uplink communication, determine a transmission frequency bandwidth for the uplink communication as a subset of a channel frequency bandwidth used for receiving downlink communications at the UE, and transmit the uplink communication via the set of uplink resources using the transmission frequency bandwidth.

The communications manager 2210 may as described herein be implemented to realize one or more potential aspects. One implementation may allow the device 2205 to reduce BLER associated with communications with of via a high altitude node, such as a satellite in a NTN, which may allow for enhanced reliability and reduced retransmissions. Further, implementations may allow the device 2205 to reduce the latency of communications, and increase signaling reliability, throughput, and user experience, while reducing power consumption, among other aspects.

The I/O controller 2215 may manage input and output signals for the device 2205. The I/O controller 2215 may also manage peripherals not integrated into the device 2205. In some cases, the I/O controller 2215 may represent a physical connection or port to an external peripheral. In some cases, the I/O controller 2215 may utilize an operating system such as iOS®, ANDROID®, MS-DOS®, MS-WINDOWS®, OS/2®, UNIX®, LINUX®, or another known operating system. In other cases, the I/O controller 2215 may represent or interact with a modem, a keyboard, a mouse, a touchscreen, or a similar device. In some cases, the I/O controller 2215 may be implemented as part of a processor. In some cases, a user may interact with the device 2205 via the I/O controller 2215 or via hardware components controlled by the I/O controller 2215.

The transceiver 2220 may communicate bi-directionally, via one or more antennas, wired, or wireless links as described above. For example, the transceiver 2220 may represent a wireless transceiver and may communicate bi-directionally with another wireless transceiver. The transceiver 2220 may also include a modem to modulate the packets and provide the modulated packets to the antennas for transmission, and to demodulate packets received from the antennas.

In some cases, the wireless device may include a single antenna 2225. However, in some cases the device may have more than one antenna 2225, which may be capable of concurrently transmitting or receiving multiple wireless transmissions.

The memory 2230 may include RAM and ROM. The memory 2230 may store computer-readable, computer-executable code 2235 including instructions that, when executed, cause the processor to perform various functions described herein. In some cases, the memory 2230 may contain, among other things, a BIOS which may control basic hardware or software operation such as the interaction with peripheral components or devices.

The processor 2240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2240 may be configured to operate a memory array using a memory controller. In other cases, a memory controller may be integrated into the processor 2240. The processor 2240 may be configured to execute computer-readable instructions stored in a memory (e.g., the memory 2230) to cause the device 2205 to perform various functions (e.g., functions or tasks supporting reliability and coverage enhancement for NTNs).

The code 2235 may include instructions to implement aspects of the present disclosure, including instructions to support wireless communications. The code 2235 may be stored in a non-transitory computer-readable medium such as system memory or other type of memory. In some cases, the code 2235 may not be directly executable by the processor 2240 but may cause a computer (e.g., when compiled and executed) to perform functions described herein.

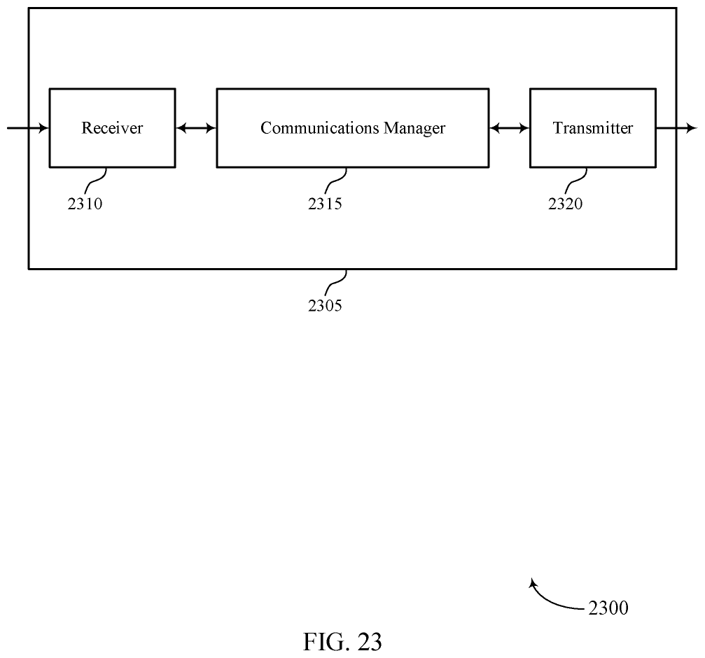

FIG. 23 shows a block diagram 2300 of a device 2305 that supports reliability and coverage enhancement for NTNs in accordance with aspects of the present disclosure. The device 2305 may be an example of aspects of a base station 105 as described herein. The device 2305 may include a receiver 2310, a communications manager 2315, and a transmitter 2320. The device 2305 may also include a processor. Each of these components may be in communication with one another (e.g., via one or more buses).

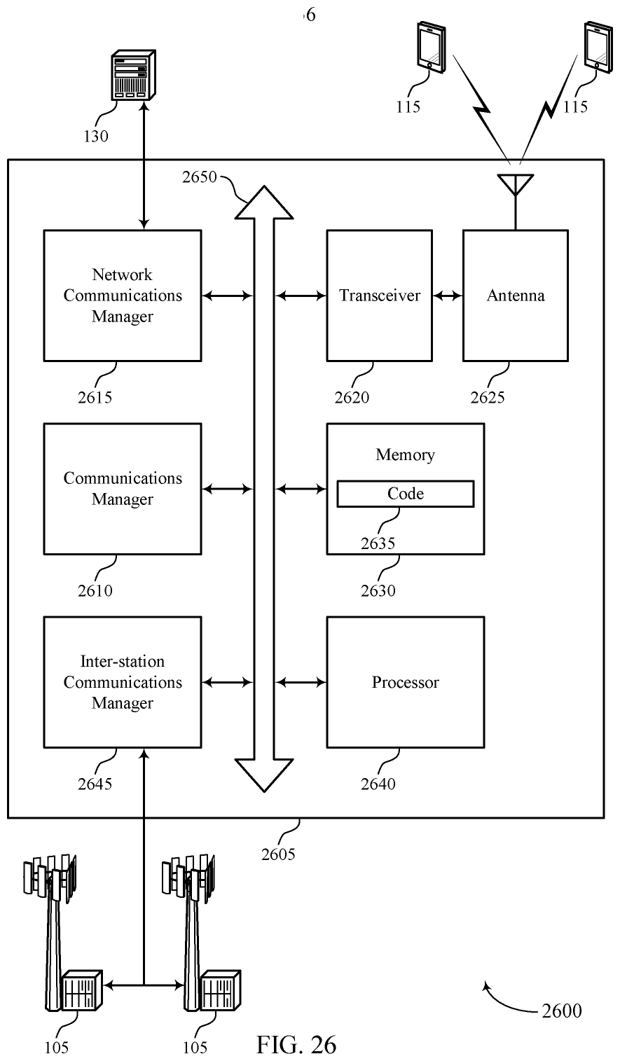

The receiver 2310 may receive information such as packets, user data, or control information associated with various information channels (e.g., control channels, data channels, and information related to reliability and coverage enhancement for NTNs, etc.). Information may be passed on to other components of the device 2305. The receiver 2310 may be an example of aspects of the transceiver 2620 described with reference to FIG. 26. The receiver 2310 may utilize a single antenna or a set of antennas.

In some cases, the communications manager 2315 may support wireless communications at a base station in accordance with examples as disclosed herein. For example, the communications manager 2315 may be configured as or otherwise support a means for configuring a set of multiple shared channel resources associated with a shared channel communication to a UE, where the set of multiple shared channel resources include a first repetition resource set for an initial shared channel communication and one or more repetition resource sets for one or more repetitions of the shared channel communication. The communications manager 2315 may be configured as or otherwise support a means for transmitting, to the UE, a control channel communication that indicates the set of multiple shared channel resources. The communications manager 2315 may be configured as or otherwise support a means for transmitting a set of multiple repetitions of the shared channel transmission using the set of multiple shared channel resources.

In some cases, the communications manager 2315 may determine that coverage enhancement is to be used for communications with a UE, identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmit a set of repetitions of the downlink control channel transmission using the set of resources.

In some cases, the communications manager 2315 may identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmit, to the UE, a control channel communication that indicates the set of shared channel resources, and transmit a set of repetitions of the downlink shared channel transmission according to the repetition pattern, using the set of shared channel resources.

In some cases, the communications manager 2315 may determine that coverage enhancement is to be used for physical broadcast channel communications with at least one UE, allocate a set of physical broadcast channel resources based on the determining, the set of physical broadcast channel resources including two or more repetition resources for two or more repetitions of the physical broadcast channel communications, and transmit a set of instances of the physical broadcast channel communications using the set of physical broadcast channel resources.

In some cases, the communications manager 2315 may determine that coverage enhancement is to be used for communications with a UE, allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmit an uplink grant for the uplink communication to the UE, buffer received signals from two or more of the set of uplink resources based on the uplink grant, and decode the uplink communication based on the buffered received signals. The communications manager 2315 may be an example of aspects of the communications manager 2610 described herein.

The communications manager 2315, or its sub-components, may be implemented in hardware, code (e.g., software or firmware) executed by a processor, or any combination thereof. If implemented in code executed by a processor, the functions of the communications manager 2315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 2315, or its sub-components, may be physically located at various positions, including being distributed such that portions of functions are implemented at different physical locations by one or more physical components. In some examples, the communications manager 2315, or its sub-components, may be a separate and distinct component in accordance with various aspects of the present disclosure. In some examples, the communications manager 2315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 2320 may transmit signals generated by other components of the device 2305. In some examples, the transmitter 2320 may be collocated with a receiver 2310 in a transceiver module. For example, the transmitter 2320 may be an example of aspects of the transceiver 2620 described with reference to FIG. 26. The transmitter 2320 may utilize a single antenna or a set of antennas.

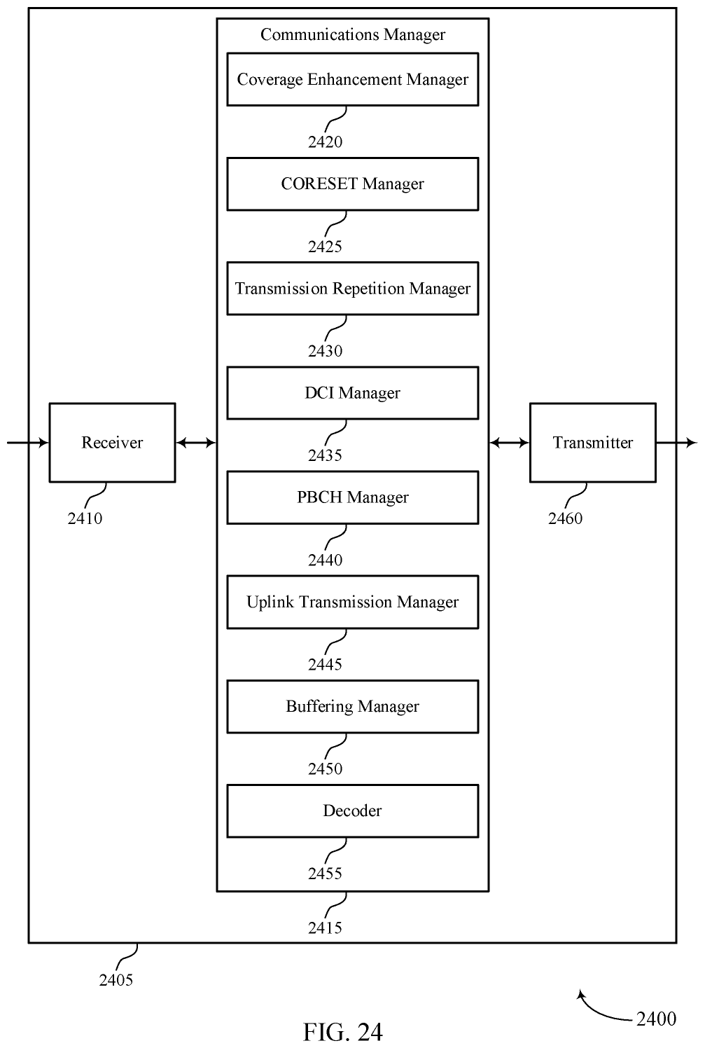

FIG. 24 shows a block diagram 2400 of a device 2405 that supports reliability and coverage enhancement for NTNs in accordance with aspects of the present disclosure. The device 2405 may be an example of aspects of a device 2305, or a base station 105 as described herein. The device 2405 may include a receiver 2410, a communications manager 2415, and a transmitter 2460. The device 2405 may also include a processor. Each of these components may be in communication with one another (e.g., via one or more buses).

The receiver 2410 may receive information such as packets, user data, or control information associated with various information channels (e.g., control channels, data channels, and information related to reliability and coverage enhancement for NTNs, etc.). Information may be passed on to other components of the device 2405. The receiver 2410 may be an example of aspects of the transceiver 2620 described with reference to FIG. 26. The receiver 2410 may utilize a single antenna or a set of antennas.

The communications manager 2415 may be an example of aspects of the communications manager 2315 as described herein. The communications manager 2415 may include a coverage enhancement manager 2420, a CORESET manager 2425, a transmission repetition manager 2430, a DCI manager 2435, a PBCH manager 2440, an uplink transmission manager 2445, a buffering manager 2450, and a decoder 2455. The communications manager 2415 may be an example of aspects of the communications manager 2610 described herein.

In some cases, the coverage enhancement manager 2420 may determine that coverage enhancement is to be used for communications with a UE. The CORESET manager 2425 may identify, based on a control resource set configuration associated with the UE, a set of resources associated with a control channel transmission to the UE, the set of resources including a first repetition resource set for an initial repetition of the control channel transmission and one or more further repetition resource sets for the control channel transmission. The transmission repetition manager 2430 may transmit a set of repetitions of the control channel transmission using the set of resources.

The communications manager 2415 may support wireless communications at a base station in accordance with examples as disclosed herein. The coverage enhancement manager 2420 may be configured as or otherwise support a means for configuring a set of multiple shared channel resources associated with a downlink shared channel communication to a UE, where the set of multiple shared channel resources include a first repetition resource set for an initial downlink shared channel communication and one or more repetition resource sets for one or more repetitions of the downlink shared channel communication. The DCI manager 2435 may be configured as or otherwise support a means for transmitting, to the UE, a control channel communication that indicates the set of multiple shared channel resources. The transmission repetition manager 2430 may be configured as or otherwise support a means for transmitting a set of multiple repetitions of the downlink shared channel transmission using the set of multiple shared channel resources.

In some cases, the coverage enhancement manager 2420 may identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern. The DCI manager 2435 may transmit, to the UE, a control channel communication that indicates the set of shared channel resources. The transmission repetition manager 2430 may transmit a set of repetitions of the downlink shared channel transmission according to the repetition pattern, using the set of shared channel resources.

In some cases, the coverage enhancement manager 2420 may determine that coverage enhancement is to be used for physical broadcast channel communications with at least one UE. The PBCH manager 2440 may allocate a set of physical broadcast channel resources based on the determining, the set of physical broadcast channel resources including two or more repetition resources for two or more repetitions of the physical broadcast channel communications. The transmission repetition manager 2430 may transmit a set of instances of the physical broadcast channel communications using the set of physical broadcast channel resources.

In some cases, the coverage enhancement manager 2420 may determine that coverage enhancement is to be used for communications with a UE. The uplink transmission manager 2445 may allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE and transmit an uplink grant for the uplink communication to the UE. The buffering manager 2450 may buffer received signals from two or more of the set of uplink resources based on the uplink grant. The decoder 2455 may decode the uplink communication based on the buffered received signals.

The transmitter 2460 may transmit signals generated by other components of the device 2405. In some examples, the transmitter 2460 may be collocated with a receiver 2410 in a transceiver module. For example, the transmitter 2460 may be an example of aspects of the transceiver 2620 described with reference to FIG. 26. The transmitter 2460 may utilize a single antenna or a set of antennas.

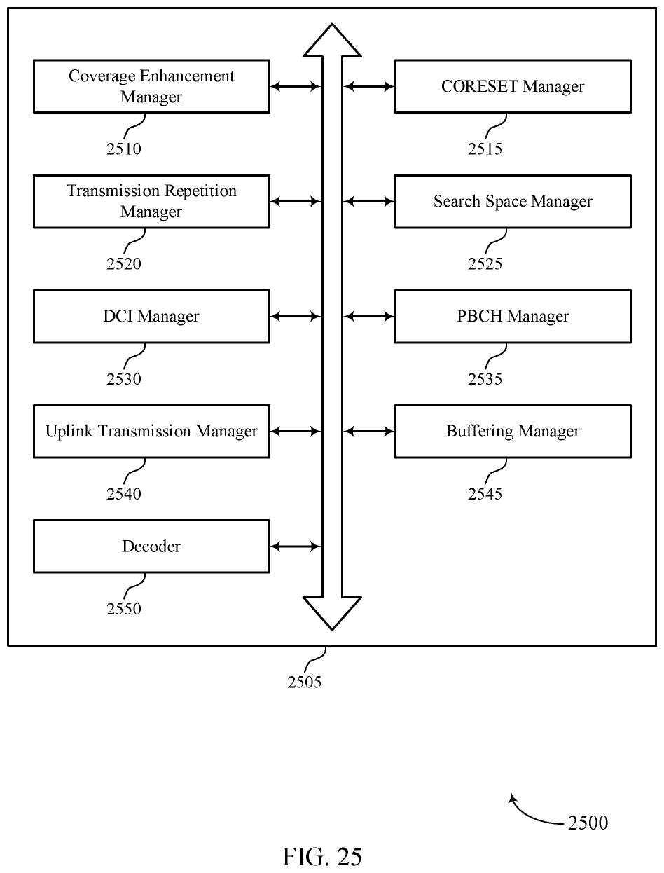

FIG. 25 shows a block diagram 2500 of a communications manager 2505 that supports reliability and coverage enhancement for NTNs in accordance with aspects of the present disclosure. The communications manager 2505 may be an example of aspects of a communications manager 2315, a communications manager 2415, or a communications manager 2610 described herein. The communications manager 2505 may include a coverage enhancement manager 2510, a CORESET manager 2515, a transmission repetition manager 2520, a search space manager 2525, a DCI manager 2530, a PBCH manager 2535, an uplink transmission manager 2540, a buffering manager 2545, and a decoder 2550. Each of these modules may communicate, directly or indirectly, with one another (e.g., via one or more buses).

The communications manager 2505 may support wireless communications at a base station in accordance with examples as disclosed herein. The coverage enhancement manager 2510 may be configured as or otherwise support a means for configuring a set of multiple shared channel resources associated with a shared channel communication to a UE, where the set of multiple shared channel resources include a first repetition resource set for an initial shared channel communication and one or more repetition resource sets for one or more repetitions of the shared channel communication. The DCI manager 2530 may be configured as or otherwise support a means for transmitting, to the UE, a control channel communication that indicates the set of multiple shared channel resources. The transmission repetition manager 2520 may be configured as or otherwise support a means for transmitting a set of multiple repetitions of the shared channel transmission using the set of multiple shared channel resources.

In some examples, repetition resource sets include resources having a periodic or non-periodic pattern across multiple consecutive or non-consecutive slots. In some examples, one or more of the repetition resource sets include multiple time resources, frequency resources, or combinations thereof, within a same slot. In some examples, the repetitions of the shared channel transmission include repetitions of an exact copy of the shared channel transmission or include different redundancy versions of the shared channel transmission. In some examples, control channel communication further indicates a repetition pattern for the one or more repetitions of the shared channel communication. In some examples, the UE and the base station are nodes in a non-terrestrial network (NTN). In some examples, the shared channel communication has multiple repetitions in a same slot. In some examples, a repetition pattern associated with the set of multiple repetitions of the shared channel transmission provides a duration that repetitions according to the repetition pattern are to be transmitted, a number of slots between consecutive repetitions, or any combinations thereof. In some examples, the control channel communication further indicates whether different redundancy versions (RVs) are used for consecutive repetitions of the shared channel communication.

In some examples, the coverage enhancement manager 2510 may determine that coverage enhancement is to be used for communications with a UE. In some examples, the coverage enhancement manager 2510 may identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern. In some examples, the coverage enhancement manager 2510 may determine that coverage enhancement is to be used for physical broadcast channel communications with at least one UE.

In some examples, the coverage enhancement manager 2510 may transmit an indication to the UE that repetitions of the downlink control channel transmission are enabled and that indicates whether the repetitions are slot-based repetitions or control resource set based repetitions. In some cases, the repetition resource sets include resources having a periodic or non-periodic pattern across multiple consecutive or non-consecutive slots. In some cases, one or more of the repetition resource sets include multiple time resources, frequency resources, or combinations thereof, within a same slot. In some cases, the repetition resource sets include two or more different time resources, two or more different frequency resources, two or more resources associated with different control resource sets, or any combinations thereof.

In some cases, the repetition resource sets are derived based on one or more of a time shift and repetition level associated with the first repetition resource set, and where the time shift is a fixed time shift, a deterministic time shift, or a pseudo-random time shift relative to the first repetition resource set. In some cases, the repetition resource sets are derived based on one or more of a frequency shift and repetition level associated with the first repetition resource set, and where the frequency shift is a fixed frequency shift, a deterministic frequency shift, or a pseudo-random frequency shift relative to the first repetition resource set. In some cases, the repetition resource sets are derived based on a control resource set shift associated with the first repetition resource set and the control resource set configuration, and where the control resource set shift indicates one or more control resource sets that carry one or more repetitions of the downlink control channel transmission.

The CORESET manager 2515 may identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission.

In some cases, a first part of a repetition of the downlink control channel transmission at an aggregation level is associated with a first control resource set transmitted by the base station, and a second part of the repetition of the downlink control channel transmission is associated with a second control resource set transmitted by the base station.

In some cases, the indication is transmitted in a master information block (MIB) that indicates whether repetitions are used, a repetition level, shift information, or any combinations thereof. In some cases, the repetition resource sets are determined based on a mapping between the MIB information and one or more time locations, frequency locations, a repetition level, or any combinations thereof.

The transmission repetition manager 2520 may transmit a set of repetitions of the downlink control channel transmission using the set of resources. In some examples, the transmission repetition manager 2520 may transmit a set of repetitions of the downlink shared channel transmission according to the repetition pattern, using the set of shared channel resources. In some examples, the transmission repetition manager 2520 may transmit a set of instances of the physical broadcast channel communications using the set of physical broadcast channel resources.

In some examples, the transmission repetition manager 2520 may determine the first repetition resource set for the downlink control channel transmission based on a configured search space of a set of search spaces that are candidates for downlink control channel communications. In some examples, the transmission repetition manager 2520 may derive one or more repetition resource sets based on the first repetition resource set.

In some examples, two or more sets of physical broadcast channel frequency resources are defined within a slot, and where two or more repetitions of the physical broadcast channel communication use different sets of physical broadcast channel frequency resources within the slot. In some cases, the repetitions of the downlink control channel transmission include repetitions of an exact copy of the downlink control channel transmission or include different redundancy versions of the downlink control channel transmission. In some cases, a repetition level of the one or more repetitions of the downlink control channel transmission is determined based on mapping between the repetition level and a scrambling identification, a radio network temporary identifier (RNTI), or a DCI size.

In some cases, the downlink control channel transmission includes a grant of downlink shared channel resources, and where the downlink shared channel resources start before or after a final repetition resource. In some cases, the downlink shared channel communication has multiple repetitions in a same slot. In some cases, each repetition of the physical broadcast channel communications use a same set of beamforming parameters. In some cases, the one or more repetitions of the uplink communication include retransmissions of a same communication or different redundancy versions (RVs) of the uplink communication.

The DCI manager 2530 may transmit, to the UE, a control channel communication that indicates the set of shared channel resources. In some cases, the repetition pattern provided is provided in DCI in the control channel communication, and where the DCI further indicates a duration that repetitions according to the repetition pattern are to be transmitted, a number of slots between consecutive repetitions, or any combinations thereof. In some cases, the control channel communication further indicates whether different redundancy versions (RVs) are used for consecutive repetitions of the downlink shared channel communication, and where the buffering is further based on whether the different RVs are used for the consecutive repetitions.

The PBCH manager 2535 may allocate a set of physical broadcast channel resources based on the determining, the set of physical broadcast channel resources including two or more repetition resources for two or more repetitions of the physical broadcast channel communications. In some examples, adjacent sets of physical broadcast channel resources for two or more repetitions of the physical broadcast channel communication are determined based on a defined time gap between adjacent repetitions. In some cases, the two or more repetitions of the physical broadcast channel communication use a same system frame number (SFN) as an initial transmission of the physical broadcast channel communication. In some cases, the two or more repetitions of the physical broadcast channel communication use a same half-frame bit associated with a system frame number as an initial transmission of the physical broadcast channel communication.

The uplink transmission manager 2540 may allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE. In some examples, the uplink transmission manager 2540 may transmit an uplink grant for the uplink communication to the UE.

In some cases, the uplink communication is an uplink control channel communication and the uplink grant indicates a repetition level and resource allocation for the uplink control channel communication over multiple slots. In some cases, the uplink communication is an uplink shared channel communication and the uplink grant indicates a repetition level and resource allocation for the uplink shared channel communication over multiple slots. In some cases, a timing between the uplink grant and the uplink shared channel communication corresponds to a predetermined repetition of the one or more repetitions of the uplink shared channel communication.

The buffering manager 2545 may buffer received signals from two or more of the set of uplink resources based on the uplink grant. The decoder 2550 may decode the uplink communication based on the buffered received signals. The search space manager 2525 may configure one or more search spaces at a UE. In some cases, the repetition resources include one or more configured search spaces of a set of available search spaces. In some cases, the one or more configured search spaces include all search space candidates for an indicated number of slots, search space candidates up to an indicated repetition level, or search space candidates that are determined based on a gap that indicates how many search space candidates are skipped between two repetitions.

FIG. 26 shows a diagram of a system 2600 including a device 2605 that supports reliability and coverage enhancement for NTNs in accordance with aspects of the present disclosure. The device 2605 may be an example of or include the components of device 2305, device 2405, or a base station 105 as described herein. The device 2605 may include components for bi-directional voice and data communications including components for transmitting and receiving communications, including a communications manager 2610, a network communications manager 2615, a transceiver 2620, an antenna 2625, memory 2630, a processor 2640, and an inter-station communications manager 2645. These components may be in electronic communication via one or more buses (e.g., bus 2650).

The communications manager 2610 may support wireless communications at a base station in accordance with examples as disclosed herein. For example, the communications manager 2610 may be configured as or otherwise support a means for configuring a set of multiple shared channel resources associated with a shared channel communication to a UE, where the set of multiple shared channel resources include a first repetition resource set for an initial shared channel communication and one or more repetition resource sets for one or more repetitions of the shared channel communication. The communications manager 2610 may be configured as or otherwise support a means for transmitting, to the UE, a control channel communication that indicates the set of multiple shared channel resources. The communications manager 2610 may be configured as or otherwise support a means for transmitting a set of multiple repetitions of the shared channel transmission using the set of multiple shared channel resources.

The communications manager 2610 may determine that coverage enhancement is to be used for communications with a UE, identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission, and transmit a set of repetitions of the downlink control channel transmission using the set of resources.

The communications manager 2610 may also identify a set of shared channel resources associated with a downlink shared channel communication to a UE and a repetition pattern for the one or more repetitions of the downlink shared channel communication, where the set of shared channel resources include one or more repetition resource sets for one or more repetitions of the downlink shared channel communication according to the repetition pattern, transmit, to the UE, a control channel communication that indicates the set of shared channel resources, and transmit a set of repetitions of the downlink shared channel transmission according to the repetition pattern, using the set of shared channel resources.

The communications manager 2610 may also determine that coverage enhancement is to be used for physical broadcast channel communications with at least one UE, allocate a set of physical broadcast channel resources based on the determining, the set of physical broadcast channel resources including two or more repetition resources for two or more repetitions of the physical broadcast channel communications, and transmit a set of instances of the physical broadcast channel communications using the set of physical broadcast channel resources.

The communications manager 2610 may also determine that coverage enhancement is to be used for communications with a UE, allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE, transmit an uplink grant for the uplink communication to the UE, buffer received signals from two or more of the set of uplink resources based on the uplink grant, and decode the uplink communication based on the buffered received signals.

The network communications manager 2615 may manage communications with the core network (e.g., via one or more wired backhaul links). For example, the network communications manager 2615 may manage the transfer of data communications for client devices, such as one or more UEs 115.

The transceiver 2620 may communicate bi-directionally, via one or more antennas, wired, or wireless links as described above. For example, the transceiver 2620 may represent a wireless transceiver and may communicate bi-directionally with another wireless transceiver. The transceiver 2620 may also include a modem to modulate the packets and provide the modulated packets to the antennas for transmission, and to demodulate packets received from the antennas.

In some cases, the wireless device may include a single antenna 2625. However, in some cases the device may have more than one antenna 2625, which may be capable of concurrently transmitting or receiving multiple wireless transmissions.

The memory 2630 may include RAM, ROM, or a combination thereof. The memory 2630 may store computer-readable code 2635 including instructions that, when executed by a processor (e.g., the processor 2640) cause the device to perform various functions described herein. In some cases, the memory 2630 may contain, among other things, a BIOS which may control basic hardware or software operation such as the interaction with peripheral components or devices.

The processor 2640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2640 may be configured to operate a memory array using a memory controller. In some cases, a memory controller may be integrated into processor 2640. The processor 2640 may be configured to execute computer-readable instructions stored in a memory (e.g., the memory 2630) to cause the device 2605 to perform various functions (e.g., functions or tasks supporting reliability and coverage enhancement for NTNs).

The inter-station communications manager 2645 may manage communications with other base station 105, and may include a controller or scheduler for controlling communications with UEs 115 in cooperation with other base stations 105. For example, the inter-station communications manager 2645 may coordinate scheduling for transmissions to UEs 115 for various interference mitigation techniques such as beamforming or joint transmission. In some examples, the inter-station communications manager 2645 may provide an X2 interface within an LTE/LTE-A wireless communication network technology to provide communication between base stations 105.

The code 2635 may include instructions to implement aspects of the present disclosure, including instructions to support wireless communications. The code 2635 may be stored in a non-transitory computer-readable medium such as system memory or other type of memory. In some cases, the code 2635 may not be directly executable by the processor 2640 but may cause a computer (e.g., when compiled and executed) to perform functions described herein.

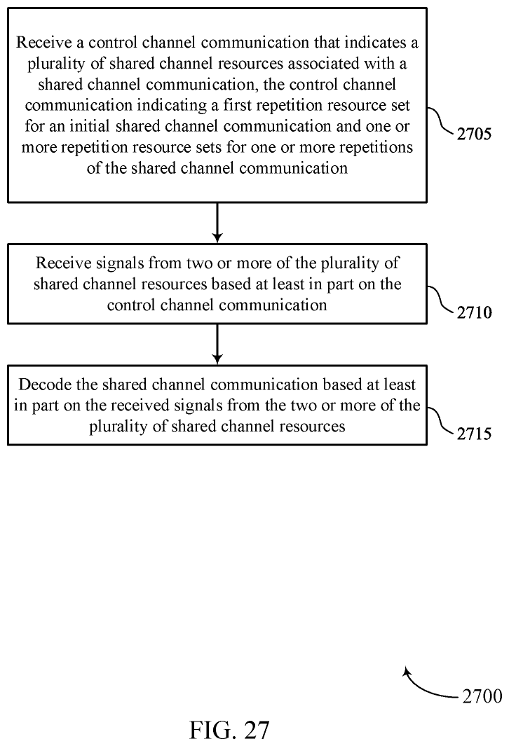

FIG. 27 shows a flowchart illustrating a method 2700 that supports reliability and coverage enhancement for NTNs in accordance with aspects of the present disclosure. The operations of method 2700 may be implemented by a UE 115 or its components as described herein. For example, the operations of method 2700 may be performed by a communications manager as described with reference to FIGS. 19 through 22. In some examples, a UE may execute a set of instructions to control the functional elements of the UE to perform the functions described below. Additionally or alternatively, a UE may perform aspects of the functions described below using special-purpose hardware.

At 2705, the UE may receive a control channel communication that indicates a set of multiple shared channel resources associated with a shared channel communication, the control channel communication indicating a first repetition resource set for an initial shared channel communication and one or more repetition resource sets for one or more repetitions of the shared channel communication. The operations of 2705 may be performed according to the methods described herein. In some examples, aspects of the operations of 2705 may be performed by a coverage enhancement manager as described with reference to FIGS. 19 through 22.

At 2710, the UE may receive signals from two or more of the set of multiple shared channel resources based on the control channel communication. The operations of 2710 may be performed according to the methods described herein. In some examples, aspects of the operations of 2710 may be performed by a buffering manager as described with reference to FIGS. 19 through 22.

At 2715, the UE may decode the shared channel communication based on the received signals from the two or more of the set of multiple shared channel resources. The operations of 2715 may be performed according to the methods described herein. In some examples, aspects of the operations of 2715 may be performed by a decoder as described with reference to FIGS. 19 through 22.

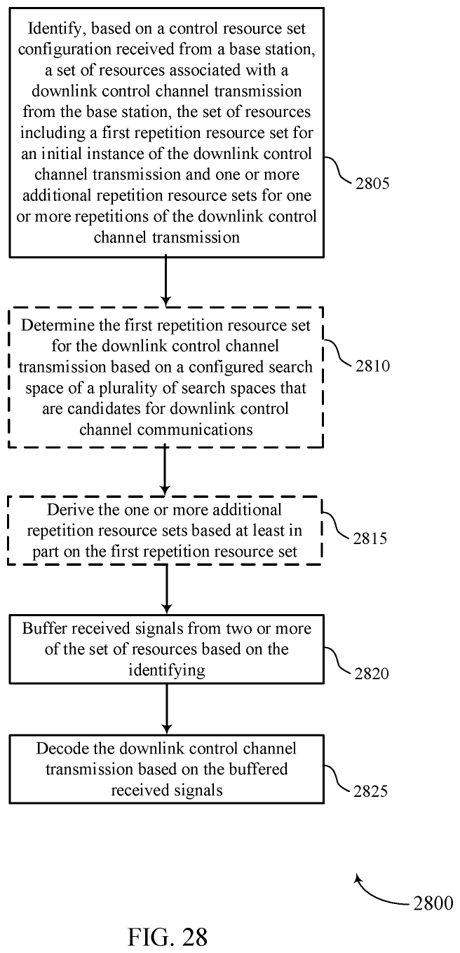

FIG. 28 shows a flowchart illustrating a method 2800 that supports reliability and coverage enhancement for NTNs in accordance with aspects of the present disclosure. The operations of method 2800 may be implemented by a UE 115 or its components as described herein. For example, the operations of method 2800 may be performed by a communications manager as described with reference to FIGS. 19 through 22. In some examples, a UE may execute a set of instructions to control the functional elements of the UE to perform the functions described below. Additionally or alternatively, a UE may perform aspects of the functions described below using special-purpose hardware.

At 2805, the UE may identify, based on a control resource set configuration received from a base station, a set of resources associated with a downlink control channel transmission from the base station, the set of resources including a first repetition resource set for an initial instance of the downlink control channel transmission and one or more additional repetition resource sets for one or more repetitions of the downlink control channel transmission. The operations of 2805 may be performed according to the methods described herein. In some examples, aspects of the operations of 2805 may be performed by a coverage enhancement manager as described with reference to FIGS. 19 through 22.

Optionally, at 2810, the UE may determine the first repetition resource set for the downlink control channel transmission based on a configured search space of a plurality of search spaces that are candidates for downlink control channel communications. The operations of 2810 may be performed according to the methods described herein. In some examples, aspects of the operations of 2810 may be performed by a coverage enhancement manager as described with reference to FIGS. 19 through 22.

Optionally, at 2815, the UE may derive the one or more additional repetition resource sets based at least in part on the first repetition resource set. The operations of 2815 may be performed according to the methods described herein. In some examples, aspects of the operations of 2815 may be performed by a coverage enhancement manager as described with reference to FIGS. 19 through 22.

At 2820, the UE may buffer received signals from two or more of the set of resources based on the identifying. The operations of 2820 may be performed according to the methods described herein. In some examples, aspects of the operations of 2820 may be performed by a buffering manager as described with reference to FIGS. 19 through 22.

At 2825, the UE may decode the downlink control channel transmission based on the buffered received signals. The operations of 2825 may be performed according to the methods described herein. In some examples, aspects of the operations of 2825 may be performed by a decoder as described with reference to FIGS. 19 through 22.

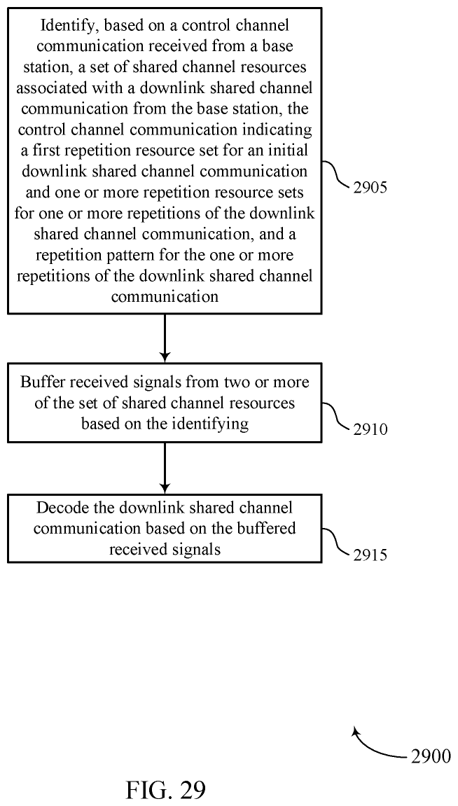

FIG. 29 shows a flowchart illustrating a method 2900 that supports reliability and coverage enhancement for NTNs in accordance with aspects of the present disclosure. The operations of method 2900 may be implemented by a UE 115 or its components as described herein. For example, the operations of method 2900 may be performed by a communications manager as described with reference to FIGS. 19 through 22. In some examples, a UE may execute a set of instructions to control the functional elements of the UE to perform the functions described below. Additionally or alternatively, a UE may perform aspects of the functions described below using special-purpose hardware.

At 2905, the UE may identify, based on a control channel communication received from a base station, a set of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication. The operations of 2905 may be performed according to the methods described herein. In some examples, aspects of the operations of 2905 may be performed by a coverage enhancement manager as described with reference to FIGS. 19 through 22.

At 2910, the UE may buffer received signals from two or more of the set of shared channel resources based on the identifying. The operations of 2910 may be performed according to the methods described herein. In some examples, aspects of the operations of 2910 may be performed by a buffering manager as described with reference to FIGS. 19 through 22.

At 2915, the UE may decode the downlink shared channel communication based on the buffered received signals. The operations of 2915 may be performed according to the methods described herein. In some examples, aspects of the operations of 2915 may be performed by a decoder as described with reference to FIGS. 19 through 22.

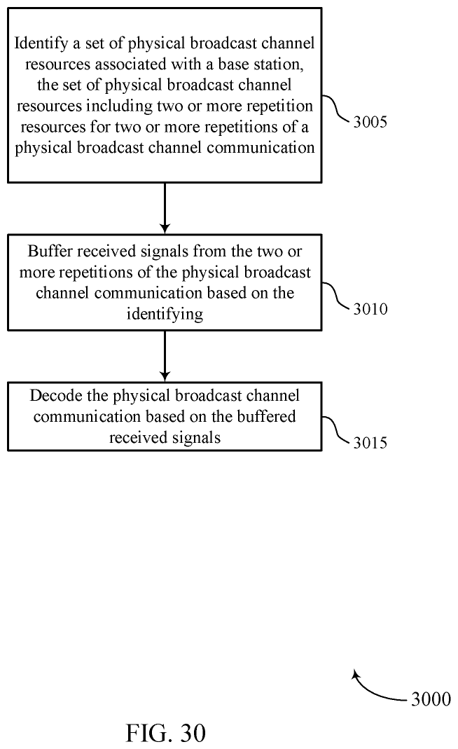

FIG. 30 shows a flowchart illustrating a method 3000 that supports reliability and coverage enhancement for NTNs in accordance with aspects of the present disclosure. The operations of method 3000 may be implemented by a UE 115 or its components as described herein. For example, the operations of method 3000 may be performed by a communications manager as described with reference to FIGS. 19 through 22. In some examples, a UE may execute a set of instructions to control the functional elements of the UE to perform the functions described below. Additionally or alternatively, a UE may perform aspects of the functions described below using special-purpose hardware.

At 3005, the UE may identify a set of physical broadcast channel resources associated with a base station, the set of physical broadcast channel resources including two or more repetition resources for two or more repetitions of a physical broadcast channel communication. The operations of 3005 may be performed according to the methods described herein. In some examples, aspects of the operations of 3005 may be performed by a coverage enhancement manager as described with reference to FIGS. 19 through 22.

At 3010, the UE may buffer received signals from the two or more repetitions of the physical broadcast channel communication based on the identifying. The operations of 3010 may be performed according to the methods described herein. In some examples, aspects of the operations of 3010 may be performed by a buffering manager as described with reference to FIGS. 19 through 22.

At 3015, the UE may decode the physical broadcast channel communication based on the buffered received signals. The operations of 3015 may be performed according to the methods described herein. In some examples, aspects of the operations of 3015 may be performed by a decoder as described with reference to FIGS. 19 through 22.

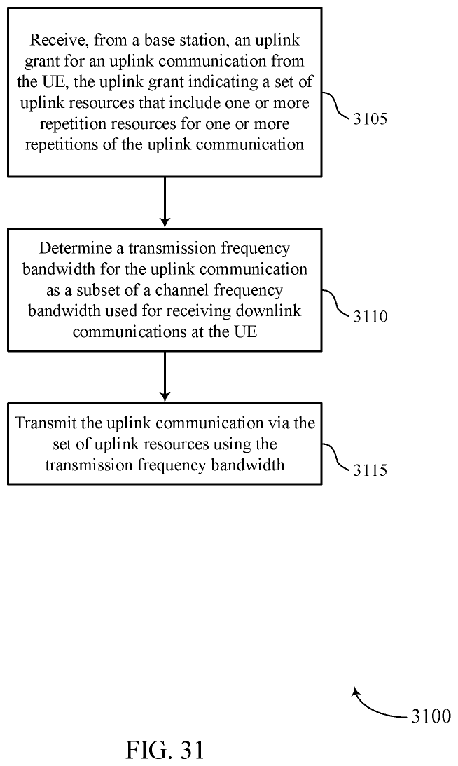

FIG. 31 shows a flowchart illustrating a method 3100 that supports reliability and coverage enhancement for NTNs in accordance with aspects of the present disclosure. The operations of method 3100 may be implemented by a UE 115 or its components as described herein. For example, the operations of method 3100 may be performed by a communications manager as described with reference to FIGS. 19 through 22. In some examples, a UE may execute a set of instructions to control the functional elements of the UE to perform the functions described below. Additionally or alternatively, a UE may perform aspects of the functions described below using special-purpose hardware.

At 3105, the UE may receive, from a base station, an uplink grant for an uplink communication from the UE, the uplink grant indicating a set of uplink resources that include one or more repetition resources for one or more repetitions of the uplink communication. The operations of 3105 may be performed according to the methods described herein. In some examples, aspects of the operations of 3105 may be performed by a coverage enhancement manager as described with reference to FIGS. 19 through 22.

At 3110, the UE may determine a transmission frequency bandwidth for the uplink communication as a subset of a channel frequency bandwidth used for receiving downlink communications at the UE. The operations of 3110 may be performed according to the methods described herein. In some examples, aspects of the operations of 3110 may be performed by an uplink frequency bandwidth manager as described with reference to FIGS. 19 through 22.

At 3115, the UE may transmit the uplink communication via the set of uplink resources using the transmission frequency bandwidth. The operations of 3115 may be performed according to the methods described herein. In some examples, aspects of the operations of 3115 may be performed by an uplink transmission manager as described with reference to FIGS. 19 through 22.

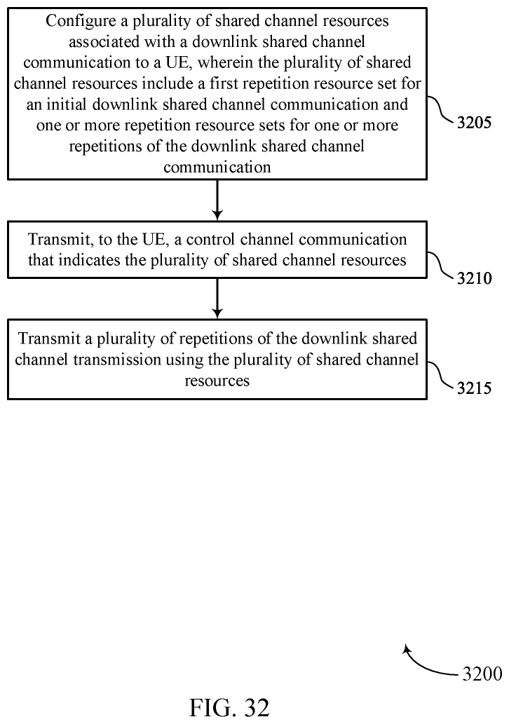

FIG. 32 shows a flowchart illustrating a method 3300 that supports reliability and coverage enhancement for NTNs in accordance with aspects of the present disclosure. The operations of method 3300 may be implemented by a base station 105 or its components as described herein. For example, the operations of method 3300 may be performed by a communications manager as described with reference to FIGS. 23 through 26. In some examples, a base station may execute a set of instructions to control the functional elements of the base station to perform the functions described below. Additionally or alternatively, a base station may perform aspects of the functions described below using special-purpose hardware.

At 3305, the base station may configure a set of multiple shared channel resources associated with a downlink shared channel communication to a UE, where the set of multiple shared channel resources include a first repetition resource set for an initial downlink shared channel communication and one or more repetition resource sets for one or more repetitions of the downlink shared channel communication. The operations of 3305 may be performed according to the methods described herein. In some examples, aspects of the operations of 3305 may be performed by a coverage enhancement manager as described with reference to FIGS. 23 through 26.

At 3310, the base station may transmit, to the UE, a control channel communication that indicates the set of multiple shared channel resources. The operations of 3310 may be performed according to the methods described herein. In some examples, aspects of the operations of 3310 may be performed by a DCI manager as described with reference to FIGS. 23 through 26.

At 3315, the base station may transmit a set of multiple repetitions of the downlink shared channel transmission using the set of multiple shared channel resources. The operations of 3315 may be performed according to the methods described herein. In some examples, aspects of the operations of 3315 may be performed by a transmission repetition manager as described with reference to FIGS. 23 through 26.

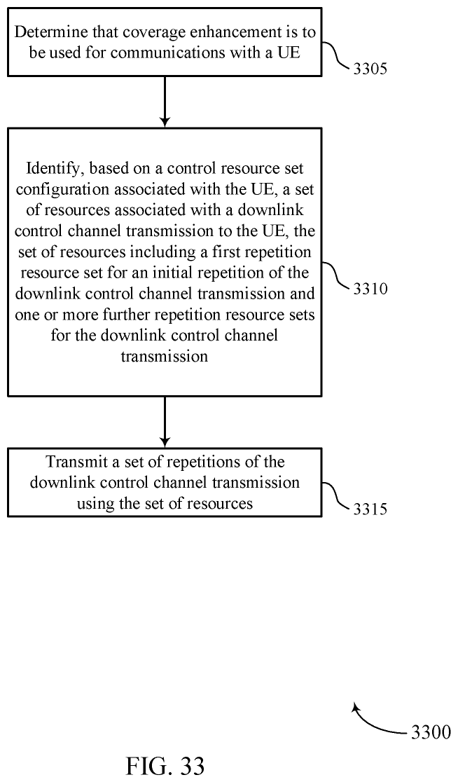

FIG. 33 shows a flowchart illustrating a method 3300 that supports reliability and coverage enhancement for NTNs in accordance with aspects of the present disclosure. The operations of method 3300 may be implemented by a base station 105 or its components as described herein. For example, the operations of method 3300 may be performed by a communications manager as described with reference to FIGS. 23 through 26. In some examples, a base station may execute a set of instructions to control the functional elements of the base station to perform the functions described below. Additionally or alternatively, a base station may perform aspects of the functions described below using special-purpose hardware.

At 3305, the base station may determine that coverage enhancement is to be used for communications with a UE. The operations of 3305 may be performed according to the methods described herein. In some examples, aspects of the operations of 3305 may be performed by a coverage enhancement manager as described with reference to FIGS. 23 through 26.

At 3310, the base station may identify, based on a control resource set configuration associated with the UE, a set of resources associated with a downlink control channel transmission to the UE, the set of resources including a first repetition resource set for an initial repetition of the downlink control channel transmission and one or more further repetition resource sets for the downlink control channel transmission. The operations of 3310 may be performed according to the methods described herein. In some examples, aspects of the operations of 3310 may be performed by a CORESET manager as described with reference to FIGS. 23 through 26.

At 3315, the base station may transmit a set of repetitions of the downlink control channel transmission using the set of resources. The operations of 3315 may be performed according to the methods described herein. In some examples, aspects of the operations of 3315 may be performed by a transmission repetition manager as described with reference to FIGS. 23 through 26.

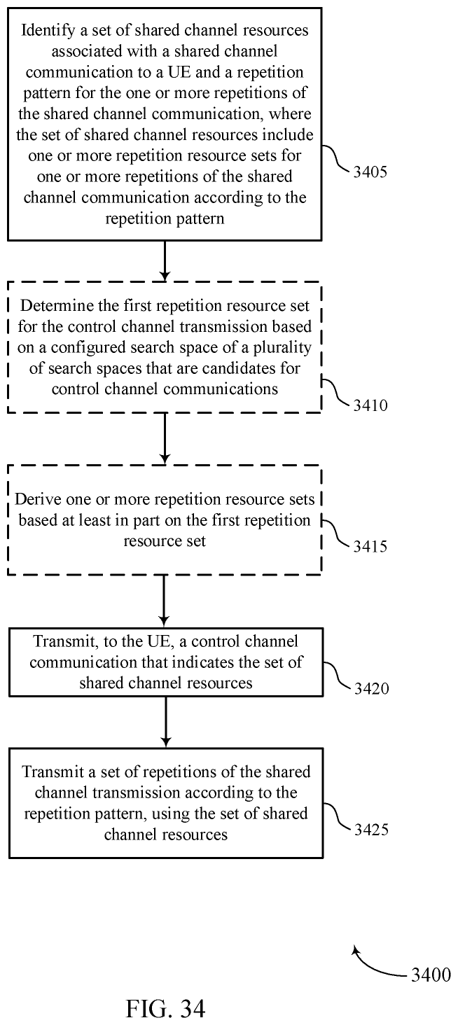

FIG. 34 shows a flowchart illustrating a method 3400 that supports reliability and coverage enhancement for NTNs in accordance with aspects of the present disclosure. The operations of method 3400 may be implemented by a base station 105 or its components as described herein. For example, the operations of method 3400 may be performed by a communications manager as described with reference to FIGS. 23 through 26. In some examples, a base station may execute a set of instructions to control the functional elements of the base station to perform the functions described below. Additionally or alternatively, a base station may perform aspects of the functions described below using special-purpose hardware.

At 3405, the base station may identify a set of shared channel resources associated with a shared channel communication to a UE and a repetition pattern for the one or more repetitions of the shared channel communication, where the set of shared channel resources include one or more repetition resource sets for one or more repetitions of the shared channel communication according to the repetition pattern. The operations of 3405 may be performed according to the methods described herein. In some examples, aspects of the operations of 3405 may be performed by a coverage enhancement manager as described with reference to FIGS. 23 through 26.

Optionally, at 3410, the base station may determine the first repetition resource set for the control channel transmission based on a configured search space of a plurality of search spaces that are candidates for control channel communications. The operations of 3410 may be performed according to the methods described herein. In some examples, aspects of the operations of 3410 may be performed by a coverage enhancement manager as described with reference to FIGS. 23 through 26.

Optionally, at 3415, the base station may derive one or more repetition resource sets based at least in part on the first repetition resource set. The operations of 3415 may be performed according to the methods described herein. In some examples, aspects of the operations of 3415 may be performed by a coverage enhancement manager as described with reference to FIGS. 23 through 26.

At 3420, the base station may transmit, to the UE, a control channel communication that indicates the set of shared channel resources. The operations of 3420 may be performed according to the methods described herein. In some examples, aspects of the operations of 3420 may be performed by a DCI manager as described with reference to FIGS. 23 through 26.

At 3425, the base station may transmit a set of repetitions of the shared channel transmission according to the repetition pattern, using the set of shared channel resources. The operations of 3425 may be performed according to the methods described herein. In some examples, aspects of the operations of 3425 may be performed by a transmission repetition manager as described with reference to FIGS. 23 through 26.

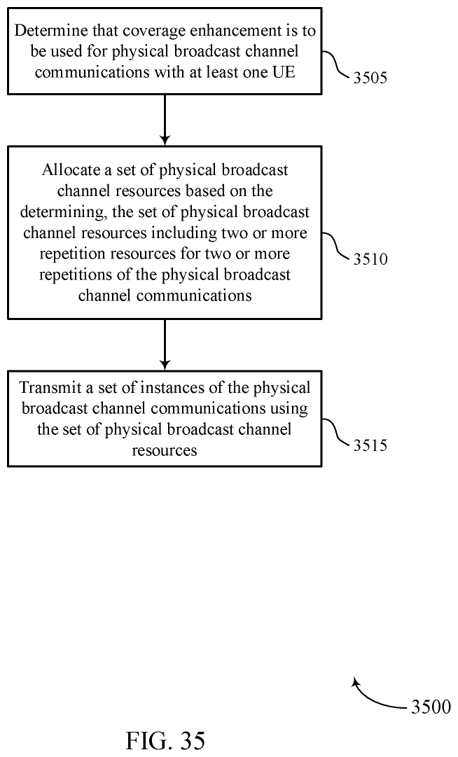

FIG. 35 shows a flowchart illustrating a method 3500 that supports reliability and coverage enhancement for NTNs in accordance with aspects of the present disclosure. The operations of method 3500 may be implemented by a base station 105 or its components as described herein. For example, the operations of method 3500 may be performed by a communications manager as described with reference to FIGS. 23 through 26. In some examples, a base station may execute a set of instructions to control the functional elements of the base station to perform the functions described below. Additionally or alternatively, a base station may perform aspects of the functions described below using special-purpose hardware.

At 3505, the base station may determine that coverage enhancement is to be used for physical broadcast channel communications with at least one UE. The operations of 3505 may be performed according to the methods described herein. In some examples, aspects of the operations of 3505 may be performed by a coverage enhancement manager as described with reference to FIGS. 23 through 26.

At 3510, the base station may allocate a set of physical broadcast channel resources based on the determining, the set of physical broadcast channel resources including two or more repetition resources for two or more repetitions of the physical broadcast channel communications. The operations of 3510 may be performed according to the methods described herein. In some examples, aspects of the operations of 3510 may be performed by a PBCH manager as described with reference to FIGS. 23 through 26.

At 3515, the base station may transmit a set of instances of the physical broadcast channel communications using the set of physical broadcast channel resources. The operations of 3515 may be performed according to the methods described herein. In some examples, aspects of the operations of 3515 may be performed by a transmission repetition manager as described with reference to FIGS. 23 through 26.

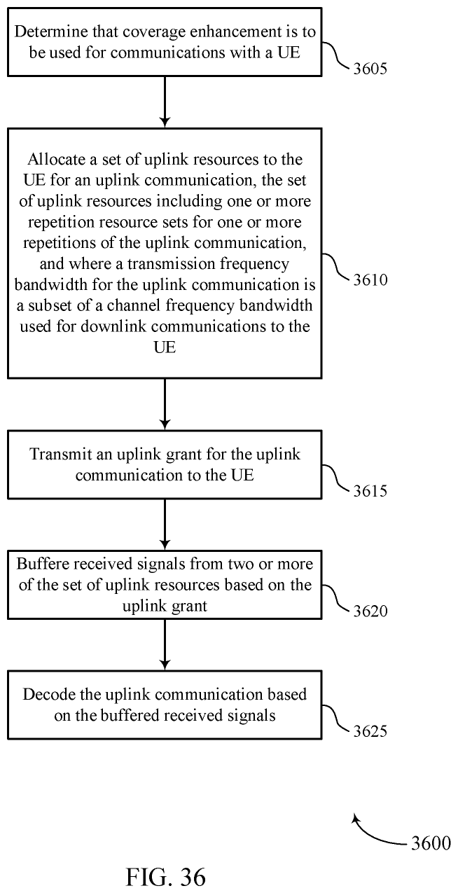

FIG. 36 shows a flowchart illustrating a method 3600 that supports reliability and coverage enhancement for NTNs in accordance with aspects of the present disclosure. The operations of method 3600 may be implemented by a base station 105 or its components as described herein. For example, the operations of method 3600 may be performed by a communications manager as described with reference to FIGS. 23 through 26. In some examples, a base station may execute a set of instructions to control the functional elements of the base station to perform the functions described below. Additionally or alternatively, a base station may perform aspects of the functions described below using special-purpose hardware.

At 3605, the base station may determine that coverage enhancement is to be used for communications with a UE. The operations of 3605 may be performed according to the methods described herein. In some examples, aspects of the operations of 3605 may be performed by a coverage enhancement manager as described with reference to FIGS. 23 through 26.

At 3610, the base station may allocate a set of uplink resources to the UE for an uplink communication, the set of uplink resources including one or more repetition resource sets for one or more repetitions of the uplink communication, and where a transmission frequency bandwidth for the uplink communication is a subset of a channel frequency bandwidth used for downlink communications to the UE. The operations of 3610 may be performed according to the methods described herein. In some examples, aspects of the operations of 3610 may be performed by an uplink transmission manager as described with reference to FIGS. 23 through 26.

At 3615, the base station may transmit an uplink grant for the uplink communication to the UE. The operations of 3615 may be performed according to the methods described herein. In some examples, aspects of the operations of 3615 may be performed by an uplink transmission manager as described with reference to FIGS. 23 through 26.

At 3620, the base station may buffer received signals from two or more of the set of uplink resources based on the uplink grant. The operations of 3620 may be performed according to the methods described herein. In some examples, aspects of the operations of 3620 may be performed by a buffering manager as described with reference to FIGS. 23 through 26.

At 3625, the base station may decode the uplink communication based on the buffered received signals. The operations of 3625 may be performed according to the methods described herein. In some examples, aspects of the operations of 3625 may be performed by a decoder as described with reference to FIGS. 23 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

The following provides an overview of aspects of the present disclosure:

Aspect 1: A method for wireless communications at a UE, comprising: receiving a control channel communication that indicates a plurality of shared channel resources associated with a downlink shared channel communication, the control channel communication indicating a first repetition resource set for an initial downlink shared channel communication and one or more repetition resource sets for one or more repetitions of the downlink shared channel communication; receiving signals from two or more of the plurality of shared channel resources based at least in part on the control channel communication; and decoding the downlink shared channel communication based at least in part on the received signals from the two or more of the plurality of shared channel resources.

Aspect 2: The method of aspect 1, wherein the shared channel communication is a downlink shared channel communication.

Aspect 3: The method of any of aspects 1 through 2, wherein the shared channel resources further include resources for uplink shared channel communications, and wherein the method further comprises: transmitting uplink shared channel communications on two or more of the plurality of shared channel resources.

Aspect 4: The method of any of aspects 1 through 3, wherein the repetition resource sets comprise resources having a periodic or non-periodic pattern across multiple consecutive or non-consecutive slots.

Aspect 5: The method of any of aspects 1 through 4, wherein one or more of the repetition resource sets include multiple time resources, frequency resources, or combinations thereof, within a same slot.

Aspect 6: The method of any of aspects 1 through 5, wherein the one or more repetitions of the shared channel transmission include repetitions of an exact copy of the shared channel transmission or include different redundancy versions of the shared transmission.

Aspect 7: The method of any of aspects 1 through 6, wherein the repetitions of the shared channel transmission are configured for aggregation levels above a configured threshold value.

Aspect 8: The method of any of aspects 1 through 7, wherein the control channel communication further indicates a repetition pattern for the one or more repetitions of the shared channel communication.

Aspect 9: The method of any of aspects 1 through 8, wherein the shared channel communication has multiple repetitions in a same slot.

Aspect 10: The method of any of aspects 1 through 9, wherein the repetition pattern provided is provided in DCI in the control channel communication, and wherein the DCI further indicates a duration that repetitions according to the repetition pattern are to be transmitted, a number of slots between consecutive repetitions, or any combinations thereof.

Aspect 11: The method of any of aspects 1 through 10, wherein control channel communication further indicates whether different redundancy versions (RVs) are used for consecutive repetitions of the shared channel communication, and wherein the decoding is further based at least in part on whether the different RVs are used for the consecutive repetitions.

Aspect 12: The method of any of aspects 1 through 11, wherein UE and the base station are nodes in a non-terrestrial network (NTN).

Aspect 13: A method for wireless communications at a base station, comprising: configuring a plurality of shared channel resources associated with a shared channel communication to a UE, wherein the plurality of shared channel resources include a first repetition resource set for an initial shared channel communication and one or more repetition resource sets for one or more repetitions of the shared channel communication; transmitting, to the UE, a control channel communication that indicates the plurality of shared channel resources; and transmitting a plurality of repetitions of the shared channel transmission using the plurality of shared channel resources.

Aspect 14: The method of aspect 13, wherein repetition resource sets comprise resources having a periodic or non-periodic pattern across multiple consecutive or non-consecutive slots.

Aspect 15: The method of any of aspects 13 through 14, wherein one or more of the repetition resource sets include multiple time resources, frequency resources, or combinations thereof, within a same slot.

Aspect 16: The method of any of aspects 13 through 15, wherein the repetitions of the shared channel transmission include repetitions of an exact copy of the shared channel transmission or include different redundancy versions of the shared channel transmission.

Aspect 17: The method of any of aspects 13 through 16, wherein control channel communication further indicates a repetition pattern for the one or more repetitions of the shared channel communication.

Aspect 18: The method of any of aspects 13 through 17, wherein the UE and the base station are nodes in a non-terrestrial network (NTN).

Aspect 19: The method of any of aspects 13 through 18, wherein the shared channel communication has multiple repetitions in a same slot.

Aspect 20: The method of any of aspects 13 through 19, wherein a repetition pattern associated with the plurality of repetitions of the shared channel transmission provides a duration that repetitions according to the repetition pattern are to be transmitted, a number of slots between consecutive repetitions, or any combinations thereof.

Aspect 21: The method of any of aspects 13 through 20, wherein the control channel communication further indicates whether different redundancy versions (RVs) are used for consecutive repetitions of the shared channel communication.

Aspect 22: An apparatus for wireless communication comprising a processor, memory coupled with the processor, the processor and memory configured to cause the apparatus to perform a method of any of aspects 1 through 12.

Aspect 23: An apparatus for wireless communications at a UE, comprising at least one means for performing a method of any of aspects 1 through 12.

Aspect 24: A non-transitory computer-readable medium storing code for wireless communications at a UE, the code comprising instructions executable by a processor to perform a method of any of aspects 1 through 12.

Aspect 25: An apparatus for wireless communication comprising a processor, memory coupled with the processor, the processor and memory configured to cause the apparatus to perform a method of any of aspects 13 through 21.

Aspect 26: An apparatus for wireless communications at a base station, comprising at least one means for performing a method of any of aspects 13 through 21.

Aspect 27: A non-transitory computer-readable medium storing code for wireless communications at a base station, the code comprising instructions executable by a processor to perform a method of any of aspects 13 through 21.

Aspect 28: A method for wireless communications at a UE, comprising: identifying, based at least in part on a control resource set configuration received from a base station, a plurality of resources associated with a downlink control channel transmission from the base station, the plurality of resources including a first repetition resource set for an initial instance of the downlink control channel transmission and one or more additional repetition resource sets for one or more repetitions of the downlink control channel transmission; buffering received signals from two or more of the plurality of resources based at least in part on the identifying; and decoding the downlink control channel transmission based at least in part on the buffered received signals.

Aspect 29: The method of aspect 28, wherein the repetition resource sets comprise resources having a periodic or non-periodic pattern across multiple consecutive or non-consecutive slots.

Aspect 30: The method of any of aspects 28 through 29, wherein one or more of the repetition resource sets include multiple time resources, frequency resources, or combinations thereof, within a same slot.

Aspect 31: The method of any of aspects 28 through 30, wherein the one or more repetitions of the downlink control channel transmission include repetitions of an exact copy of the downlink control channel transmission or include different redundancy versions of the downlink control channel transmission.

Aspect 32: The method of any of aspects 28 through 31, wherein the repetitions of the downlink control channel transmission are configured for aggregation levels above a configured threshold value.

Aspect 33: The method of any of aspects 28 through 32, wherein a first part of a repetition of the downlink control channel transmission at an aggregation level is associated with a first control resource set transmitted by the base station, and a second part of the repetition of the downlink control channel transmission is associated with a second control resource set transmitted by the base station.

Aspect 34: The method of any of aspects 28 through 33, wherein the repetition resource sets comprise one or more configured search spaces of a plurality of available search spaces.

Aspect 35: The method of aspect 34, wherein the one or more configured search spaces include all search space candidates for an indicated number of slots, search space candidates up to an indicated repetition level, or search space candidates that are determined based on a gap that indicates how many search space candidates are skipped between two repetitions.

Aspect 36: The method of any of aspects 28 through 35, further comprising: determining one or more of a scrambling identification, a radio network temporary identifier (RNTI), or a downlink control information (DCI) size, associated with the downlink control channel transmission; and determining a repetition level of the downlink control channel transmission based at least in part on mapping between the scrambling identification, RNTI, or DCI size and the repetition level.

Aspect 37: The method of aspect 36, wherein the control resource set configuration has a plurality of search spaces that are candidates for downlink control channel communications, and wherein one or more search space candidates are dropped based at least in part on the determined repetition level.

Aspect 38: The method of any of aspects 28 through 37, further comprising: determining the first repetition resource set for the downlink control channel transmission based on a configured search space of a plurality of search spaces that are candidates for downlink control channel communications; and deriving the one or more additional repetition resource sets based at least in part on the first repetition resource set.

Aspect 39: The method of aspect 38, wherein the repetition resource sets include two or more different time resources, two or more different frequency resources, two or more resources associated with different control resource sets, or any combinations thereof.

Aspect 40: The method of any of aspects 38 through 39, wherein the one or more additional repetition resource sets are derived based on one or more of a time shift and repetition level associated with the first repetition resource set, and wherein the time shift is a fixed time shift, a deterministic time shift, or a pseudo-random time shift relative to the first repetition resource set.

Aspect 41: The method of aspect 40, wherein the time shift is configured as a number of orthogonal frequency division multiplexing (OFDM) symbols.

Aspect 42: The method of any of aspects 38 through 41, wherein the one or more additional repetition resource sets are derived based on one or more of a frequency shift and repetition level associated with the first repetition resource set, and wherein the frequency shift is a fixed frequency shift, a deterministic frequency shift, or a pseudo-random frequency shift relative to the first transmission resource.

Aspect 43: The method of aspect 42, wherein the frequency shift is cyclic frequency shift that is applied to the first repetition resource set or a prior repetition resource set, or that is applied to one or more search spaces associated with two or more different control resource sets.

Aspect 44: The method of any of aspects 38 through 43, wherein the one or more additional repetition resource sets are derived based on a control resource set shift associated with the first repetition resource set and the control resource set configuration, and wherein the control resource set shift indicates one or more control resource sets that carry one or more repetitions of the downlink control channel transmission.

Aspect 45: The method of any of aspects 38 through 44, wherein the one or more additional repetition resource sets are derived based at least in part on one or more of a time shift, a frequency shift, a control resource set shift, or any combinations thereof, relative to the first repetition resource set.

Aspect 46: The method of aspect 45, wherein one or more repetition resource sets are located in UE-specific search spaces that are at a same frequency within a same slot and are shifted in frequency across slots.

Aspect 47: The method of any of aspects 45 through 46, wherein one or more repetition resource sets are located in common search spaces that are at a same frequency within a same slot, and that are at the same frequency across slots.

Aspect 48: The method of any of aspects 28 through 47, further comprising: receiving information from the base station that indicates that repetitions of the downlink control channel transmission are enabled and that indicates whether the repetitions are slot-based repetitions or control resource set based repetitions.

Aspect 49: The method of aspect 48, wherein the information from the base station is received in a master information block (MIB) that indicates whether repetitions are used, a repetition level, shift information, or any combinations thereof.

Aspect 50: The method of aspect 49, wherein one or more slots are determined to be downlink control channel transmission candidates, and a repetition level and a starting slot number may be indicated in the MIB.

Aspect 51: The method of any of aspects 28 through 50, wherein the downlink control channel transmission includes a grant of downlink shared channel resources, and wherein the downlink shared channel resources start before or after a final repetition resource set.

Aspect 52: An apparatus for wireless communications comprising at least one means for performing a method of any one of aspects 28 through 51.

Aspect 53: An apparatus for wireless communication comprising a processor, memory coupled with the processor, the processor and memory configured to cause the apparatus to perform a method of any one of aspects 28 through 51.

Aspect 54: A non-transitory computer-readable medium storing code for wireless communication comprising a processor, memory in electronic communication with the processor, and instructions stored in the memory and executable by the processor to cause the apparatus to perform a method of any one of aspects 28 through 51.

Aspect 55: A method for wireless communications at a user equipment (UE), comprising: identifying, based at least in part on a control channel communication received from a base station, a plurality of shared channel resources associated with a downlink shared channel communication from the base station, the control channel communication indicating a first repetition resource set for an initial downlink shared channel communication and one or more repetition resource sets for one or more repetitions of the downlink shared channel communication, and a repetition pattern for the one or more repetitions of the downlink shared channel communication; buffering received signals from two or more of the plurality of shared channel resources based at least in part on the identifying; and decoding the downlink shared channel communication based at least in part on the buffered received signals.

Aspect 56: The method of aspect 55, wherein the downlink shared channel communication has multiple repetitions in a same slot.

Aspect 57: The method of any of aspects 55 through 56, wherein the repetition pattern provided is provided in downlink control information (DCI) in the control channel communication, and wherein the DCI further indicates a duration that repetitions according to the repetition pattern are to be transmitted, a number of slots between consecutive repetitions, or any combinations thereof.

Aspect 58: The method of any of aspects 55 through 57, wherein the control channel communication further indicates whether different redundancy versions (RVs) are used for consecutive repetitions of the downlink shared channel communication, and wherein the buffering is further based at least in part on whether the different RVs are used for the consecutive repetitions.

Aspect 59: An apparatus for wireless communications comprising at least one means for performing a method of any one of aspects 55 through 58.

Aspect 60: An apparatus for wireless communication comprising a processor, memory coupled with the processor, the processor and memory configured to cause the apparatus to perform a method of any one of aspects 55 through 58.

Aspect 61: A non-transitory computer-readable medium storing code for wireless communication comprising a processor, memory in electronic communication with the processor, and instructions stored in the memory and executable by the processor to cause the apparatus to perform a method of any one of aspects 55 through 58.

Aspect 62: A method for wireless communications at a user equipment (UE), comprising: identifying a plurality of physical broadcast channel resources associated with a base station, the plurality of physical broadcast channel resources including two or more repetition resources for two or more repetitions of a physical broadcast channel communication; buffering received signals from the two or more repetitions of the physical broadcast channel communication based at least in part on the identifying; and decoding the physical broadcast channel communication based at least in part on the buffered received signals.

Aspect 63: The method of aspect 62, wherein each repetition of the physical broadcast channel communications use a same set of beamforming parameters.

Aspect 64: The method of any of aspects 62 through 63, wherein: adjacent sets of physical broadcast channel resources for two or more repetitions of the physical broadcast channel communication are determined based at least in part on a defined time gap between adjacent repetitions.

Aspect 65: The method of any of aspects 62 through 64, wherein: two or more sets of physical broadcast channel frequency resources are defined within a slot, and wherein two or more repetitions of the physical broadcast channel communication use different sets of physical broadcast channel frequency resources within the slot.

Aspect 66: The method of any of aspects 62 through 65, wherein the two or more repetitions of the physical broadcast channel communication use a same system frame number (SFN) as an initial transmission of the physical broadcast channel communication.

Aspect 67: The method of any of aspects 62 through 66, wherein the two or more repetitions of the physical broadcast channel communication use a same half-frame bit associated with a system frame number as an initial transmission of the physical broadcast channel communication.

Aspect 68: The method of any of aspects 62 through 67, wherein the two or more repetitions of the physical broadcast channel communication use a same synchronization signal (SS)/physical broadcast channel (PBCH) index as an initial transmission of the physical broadcast channel communication.

Aspect 69: An apparatus for wireless communications comprising at least one means for performing a method of any one of aspects 62 through 68.

Aspect 70: An apparatus for wireless communication comprising a processor, memory coupled with the processor, the processor and memory configured to cause the apparatus to perform a method of any one of aspects 62 through 68.

Aspect 71: A non-transitory computer-readable medium storing code for wireless communication comprising a processor, memory in electronic communication with the processor, and instructions stored in the memory and executable by the processor to cause the apparatus to perform a method of any one of aspects 62 through 68.

Aspect 72: A method for wireless communications at a user equipment (UE), comprising: receiving, from a base station, an uplink grant for an uplink communication from the UE, the uplink grant indicating a plurality of uplink resources that include one or more repetition resources for one or more repetitions of the uplink communication; determining a transmission frequency bandwidth for the uplink communication as a subset of a channel frequency bandwidth used for receiving downlink communications at the UE; and transmitting the uplink communication via the plurality of uplink resources using the transmission frequency bandwidth.

Aspect 73: The method of aspect 72, wherein the uplink communication is an uplink control channel communication and the uplink grant indicates a repetition level and resource allocation for the uplink control channel communication over multiple slots.

Aspect 74: The method of any of aspects 72 through 73, wherein the one or more repetitions of the uplink communication include retransmissions of a same communication or different redundancy versions (RVs) of the uplink communication.

Aspect 75: The method of any of aspects 72 through 74, wherein the uplink communication is an uplink shared channel communication and the uplink grant indicates a repetition level and resource allocation for the uplink shared channel communication over multiple slots.

Aspect 76: The method of aspect 75, wherein a timing between the uplink grant and the uplink shared channel communication corresponds to a predetermined repetition of the one or more repetitions of the uplink shared channel communication.

Aspect 77: An apparatus for wireless communications comprising at least one means for performing a method of any one of aspects 72 through 76.

Aspect 78: An apparatus for wireless communication comprising a processor, memory coupled with the processor, the processor and memory configured to cause the apparatus to perform a method of any one of aspects 72 through 76.

Aspect 79: A non-transitory computer-readable medium storing code for wireless communication comprising a processor, memory in electronic communication with the processor, and instructions stored in the memory and executable by the processor to cause the apparatus to perform a method of any one of aspects 72 through 76.

Aspect 80: A method for wireless communications at a base station, comprising: determining that coverage enhancement is to be used for communications with a user equipment (UE); identifying, based at least in part on a control resource set configuration associated with the UE, a plurality of resources associated with a downlink control channel transmission to the UE, the plurality of resources including a first repetition resource set for an initial repetition of the downlink control channel transmission and one or more further repetition resource sets for the downlink control channel transmission; and transmitting a plurality of repetitions of the downlink control channel transmission using the plurality of resources.

Aspect 81: The method of aspect 80, wherein the repetition resource sets comprise resources having a periodic or non-periodic pattern across multiple consecutive or non-consecutive slots.

Aspect 82: The method of any of aspects 80 through 81, wherein one or more of the repetition resource sets include multiple time resources, frequency resources, or combinations thereof, within a same slot.

Aspect 83: The method of any of aspects 80 through 82, wherein the repetitions of the downlink control channel transmission include repetitions of an exact copy of the downlink control channel transmission or include different redundancy versions of the downlink control channel transmission.

Aspect 84: The method of any of aspects 80 through 83, wherein a first part of a repetition of the downlink control channel transmission at an aggregation level is associated with a first control resource set transmitted by the base station, and a second part of the repetition of the downlink control channel transmission is associated with a second control resource set transmitted by the base station.

Aspect 85: The method of any of aspects 80 through 84, wherein the repetition resources comprise one or more configured search spaces of a plurality of available search spaces.

Aspect 86: The method of aspect 85, wherein the one or more configured search spaces include all search space candidates for an indicated number of slots, search space candidates up to an indicated repetition level, or search space candidates that are determined based on a gap that indicates how many search space candidates are skipped between two repetitions.

Aspect 87: The method of any of aspects 80 through 86, wherein a repetition level of the one or more repetitions of the downlink control channel transmission is determined based at least in part on mapping between the repetition level and a scrambling identification, a radio network temporary identifier (RNTI), or a downlink control information (DCI) size.

Aspect 88: The method of any of aspects 80 through 87, further comprising: determining the first repetition resource set for the downlink control channel transmission based on a configured search space of a plurality of search spaces that are candidates for downlink control channel communications; and deriving one or more repetition resource sets based at least in part on the first repetition resource set.

Aspect 89: The method of aspect 88, wherein the repetition resource sets include two or more different time resources, two or more different frequency resources, two or more resources associated with different control resource sets, or any combinations thereof.

Aspect 90: The method of any of aspects 88 through 89, wherein the repetition resource sets are derived based on one or more of a time shift and repetition level associated with the first repetition resource set, and wherein the time shift is a fixed time shift, a deterministic time shift, or a pseudo-random time shift relative to the first repetition resource set.

Aspect 91: The method of any of aspects 88 through 90, wherein the repetition resource sets are derived based on one or more of a frequency shift and repetition level associated with the first repetition resource set, and wherein the frequency shift is a fixed frequency shift, a deterministic frequency shift, or a pseudo-random frequency shift relative to the first repetition resource set.

Aspect 92: The method of any of aspects 88 through 91, wherein the repetition resource sets are derived based on a control resource set shift associated with the first repetition resource set and the control resource set configuration, and wherein the control resource set shift indicates one or more control resource sets that carry one or more repetitions of the downlink control channel transmission.

Aspect 93: The method of any of aspects 80 through 92, further comprising: transmitting an indication to the UE that repetitions of the downlink control channel transmission are enabled and that indicates whether the repetitions are slot-based repetitions or control resource set based repetitions.

Aspect 94: The method of aspect 93, wherein the indication is transmitted in a master information block (MIB) that indicates whether repetitions are used, a repetition level, shift information, or any combinations thereof.

Aspect 95: The method of aspect 94, wherein the repetition resource sets are determined based on a mapping between the MIB information and one or more time locations, frequency locations, a repetition level, or any combinations thereof.

Aspect 96: The method of any of aspects 80 through 95, wherein the downlink control channel transmission includes a grant of downlink shared channel resources, and wherein the downlink shared channel resources start before or after a final repetition resource.

Aspect 97: An apparatus for wireless communications comprising at least one means for performing a method of any one of aspects 80 through 96.

Aspect 98: An apparatus for wireless communication comprising a processor, memory coupled with the processor, the processor and memory configured to cause the apparatus to perform a method of any one of aspects 80 through 96.

Aspect 99: A non-transitory computer-readable medium storing code for wireless communication comprising a processor, memory in electronic communication with the processor, and instructions stored in the memory and executable by the processor to cause the apparatus to perform a method of any one of aspects 80 through 96.

Aspect 100: A method for wireless communications at a base station, comprising: identifying a plurality of shared channel resources associated with a downlink shared channel communication to a user equipment (UE) and a repetition pattern for the one or more repetitions of the downlink shared channel communication, wherein the plurality of shared channel resources include one or more repetition resource sets for one or more repetitions of the downlink shared channel communication according to the repetition pattern; transmitting, to the UE, a control channel communication that indicates the plurality of shared channel resources; and transmitting a plurality of repetitions of the downlink shared channel transmission according to the repetition pattern, using the plurality of shared channel resources.

Aspect 101: The method of aspect 100, wherein the downlink shared channel communication has multiple repetitions in a same slot.

Aspect 102: The method of any of aspects 100 through 101, wherein the repetition pattern provided is provided in downlink control information (DCI) in the control channel communication, and wherein the DCI further indicates a duration that repetitions according to the repetition pattern are to be transmitted, a number of slots between consecutive repetitions, or any combinations thereof.

Aspect 103: The method of any of aspects 100 through 102, wherein the control channel communication further indicates whether different redundancy versions (RVs) are used for consecutive repetitions of the downlink shared channel communication, and wherein the buffering is further based at least in part on whether the different RVs are used for the consecutive repetitions.

Aspect 104: An apparatus for wireless communications comprising at least one means for performing a method of any one of aspects 100 through 103.

Aspect 105: An apparatus for wireless communication comprising a processor, memory coupled with the processor, the processor and memory configured to cause the apparatus to perform a method of any one of aspects 100 through 103.

Aspect 106: A non-transitory computer-readable medium storing code for wireless communication comprising a processor, memory in electronic communication with the processor, and instructions stored in the memory and executable by the processor to cause the apparatus to perform a method of any one of aspects 100 through 103.

Aspect 107: A method for wireless communications at a base station, comprising: determining that coverage enhancement is to be used for physical broadcast channel communications with at least one user equipment (UE); allocating a plurality of physical broadcast channel resources based at least in part on the determining, the plurality of physical broadcast channel resources including two or more repetition resources for two or more repetitions of the physical broadcast channel communications; and transmitting a plurality of instances of the physical broadcast channel communications using the plurality of physical broadcast channel resources.

Aspect 108: The method of aspect 107, wherein each repetition of the physical broadcast channel communications use a same set of beamforming parameters.

Aspect 109: The method of any of aspects 107 through 108, wherein: adjacent sets of physical broadcast channel resources for two or more repetitions of the physical broadcast channel communication are determined based at least in part on a defined time gap between adjacent repetitions.

Aspect 110: The method of any of aspects 107 through 109, wherein: two or more sets of physical broadcast channel frequency resources are defined within a slot, and wherein two or more repetitions of the physical broadcast channel communication use different sets of physical broadcast channel frequency resources within the slot.

Aspect 111: The method of any of aspects 107 through 110, wherein the two or more repetitions of the physical broadcast channel communication use a same system frame number (SFN) as an initial transmission of the physical broadcast channel communication.

Aspect 112: The method of any of aspects 107 through 111, wherein the two or more repetitions of the physical broadcast channel communication use a same half-frame bit associated with a system frame number as an initial transmission of the physical broadcast channel communication.

Aspect 113: An apparatus for wireless communications comprising at least one means for performing a method of any one of aspects 107 through 112.

Aspect 114: An apparatus for wireless communication comprising a processor, memory coupled with the processor, the processor and memory configured to cause the apparatus to perform a method of any one of aspects 107 through 112.

Aspect 115: A non-transitory computer-readable medium storing code for wireless communication comprising a processor, memory in electronic communication with the processor, and instructions stored in the memory and executable by the processor to cause the apparatus to perform a method of any one of aspects 107 through 112.

Aspect 116: A method for wireless communications at a base station, comprising: determining that coverage enhancement is to be used for communications with a user equipment (UE); allocating a plurality of uplink resources to the UE for an uplink communication, the plurality of uplink resources including one or more repetition resource sets for one or more repetitions of the uplink communication, and wherein a transmission frequency bandwidth for the uplink communication is a subset of a channel frequency bandwidth used for downlink communications to the UE; transmitting an uplink grant for the uplink communication to the UE; buffering received signals from two or more of the plurality of uplink resources based at least in part on the uplink grant; and decoding the uplink communication based at least in part on the buffered received signals.

Aspect 117: The method of aspect 116, wherein the uplink communication is an uplink control channel communication and the uplink grant indicates a repetition level and resource allocation for the uplink control channel communication over multiple slots.

Aspect 118: The method of any of aspects 116 through 117, wherein the one or more repetitions of the uplink communication include retransmissions of a same communication or different redundancy versions (RVs) of the uplink communication.

Aspect 119: The method of aspects 116 through 118, wherein the uplink communication is an uplink shared channel communication and the uplink grant indicates a repetition level and resource allocation for the uplink shared channel communication over multiple slots.

Aspect 120: The method of aspect 119, wherein a timing between the uplink grant and the uplink shared channel communication corresponds to a predetermined repetition of the one or more repetitions of the uplink shared channel communication.

Aspect 121: An apparatus for wireless communications comprising at least one means for performing a method of any one of aspects 116 through 120.

Aspect 122: An apparatus for wireless communication comprising a processor, memory coupled with the processor, the processor and memory configured to cause the apparatus to perform a method of any one of aspects 116 through 120.

Aspect 123: A non-transitory computer-readable medium storing code for wireless communication comprising a processor, memory in electronic communication with the processor, and instructions stored in the memory and executable by the processor to cause the apparatus to perform a method of any one of aspects 116 through 120.

What is claimed is:

1. A method for wireless communications at a user equipment (UE), comprising:
receiving a control channel communication that indicates a plurality of shared channel resources associated with a shared channel communication, the control channel communication indicating a first repetition resource set for an initial shared channel communication and one or more repetition resource sets for one or more repetitions of the shared channel communication;
receiving signals from two or more of the plurality of shared channel resources based at least in part on the control channel communication; and
decoding the shared channel communication based at least in part on the received signals from the two or more of the plurality of shared channel resources.

2. The method of claim 1, wherein the shared channel communication is a downlink shared channel communication.

3. The method of claim 1, wherein the shared channel resources further include resources for uplink shared channel communications, and wherein the method further comprises:
transmitting uplink shared channel communications on two or more of the plurality of shared channel resources.

4. The method of claim 1, wherein the repetition resource sets comprise resources having a periodic or non-periodic pattern across multiple consecutive or non-consecutive slots.

5. The method of claim 1, wherein one or more of the repetition resource sets include multiple time resources, frequency resources, or combinations thereof, within a same slot.

6. The method of claim 1, wherein the one or more repetitions of the shared channel communication include repetitions of an exact copy of the shared channel communication or include different redundancy versions of the shared channel communication.

7. The method of claim 1, wherein repetitions of the shared channel communication are configured for aggregation levels above a configured threshold value.

8. The method of claim 1, wherein the control channel communication further indicates a repetition pattern for the one or more repetitions of the shared channel communication.

9. The method of claim 1, wherein the shared channel communication has multiple repetitions in a same slot.

10. The method of claim 1, wherein a repetition pattern provided is provided in downlink control information (DCI) in the control channel communication, and wherein the DCI further indicates a duration that repetitions according to the repetition pattern are to be transmitted, a number of slots between consecutive repetitions, or any combinations thereof.

11. The method of claim 1, wherein the control channel communication further indicates whether different redundancy versions (RVs) are used for consecutive repetitions of the shared channel communication, and wherein the decoding is further based at least in part on whether the different RVs are used for the consecutive repetitions.

12. The method of claim 1, wherein the UE and a base station are nodes in a non-terrestrial network (NTN).

13. A method for wireless communications at a base station, comprising:
configuring a plurality of shared channel resources associated with a shared channel communication with a user equipment (UE), wherein the plurality of shared channel resources include a first repetition resource set for an initial shared channel communication and one or more repetition resource sets for one or more repetitions of the shared channel communication;
transmitting, to the UE, a control channel communication that indicates the plurality of shared channel resources; and
transmitting a plurality of repetitions of the shared channel communication using the plurality of shared channel resources.

14. The method of claim 13, wherein the repetition resource sets comprise resources having a periodic or non-periodic pattern across multiple consecutive or non-consecutive slots.

15. The method of claim 13, wherein one or more of the repetition resource sets include multiple time resources, frequency resources, or combinations thereof, within a same slot.

16. The method of claim 13, wherein repetitions of the shared channel communication include repetitions of an exact copy of the shared channel communication or include different redundancy versions of the shared channel communication.

17. The method of claim 13, wherein the control channel communication further indicates a repetition pattern for the one or more repetitions of the shared channel communication.

18. The method of claim 13, wherein the UE and the base station are nodes in a non-terrestrial network (NTN).

19. The method of claim 13, wherein the shared channel communication has multiple repetitions in a same slot.

20. An apparatus for wireless communications at a user equipment (UE), comprising:
a processor; and
memory coupled with the processor, the processor and memory configured to cause the apparatus to:
receive a control channel communication received that indicates a plurality of shared channel resources associated with a shared channel communication, the control channel communication indicating a first repetition resource set for an initial shared channel communication and one or more repetition resource sets for one or more repetitions of the shared channel communication;
receive signals from two or more of the plurality of shared channel resources based at least in part on the control channel communication; and
decode the shared channel communication based at least in part on the received signals from the two or more of the plurality of shared channel resources.

21. The apparatus of claim 20, wherein the repetition resource sets comprise resources having a periodic or non-periodic pattern across multiple consecutive or non-consecutive slots.

22. The apparatus of claim 20, wherein one or more of the repetition resource sets include multiple time resources, frequency resources, or combinations thereof, within a same slot.

23. The apparatus of claim 20, wherein the control channel communication further indicates a repetition pattern for the one or more repetitions of the shared channel communication.

24. The apparatus of claim 20, wherein a repetition pattern provided is provided in downlink control information (DCI) in the control channel communication, and wherein the DCI further indicates a duration that repetitions according to the repetition pattern are to be transmitted, a number of slots between consecutive repetitions, or any combinations thereof.

25. The apparatus of claim 20, wherein the control channel communication further indicates whether different redundancy versions (RVs) are used for consecutive repetitions of the shared channel communication.

26. An apparatus for wireless communications at a base station, comprising:
a processor; and
memory coupled with the processor, the processor and memory configured to cause the apparatus to:
configure a plurality of shared channel resources associated with a shared channel communication to a user equipment (UE), wherein the plurality of shared channel resources include a first repetition resource set for an initial shared channel communication and one or more repetition resource sets for one or more repetitions of the shared channel communication;
transmit, to the UE, a control channel communication that indicates the plurality of shared channel resources; and
transmit a plurality of repetitions of the shared channel communication using the plurality of shared channel resources.

27. The apparatus of claim 26, wherein the repetition resource sets comprise resources having a periodic or non-periodic pattern across multiple consecutive or non-consecutive slots.

28. The apparatus of claim 26, wherein one or more of the repetition resource sets include multiple time resources, frequency resources, or combinations thereof, within a same slot.

29. The apparatus of claim 26, wherein the control channel communication further indicates a repetition pattern for the one or more repetitions of the shared channel communication.

30. The apparatus of claim 26, wherein a repetition pattern associated with the plurality of repetitions of the shared channel communication provides a duration that repetitions according to the repetition pattern are to be transmitted, a number of slots between consecutive repetitions, or any combinations thereof.
